(19) United States
(12) Patent Application Publication
(10) Pub. No.: US 2025/0348906 A1
(43) Pub. Date: Nov. 13, 2025

(54) MATCHING SYSTEM, COMPUTING DEVICE, AND METHOD

(71) Applicant: Murata Manufacturing Co., Ltd., Nagaokakyo-shi (JP)

(72) Inventors: Masaharu ITAYA, Nagaokakyo-shi (JP); Kazuki MATSUI, Nagaokakyo-shi (JP); Yusuke MORI, Nagaokakyo-shi (JP); Yuuto NIWA, Nagaokakyo-shi (JP)

(73) Assignee: Murata Manufacturing Co., Ltd., Nagaokakyo-shi (JP)

(21) Appl. No.: 19/279,178

(22) Filed: Jul. 24, 2025

Related U.S. Application Data
(63) Continuation of application No. PCT/JP2023/039884, filed on Nov. 6, 2023.

(30) Foreign Application Priority Data
Jan. 25, 2023 (JP) 2023-009532

(51) Int. Cl. G06Q 30/0251

(52) U.S. Cl. CPC G06Q 30/0269; G06Q 30/0255

(57) ABSTRACT

A matching system that provides targeted advertisements includes a plurality of user devices and a computing device that communicates with each user device and accesses a database. The user devices includes a first user device operated by a user belonging to a first group. The database stores group information identifying each of the plurality of groups, a plurality of pieces of advertisement information, and prohibition information identifying advertisement information which is prohibited from being associated with the first group. The computing device extracts one or more pieces of advertisement information with the user belonging to the first group, excludes advertisement information identified by the prohibition information from extracted advertisement information, associates resulting advertisement information with the user belonging to the first group, and transmits the resulting one or more pieces of advertisement information to the first user device based on the association.

### CROSS-REFERENCE TO RELATED APPLICATIONS

The present application is a continuation of International Application No. PCT/JP2023/039884, filed Nov. 6, 2023, which claims priority to Japanese patent application JP 2023-009532, filed Jan. 25, 2023, the entire contents s of each of which being incorporated herein by reference.

### TECHNICAL FIELD

The present disclosure relates to a matching system, a computing device, and a method for providing an advertisement that matches each of a plurality of groups including companies.

### BACKGROUND ART

In general, an advertising technology is publicly known that displays an advertisement estimated to match user's preference on a screen of a Web page being viewed by the user. In such an advertising technology, users' preferences are inferred from various data, and product and service information according to inference results is provided to the users as advertisements.

Patent Document 1 describes a method to determine contents of advertisements by utilizing rules set based on personal information, and a method to determine contents of advertisements by utilizing a rule set based on a hypothesis that those who have similar interests or preferences have similar behavioral characteristics.

### CITATION LIST

### Patent Document

Patent Document 1: Japanese Unexamined Patent Application Publication No. 2004-021810

### SUMMARY

### Technical Problems

A platform aimed at sharing resources and providing information, or the like, can be built by connecting a wide variety of groups of companies, or the like, over a network. By participating in such a platform as users, companies, or the like, can enjoy benefits tailored to objectives of the platform that could not be otherwise obtained by a single company.

Companies, or the like, can also utilize a platform to provide their advertisements to other companies for which advertisement effect is high. The larger the number of users participating in the platform and the larger a scale of the platform, the higher the advertisement effect is expected to be. This enables the companies, or the like, to effectively provide advertisements to a large number of other companies, or the like, that have a high interest in their products among users who utilize the platform.

However, there is a possibility that the other companies highly interested in their products include companies, or the like, that compete with their company. In particular, the possibility increases as the scale of the platform becomes larger. Actively providing one's own advertisements to competitor companies cannot be preferable, and rather, the advertisements should not be provided to the competitor companies.

The present disclosure has been made to solve the problems described above. An objective of the present disclosure is to effectively provide advertisements from a group of companies, or the like, to another group while restricting the provision of advertisements to competing groups.

### Solutions to Problems

A matching system according to a first aspect of the present disclosure is a matching system that provides an advertisement that matches each of a plurality of groups including companies, the matching system including: a plurality of user devices; and a computing device that communicates with each of the plurality of user devices and accesses a database. The plurality of user devices includes a first user device that is operated by a user belonging to a first group. The database registers group information capable of identifying each of the plurality of groups, a plurality of pieces of advertisement information, and prohibition information capable of identifying advertisement information, among the plurality of pieces of advertisement information, which is prohibited from being associated with the user belonging to the first group. The computing device extracts one or more pieces of advertisement information among the plurality of pieces of advertisement information with the user belonging to the first group, excludes the advertisement information identified by the prohibition information, and associates the advertisement information with the user belonging to the first group, and transmits the one or more pieces of advertisement information.

A computing device according to a second aspect of the present disclosure is a computing device included in a matching system that provides an advertisement that matches each of a plurality of groups including companies, the computing device including: a communication interface that communicates with a plurality of user devices including a first user device that is operated by a user belonging to a first group; and a processor that accesses a database, in which the database registers group information capable of identifying each of the plurality of groups, a plurality of pieces of advertisement information, and prohibition information capable of identifying advertisement information, among the plurality of pieces of advertisement information, which is prohibited from being associated with the user belonging to the first group, the processor associates one or more pieces of advertisement information among the plurality of pieces of advertisement information with the user belonging to the first group, and delivers the one or more pieces of advertisement information to the first user device, and the processor excludes the advertisement information identified by the prohibition information and associates the advertisement information with the user belonging to the first group.

A method according to a third aspect of the present disclosure is a method of providing an advertisement that matches each of a plurality of groups including companies, the method including: a step of communicating with a plurality of user devices including a first user device that is operated by a user belonging to a first group; a step of accessing a database that registers group information capable of identifying each of the plurality of groups, a plurality of pieces of advertisement information, and prohibition information capable of identifying advertisement information, among the plurality of pieces of advertisement information, which is prohibited from being associated with the user belonging to the first group; a step of associating one or more pieces of advertisement information among the plurality of pieces of advertisement information with the user belonging to the first group, and delivering the one or more pieces of advertisement information to the first user device; and a step of excluding the advertisement information identified by the prohibition information and associating the advertisement information with the user belonging to the first group.

### Advantageous Effects

According to the present disclosure, it is possible to effectively provide advertisements from a group of companies, or the like, to another group, and to restrict the provision of advertisements to competing groups.

### BRIEF DESCRIPTION OF DRAWINGS

FIG. 1 is a block diagram illustrating an overview of a matching system.

FIG. 2 is a block diagram illustrating configurations of a sharing server, a requester device, and an applicant device.

FIG. 3 is a diagram illustrating an example of a company database.

FIG. 4 is a diagram illustrating an example of a member database.

FIG. 5 is a diagram illustrating an example of a community database.

FIG. 6 is a diagram illustrating an example of a posted project database.

FIG. 7 is a diagram illustrating an example of a side job database.

FIG. 8 is a diagram illustrating an example of an evaluation input database.

FIG. 9 is a diagram illustrating an example of an evaluation summary database.

FIG. 10 is a diagram for explaining functions of the sharing server, the requester device, and the applicant device.

FIG. 11 is a diagram for explaining the functions of the sharing server, the requester device, and the applicant device.

FIG. 12 is a diagram for explaining the functions of the sharing server, the requester device, and the applicant device.

FIG. 13 is a diagram for further explaining the function of the applicant device.

FIG. 14 is a diagram for explaining a procedure for registering a posted project in the posted project database.

FIG. 15 is a diagram for explaining a procedure for searching for a posted project from the database.

FIG. 16 is a diagram for explaining a procedure for registering side job plan and performance in the database.

FIG. 17 is a diagram for explaining a procedure for registering an evaluation for the applicant in the database.

FIG. 18 is a diagram for explaining a procedure for registering an evaluation for the requester in the database.

FIG. 19 is a diagram for explaining a procedure for displaying the evaluation for the applicant and member search results on a display.

FIG. 20 is a diagram for explaining a procedure for displaying the evaluation for the requester and member search results on the display.

FIG. 21 is a diagram for explaining a viewable range of the evaluation summary database.

FIG. 22 is a diagram illustrating an example in which a disclosure range is set according to a disclosure level.

FIG. 23 is a diagram illustrating a screen to be displayed on a supervisor's applicant device when a supervisor (an applicant's superior) checks side job statuses of his/her subordinates.

FIG. 24 is a diagram illustrating details of project contents included in the posted project database.

FIG. 25 is a diagram illustrating an overview of an advertisement delivery function included in the matching system.

FIG. 26 is a diagram illustrating an example of a profile database and an action history database.

FIG. 27 is a diagram illustrating an example of an advertisement database.

FIG. 28 is a diagram illustrating an example of a priority database.

FIG. 29 is a flowchart illustrating a processing procedure related to the advertisement delivery function of the matching system.

FIG. 30 is a flowchart illustrating a processing procedure of an advertisement information registration unit.

FIG. 31 is a flowchart illustrating a processing procedure of a user information acquisition unit.

FIG. 32 is a flowchart illustrating a processing procedure of a content-based algorithm.

FIG. 33 is a flowchart illustrating a processing procedure of a cooperation-based algorithm.

FIG. 34 is a flowchart illustrating a processing procedure of a decision algorithm.

FIG. 35 is a flowchart illustrating the processing procedure of an advertisement information acquisition unit.

FIG. 36 is a flowchart illustrating a processing procedure of a display unit.

FIG. 37 is a flowchart illustrating a processing procedure of an advertisement result feedback unit.

FIG. 38 is a flowchart illustrating a processing procedure of a learning unit.

FIG. 39 is a diagram for explaining functions of a sharing server, a requester device, and an applicant device according to Modification Example 1.

FIG. 40 is a diagram illustrating an example of a member database according to Modification Example 1.

FIG. 41 is a flowchart illustrating a processing procedure of counteroffer member search processing according to Modification Example 1.

FIG. 42 is a block diagram illustrating configurations of a sharing server, a requester device, and an applicant device according to Modification Example 2.

FIG. 43 is a diagram illustrating an example of a member group database according to Modification Example 2.

FIG. 44 is a diagram illustrating an example of a posted project database according to Modification Example 2.

FIG. 45 is a diagram for explaining functions of the sharing server, the requester device, and the applicant device according to Modification Example 2.

FIG. 46 is a diagram for explaining a procedure for registering a posted project in a posted project database according to Modification Example 2.

### DESCRIPTION OF EMBODIMENTS

In the following, embodiments of the present disclosure will be described in detail with reference to the drawings. Note that in the figures, same or corresponding parts are designated by same reference numerals, and a description thereof will not be repeated.

### [Background for Proposing Matching System 1]

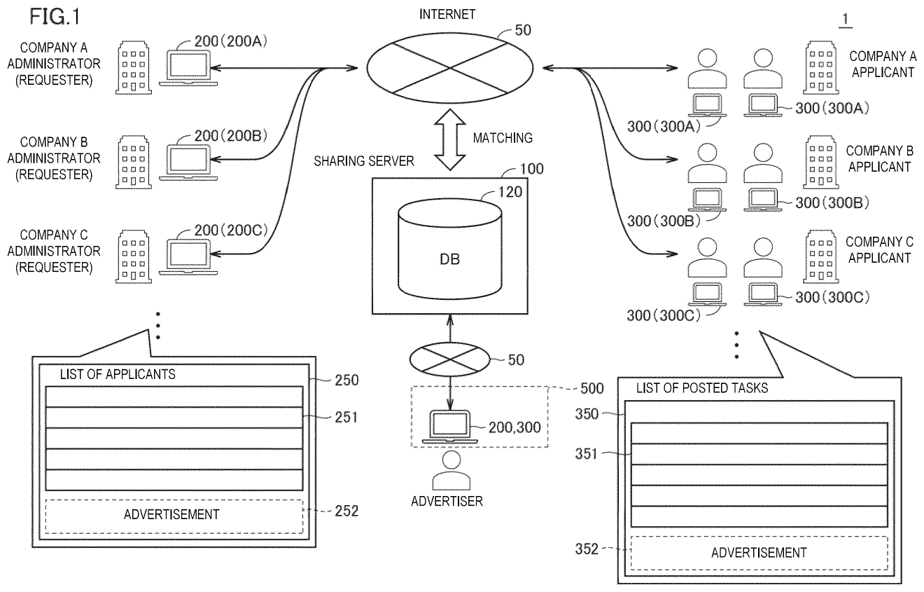

FIG. 1 is a block diagram illustrating an overview of a matching system 1 according to the present embodiment. First, in the present embodiment, a description will be given of a background for proposing the matching system 1.

The matching system 1 is utilized, for example, in crowdsourcing between companies. In general, crowdsourcing is a process that solicits contributions from a large indefinite number of people to obtain needed services, ideas, or contents.

There are not a few companies that encourage side jobs to effectively utilize their human resources. Crowdsourcing between companies makes it possible to utilize abilities of employees of the companies.

However, directly applying a typical crowdsourcing method between companies might result in problems to be described below.

[Possibility that Confidential Information May Leak]

Adoption of crowdsourcing entails company or personal risks because in the typical crowdsourcing method, no consideration is given to a relationship between a company on orderer side and a company on contractor side. For example, there is a risk that confidential information may be leaked to a company in a rival relationship, through an employee's side job. A conventional crowdsourcing method does not allow a supervisor to confirm that an employee is not accepting a project of the competitor company as a side job.

### [Possibility of Overwork]

If a company allows its employees to undertake side jobs, there is a risk that employees' working hours may become excessively long. To clear the risk of overwork, it is conceivable that a company defines an upper limit on a number of overtime hours, including a main job and a side job. However, as long as employees can freely accept a side job, it is difficult for the company to control side job hours of the employees. This may result in overwork of the employees.

[Possibility that Side Job Results are not Properly Evaluated]

Conventionally, there have been crowdsourcing systems that request an orderer to evaluate a contractor. If an appropriate evaluation made by the orderer is shared on the crowdsourcing systems, those who solicit a contractor for a task can refer to the evaluation and select a highly capable person from among many applicants who wish to accept the task.

However, an orderer of a certain company may give excessive consideration to a contractor from another company to be evaluated, so that the orderer may input a higher evaluation than an actual evaluation into the system. In addition, an orderer of a certain company may avoid giving a low evaluation to a contractor from another company, considering the possibility that a relationship between the companies may worsen. Furthermore, orderers cannot find any benefit in making evaluations and may input an evaluation that is far from the actual evaluation into the system. Given these possibilities, there is a risk that reliability of evaluations provided by the system may decrease. In this case, even if evaluations for contractors are shared, orderers of a task cannot utilize the evaluations as reference data when selecting a contractor.

[Possibility that Accurate Information Regarding Requesters Cannot be Obtained]

In the crowdsourcing systems as described above, applicants who plan to apply for a posted task will select a task that they find reasonable, while referring to task contents or rewards, or the like. However, there may exist some requesters that make an additional request that is outside of the scope of a contracted task or that often instruct changes to the task contents. Applicants would wish to apply for a posted task, avoiding such requesters. Conversely, there exist requesters that do not cause any problems till the task is completed. Applicants would wish to apply for a task being posted by such requesters if possible. Therefore, crowdsourcing systems may widely share evaluations for requesters (orderers) as well as evaluations for applicants (contractors).

When appropriate evaluations of requesters are shared in the crowdsourcing systems, those who plan to apply for a task can refer to the evaluations, considering past business records of the requesters, and select a task that they find reasonable, from among a large number of posted tasks.

However, when constructing an evaluation system capable of evaluating requesters, a similar problem may arise as in a case of constructing an evaluation system capable of evaluating contractors. That is, a contractor (applicant) of a certain company may give excessive consideration to an orderer (requester) from another company to be evaluated, so that the contractor may enter a higher evaluation than an actual evaluation in the system. In addition, a contractor (applicant) of a certain company may avoid giving a low evaluation to an orderer (requester) from another company, considering the possibility that a relationship between the companies may worsen. Furthermore, a contractor (applicant) cannot find any benefit in making evaluations and input an evaluation that is far from the actual evaluation into the system. Given these possibilities, there is a risk that the reliability of evaluations provided by the system may decrease. In this case, even if evaluations for requesters are shared, applicants cannot utilize the evaluations as reference data when selecting a requester.

[Special Characteristics Related to Company being Matching Entity]

In general, in order to match human resources and tasks across companies, it is necessary that companies that perform matching of human resources and tasks have a close relationship such as a relationship of mutual trust, or the like. Therefore, it is very difficult to perform the matching of human resources and tasks across companies that have no capital ties. Moreover, for large companies like those that are publicly listed, there exist special circumstances where they tend to compete with other companies due to their diversified operations. This leads to cannibalization with other companies, making the matching of human resources and tasks impossible in many companies.

[Possibility of Targeting Advertisements being Delivered to Competitors]

When a platform that can provide crowdsourcing to companies is built, the platform becomes larger as the number of companies participating in the platform increases. Networks including a wide variety of companies are formed in the expanded platform. It is conceivable to add, to the platform, a mechanism that enables a participating company to use this network to deliver targeting advertisements to another participating company. Because targeting advertisements are delivered to targeted users based on results of an analysis of users' preferences, high advertisement effects are produced. Therefore, the addition of an advertisement delivery function to the platform enables advertisers to deliver advertisements for their own products or services to responsible personnel at other companies who are considered to have high interest therein.

There is a possibility, however, that other companies that have high interest in their own products and services include companies that compete with them. In particular, the larger the scale of the platform, the higher the possibility. Actively providing one's own advertisements to competitor companies cannot be preferable. This is because the advertisement may contain technical information regarding new products of the company

A system that delivers targeting advertisement has a mechanism to determine delivery destinations of the advertisement, based on users' attributes and actions. It is also conceivable to apply such a mechanism to exclude competitor companies from the delivery destinations of the targeting advertisement. However, in network platforms such as SNS (Social Networking Service), which are widely popular among the general public, users may fake their attributes, and estimated results are not always correct.

If the estimated results are incorrect, there is a risk that advertisements related to new product exhibitions, or the like, which advertisers do not want competitors to see, may be delivered to the competitors. For this reason, judging whether a user belongs to the competitor company based on the user's attributes and actions that are obtained from the network may be unsatisfactory. The deficiencies in conventional advertising systems represent a specific technical failure in the field of computer network management and data security. Generic advertising platforms are incapable of enforcing deterministic, rule-based advertisement delivery exclusions based on verified, real-world corporate structures. Their reliance on probabilistic models and unreliable public data means they cannot guarantee that a sensitive advertisement will be blocked from a competitor. This technical shortcoming results in wasted computational resources, as processing cycles and network bandwidth are consumed to select and transmit advertisements that are not only undesirable from a business perspective but also represent a potential data security breach. Therefore, a technical need exists for a computing system with a novel architecture that integrates verified user group data with a deterministic advertisement filtering mechanism to improve data control and system efficiency.

In the present embodiment, the matching system 1, to be detailed below, is proposed in order to solve at least one of the above-described various issues that the conventional crowdsourcing systems have.

### Overall Configuration

A configuration of the matching system 1 will be described with reference to FIG. 1. The matching system 1 includes a sharing server 100, requester devices 200A, 200B, 200C, . . . , and applicant devices 300A, 300B, 300C . . . .

The sharing server 100 provides a large number of companies with a matching service that performs the matching of order placement and order acceptance for tasks among companies. FIG. 1 illustrates Company A, Company B, Company C . . . as examples of companies that utilize the matching service. Company A, Company B, Company C . . . are registered as company members of the matching system 1. Among employees of Company A, Company B, Company C . . . , those who utilize the matching system 1 are also individually registered as members of the matching system 1.

Tasks assigned in the matching system 1 are, for example, temporary tasks assumed to be completed in a predetermined period of time. Therefore, a person who accepts a task assigned in the matching system 1 is engaged in tasks of a specific department to which she/he belongs within a company, as his/her main job, and is engaged in a task assigned in the matching system 1, as a side job. Note that in the matching system 1, for example, an applicant from Company A can accept a task of Company A. Therefore, in the matching system 1, an applicant who belongs to a different department Y of Company A is also allowed to accept a task from a department X of Company A.

Hereinafter, a task for which a contractor is solicited in the matching system 1 may be referred to as a “posted task” or a “posted project”, those who provide a posted project may be referred to as a “requester”, and those who apply to a posted project may be referred to as an “applicant”. Applying for a posted task may be referred to as “application for a posted task” or “application for a posted project”.

An applicant who accepts an order for a posted project corresponds to a “contractor”, and a requester who places an order for a project with a contractor corresponds to an “orderer”. However, hereinafter, the term “applicant” may also include the “contractor” and the term “requester” may include the “orderer”.

A database 120 necessary for the matching service is constructed in the sharing server 100. The database 120 includes various databases in which information necessary for providing the matching service are registered. For example, information on members and posted tasks, or the like, is registered in the database 120. The sharing server 100 is managed and operated by a company other than companies that utilize the matching service. Any of the companies utilizing the matching service may manage and operate the sharing server 100.

The requester device 200A is operated by an administrator of Company A. The requester device 200B is operated by an administrator of Company B. The requester device 200C is operated by an administrator of Company C. Hereinafter, the requester devices 200A, 200B, 200C . . . may be collectively referred to as the “requester devices 200”.

The applicant device 300A is operated by an applicant of Company A. The applicant device 300B is operated by an applicant of Company B. The applicant device 300C is operated by an applicant of Company C. Hereinafter, the applicant devices 300A, 300B, 300C . . . may be collectively referred to as the “applicant devices 300”. FIG. 1 illustrates two applicants for each of the companies, but the number of applicants is not limited thereto. There may be more applicants in each of the companies or a certain company may have only one applicant. The sharing server 100 may accept those who do not belong to a company such as freelancers, as applicants.

In the present embodiment, administrators of Company A, Company B, Company C . . . shall assume a role of requesters. Therefore, hereinafter, the administrator in each of the companies may be referred to as a “requester”. A requester can also act as an applicant for a task being posted by another requester. In that case, the requester device 200 functions as the applicant device 300. In the present embodiment, when a company administrator acts as a requester, a device used by the administrator for utilizing the matching service is referred to as the requester device 200.

There may be one administrator or more than one administrator in Company A. If an administrator is arranged in Company A, the requester device 200 may be given to each administrator or the one requester device 200 may be shared by more than one person. This similarly applies to Company B, Company C . . . .

The sharing server 100 and the requester devices 200 are configured to be able to communicate with each other via Internet 50, which is one example of a communication network. The sharing server 100 and the applicant devices 300 are configured to be able to communicate with each other via the Internet 50.

When receiving access from the requester device 200, the sharing server 100 requests sign-in with input of a member ID and a password. Similarly, when receiving access from the applicant device 300, the sharing server 100 requests sign-in with a member ID and a password. The sharing server 100 individually identifies the requester and the applicant using the member ID notified at the time of sign in.

The requester device 200 receives various operations by the requester. For example, the requester device 200 receives an operation to input a posted project (requested task), an operation to input an evaluation for a contractor who has completed a task, and an operation to search for a member of the matching service, or the like.

The requester device 200 communicates with the sharing server 100 in response to each of the operations on the requester device 200. The sharing server 100 registers a posted project in the database 120 in response to the operation to input a posted project (requested task), registers an evaluation for the target applicant (contractor) in the database 120 in response to the operation to input an evaluation, and provides the requester device 200 with member information in response to the operation to search for a member.

The applicant device 300 receives various operations by the applicants. For example, the applicant device 300 receives an operation to search for a posted project, an operation to apply for a posted project, an operation to input task performance, and an operation to input an evaluation for a requester (orderer), or the like.

The applicant device 300 communicates with the sharing server 100 in response to each of the operations on the applicant devices 300. The sharing server 100 provides the applicant device 300 with an appropriate posted project in response to the operation to search for a posted project, issues to the applicant device 300 a notice of hiring or non-hiring in response to the operation to apply for a posted project, registers the task performance in the database 120 in response to the operation to input task performance, and registers the evaluation for the target requester (orderer) in the database 120 in response to the operation to input an evaluation.

As described above, the matching system 1 includes an evaluation system that evaluates applicants (contractors) and requesters (orderers) of a task, and a posting system that solicits a contractor for a task.

By utilizing the matching system 1, a requester who belongs to a certain department in Company A can employ an applicant who belongs to another department in Company A, as a contractor of a posted project. By utilizing the matching system 1, a requester who belongs to Company A can employ an applicant who belongs to Company B as a contractor of a posted project.

A member who utilizes the matching system 1 accesses the sharing server 100 as a requester or an applicant. Furthermore, a member who utilizes the matching system 1 can also access the sharing server 100 as an advertiser. Hereinafter, a member of the matching system 1 may be referred to as a “user”. In addition, hereinafter, the requester device 200 and the applicant device 300 operated by the members may be collectively referred to as a “user device 500”.

Advertisers who are users of the matching system 1 upload advertisements for their products and services to the sharing server 100. The advertisers upload advertisements to the sharing server 100, using the user devices 500, for example.

The sharing server 100 selects users considered to have high interest in contents of advertisements and delivers the advertisements to the selected users. In this manner, the sharing server 100 includes a function to deliver so-called targeting advertisements by utilizing a large platform that is constructed with participation of a large number of companies. The database 120 of the sharing server 100 registers data capable of identifying competitive relationships between companies. By referencing this data, the sharing server 100 filters a potential recipient list for an advertisement to exclude users associated with competitor companies, thereby preventing the advertisements of an advertiser from being delivered to competitors.

FIG. 1 exemplarily illustrates a screen 250 displayed on the requester device 200 and a screen 350 displayed on the applicant device 300. The requester looks at a list of applicants 251 displayed on the screen 250 and selects an applicant to be employed as a contractor. At this time, an advertisement 252 targeted for the requester is displayed on the screen 250. The applicant looks at a list of posted tasks 351 displayed on the screen 350 and selects a task for which the applicant applies. At this time, the advertisement 352 targeted for the applicant is displayed on the screen 350.

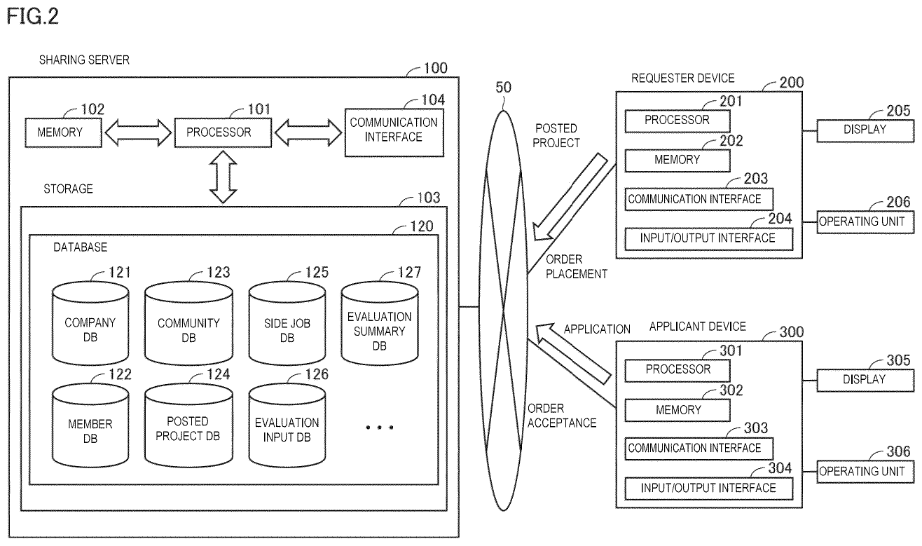

FIG. 2 is a block diagram illustrating configurations of the sharing server 100, the requester device 200, and the applicant device 300.

### [Configuration of Sharing Server 100]

The sharing server 100 includes a processor 101, a memory 102, a storage 103, and a communication interface 104. As used herein “processor” refers to circuitry that may be configured via the execution of computer readable instructions, and the circuitry may include one or more local processors (e.g., CPU's), and/or one or more remote processors, such as a cloud computing resource, or any combination thereof. For example, the present technology can be configured as a form of cloud computing in which one function is shared in cooperation for processing among a plurality of devices via a network.

The memory 102 includes a RAM (Random Access Memory), a ROM (Read Only Memory), a flash memory, or any other suitable non-transitory storage system. The memory 102 stores a program necessary for arithmetic processing of the processor 101 and temporary data calculated from the arithmetic processing, or the like.

The storage 103 includes a hard disk drive and a solid-state drive, or the like. The storage 103 stores the database 120. The database 120 includes a plurality of types of databases. The plurality of types of databases include a company database (company DB) 121, a member database (member DB) 122, a community database (community DB) 123, a posted project database (posted project DB) 124, a side job database (side job DB) 125, an evaluation input database (evaluation input) 126, an evaluation summary database (evaluation summary DB) 127, and many other databases.

Some of the plurality of types of databases may be stored in a storage that is provided separately from the sharing server 100. For example, some of the plurality of types of databases connected to a cloud service separate from the sharing server 100 and illustrated in FIG. 2 may be stored on that cloud. In this case, the sharing server 100 can access a necessary database by communicating with that cloud via the Internet 50.

The processor 101 connects to the Internet 50 via the communication interface 104, in accordance with the program stored in the memory 102. The processor 101 connects to the Internet 50 to communicate with the requester device 200 and the applicant device 300. The processor 101 accesses the database 120 and performs processing of extracting necessary data, processing of registering new data in the database 120, and processing of updating data registered in the database 120, or the like.

### [Configuration of Requester Device 200]

The requester device 200 includes a processor 201, a memory 202, a communication interface 203, an input/output interface 204, a display 205, and an operating unit 206. The operating unit 206 includes a mouse and a keyboard, or the like.

The memory 202 includes a RAM (Random Access Memory), a ROM (Read Only Memory), a flash memory, or any other suitable memory system. The memory 202 stores a program necessary for arithmetic processing of the processor 201 and temporary data calculated from the arithmetic processing, or the like.

The processor 201 connects to the Internet 50 via the communication interface 203, in accordance with the program stored in the memory 202. The processor 201 connects to the Internet 50 to communicate with the sharing server 100. The processor 201 communicates with the sharing server 100 and performs processing of transmitting a posted project, processing of displaying information on a member, who is an applicant, on the display 205, processing of ordering a task to a contractor selected from applicants, and processing of transmitting, to the sharing server 100, contents of an evaluation for a contractor that is input by a requester, or the like.

Information input by operating the operating unit 206 is notified to the processor 201 via the input/output interface 204.

### [Configuration of Applicant Device 300]

The applicant device 300 includes a processor 301, a memory 302, a communication interface 303, an input/output interface 304, a display 305, and an operating unit 306. The operating unit 306 includes a mouse and a keyboard, or the like.

The memory 302 includes a RAM (Random Access Memory), a ROM (Read Only Memory), a flash memory, or any other suitable memory system. The memory 302 stores a program necessary for arithmetic processing of the processor 301 and temporary data calculated from the arithmetic processing, or the like.

The processor 301 connects to the Internet 50 via the communication interface 303, in accordance with the program stored in the memory 302. The processor 301 connects to the Internet 50 to communicate with the sharing server 100. The processor 301 communicates with the sharing server 100 and performs processing of applying for a posted project, processing of displaying a notice of hiring or non-hiring of an applied project on the display 305, processing of transmitting, to the sharing server 100, performance of an accepted task, and processing of transmitting, to the sharing server 100, contents of an evaluation for a requester that is input by an applicant, or the like.

Information input by operating the operating unit 306 is notified to the processor 301 via the input/output interface 304.

### [Overview of Database 120]

In the following, an overview of the database 120 will be described. Information on companies affiliated with the matching system 1 is registered in a company database 121. Information on users who utilize the matching system 1 is registered in a member database 122. Many of the members are employees of the companies affiliated with the matching system 1.

The members registered in the member database 122 can act as a requester (orderer) or an applicant (contractor) by utilizing the matching system 1. The members may also include individuals (freelancers) who do not belong to a company, in addition to the employees belonging to the companies registered in the company database 121.

Information for identifying companies belonging to a community is stored in a community database 123. A community is formed by agreement between companies. Therefore, it is possible to form a plurality of communities, depending on how an agreement is reached between companies. It is also possible to set a number of companies that belong to one community in various ways. A relationship of mutual trust is formed between companies having a community relationship, to the extent defined by the manner of agreement when a community is formed. The information for identifying companies belonging to a community is registered in the community database 123, for each community.

Tasks (posted projects) for which contractors are solicited are registered in a posted project database 124. Employees of each company can be engaged in their main jobs in departments of companies to which they belong, while, as members of the matching system 1, the employees can accept orders for projects from other departments of their own companies or projects from other companies that are registered in the posted project database 124. In this case, the members accept the project from the other departments of their own companies or the projects from the other companies as a side job.

Data indicating side job statuses is registered for each of the members in a side job database 125. The data indicating side job statuses includes information on side job performance, planned side jobs, or the like.

Information on evaluations for applicants (contractors) and information on evaluations for requesters (orderers) are registered in an evaluation input database 126. By utilizing the matching system 1, requesters (orderers) can evaluate, as evaluators, work performance of applicants (contractors) who have completed tasks. By utilizing the matching system 1, the applicants (contractors) can evaluate, as evaluators, the requesters (orderers). Evaluations made by individual evaluators are registered in the evaluation input database 126.

Evaluation summaries are registered in an evaluation summary database 127. The evaluation summaries are registered for each member in the evaluation summary database 127. The evaluation summaries include a requester evaluation summary and an applicant evaluation summary. The requester evaluation summary indicates level of evaluation when the member behaves as a requester (orderer). The applicant evaluation summary indicates the level of evaluation when the member behaves as an applicant (contractor). The requester evaluation summary is created based on the evaluation for the requester from the applicant. The applicant evaluation summary is created based on the evaluation for the applicant from the requester.

Members can view the evaluation summaries. While viewing the applicant evaluation summary of each member, requesters can select a member considered to be suitable as a contractor. While viewing the requester evaluation summary of each member, applicants can apply for tasks of the requesters that are considered to be suitable.

### [Company Database 121]

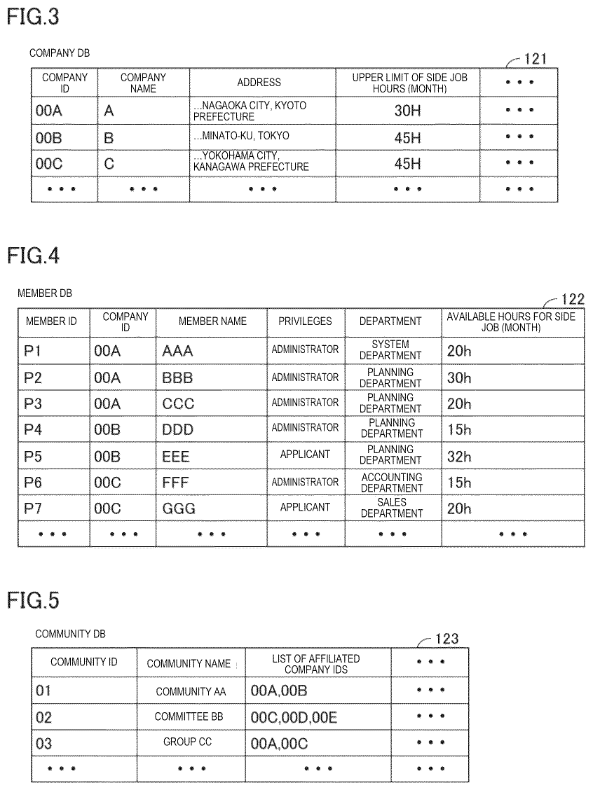

FIG. 3 is a diagram illustrating an example of the company database 121. In the company database 121, a company ID for identifying the company, a company name, a company address, and an upper limit of side job hours are registered for each company. The upper limit of side job hours is the upper limit of hours during which an employee is permitted to work in a project as a side job, separately from his/her main job. The upper limit of side job hours is defined for each company. For example, the upper limit of side job hours can be calculated using “prescribed overtime hours−overtime hours of a main job excluding a side job”. The prescribed overtime hours vary depending on the company. Note that FIG. 3 illustrates the upper limit of side job hours in months, but the upper limit of side job hours may be in weeks. A unit of the upper limit of side job hours may also be defined for each company.

In the present embodiment, a member is permitted to apply for a task solicited by various companies and departments and accept the task, to an extent that does not exceed the upper limit of side job hours defined by the company to which that member belongs.

### [Member Database 122]

FIG. 4 is a diagram illustrating an example of the member database 122. Various types of member information are registered in the member database 122. The various types of member information include a member ID for identifying a member, an ID of a company to which a member belongs, a member name, member privileges, a department to which a member belongs, and the upper limit of side job hours.

Types of member privileges include an administrator privilege and an applicant privilege. Members with the administrator privilege are granted a privilege to utilize the matching system 1 as a requester and an applicant. Members with the applicant privilege are granted the privilege to utilize the matching system 1, but not the privilege to utilize the matching system 1 as a requester. Department heads within a company are granted the administrator privilege to manage side job statuses of subordinates within departments. Administrators with the administrator privilege are granted the privilege to approve application from applicants who are their subordinates. Therefore, the administrators function as approvers.

Available hours for side job are remaining hours available for engagement in a side job. The available hours for side job are calculated using “the upper limit of side job hours−total side job hours”. If a target person is engaged in a plurality of side jobs, the total side job hours include hours that have already been spent on the plurality of side jobs. The total side job hours include expected hours for side job. The expected hours for side job are calculated using estimated man-hours registered in the posted project database 124. FIG. 4 illustrates the available hours for side job in months. For applicants who search for posted tasks utilizing the matching system 1, only tasks that can be completed within a range of the available hours for side job are provided, as projects for which they can apply.

### [Community Database 123]

FIG. 5 is a diagram illustrating an example of the community database 123. Information on communities formed between companies is registered in the community database 123. The information on communities includes a community ID for identifying a community, a community name, and a list of IDs of companies that belong to communities. Each company can form various communities by reaching an agreement with other companies. A company belonging to a community can change targeted companies belonging to the communities by reaching an agreement with other companies.

### [Posted Project Database 124]

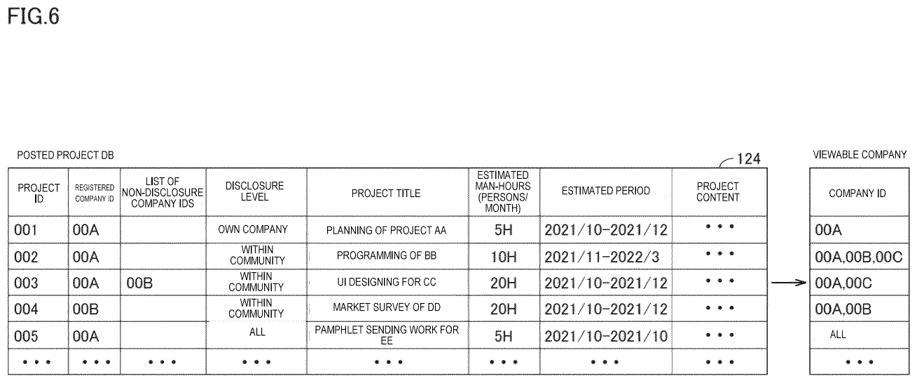

FIG. 6 is a diagram illustrating an example of the posted project database 124. Information on posted projects is registered in the posted project database 124. The information on posted projects includes a project ID for identifying a posted project, an ID of a company to which a requester who registered a posted project belongs, a list of non-disclosure company IDs, a disclosure level, a project title, estimated man-hours, an estimated period, and project contents.

The list of non-disclosure company IDs registers IDs of companies that prohibit disclosure of posted projects. Any of three levels of “Own Company”, “Within Community”, and “All” is set for the disclosure level. When the disclosure level is set to “All”, disclosure targets also include applicants outside the community.

To the right of the posted project database 124 in FIG. 6 are illustrated IDs of companies whose posted projects are viewable. For example, in a posted project corresponding to a project ID=001, the disclosure level is set to “Own Company”. In this case, only members belonging to the company (company ID=00A) that registered the posted project can view the posted project corresponding to the project ID=001.

Hereinafter, the posted projects corresponding to respective project IDs may be referred to as Project 001, Project 002, Project 003, . . . , using the project IDs. Similarly, the communities corresponding to respective community IDs may be referred to as Community 01, Community 02, Community 03, . . . , using the community IDs, and the members corresponding to respective member IDs may be referred to as Member P1, Member P2, Member P3, . . . , using the member IDs. In addition, hereinafter, the companies corresponding to respective company IDs may be referred to as Company A, Company B, Company C, . . . , using some of the company IDs.

In Project 002, the disclosure level is set to “Within Community”. According to the community database 123 illustrated in FIG. 5, companies having a community relationship with Company A, which registered Project 002, are Company B and Company C. Therefore, as illustrated in FIG. 6, only members belonging to any of Company A, Company B, and Company C can view Project 002.

The company that registered the posted project and the disclosure level of Project 003 are the same as those of Project 002. However, in Project 003, “00B” is registered in the list of non-disclosure company IDs. Therefore, as illustrated in FIG. 6, only members who belong to any of Company A and Company C can view Project 003, and members who belong to Company B are not granted the privilege to view Project 003.

For a posted project for which the disclosure level is set to “All”, all members can view the target posted project. This is the case for Project 005 illustrated in FIG. 6. If one or more company IDs are registered in the list of non-disclosure company IDs of Project 005, members who belong to the companies with those company IDs are not granted the privilege to view Project 005.

The estimated man-hours and the estimated period are used by applicants and the matching system 1 to estimate time to process a posted project.

### [Side Job Database 125]

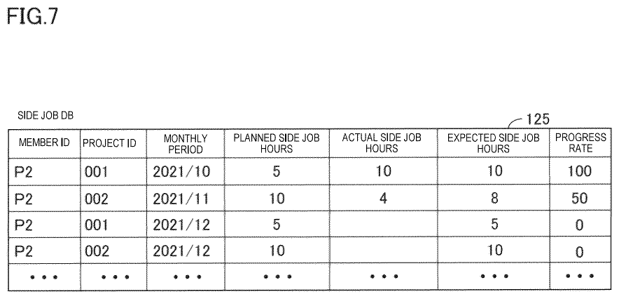

FIG. 7 is a diagram illustrating an example of the side job database 125. Information indicating side job statuses of the members is registered for each side job project in the side job database 125. The information indicating side job statuses includes an ID of a member engaged in a side job, a project ID, a monthly period (period of engagement in a side job), planned side job hours, actual side job hours, expected side job hours, and a progress rate.

The planned side job hours are hours considered necessary for the member to handle the project that he/she has accepted. Members who have accepted side jobs input monthly planned side job hours from their own applicant device 300. The input planned side job hours are reflected in the side job database 125. For example, the estimated man-hours for Project 001 are set to 5 hours/person/month in the posted project database 124. This means a workload is 5 hours per person per month. Usually, the members input the planned side job hours using the estimated man-hours for the posted project as a guide.

The actual side job hours are hours during which the member was actually engaged in the project that he/she has accepted. In other words, the actual side job hours are hours during which the member has already been engaged in actual work. Every time the member is engaged in the project, the member inputs hours during which he/she was engaged in the task of the project at any timing on his/her own applicant device 300, until the task of the project he/she has accepted is completed. The side job database 125 registers a cumulative value of the hours input on the applicant device 300 as the actual side job hours for each month.

The expected side job hours are hours expected to be necessary for the task of the target project. In other words, the expected side job hours are the time expected as the member's expected hours of labor in the future. The sharing server 100 automatically sets the expected side job hours, in consideration of the planned side job hours and the actual side job hours. The member may be able to/may be allowed to input the expected side job hours on his/her applicant device 300 at any timing, until the task of the target project is completed. In addition, the member may be once able to modify the expected side job hours that are automatically set. The expected side job hours may be equal to or less than the planned side job hours. However, depending on the situation of the project, the expected side job hours may be longer than the planned side job hours. The member engaged in the project may be able to/may be allowed to update the expected side job hours at any timing until the task of the project is completed.

The progress rate indicates a degree of progress of a side job. The progress rate is input at the discretion of the person engaged in the side job. The progress rate is input, for example, between 0(%) and 100(%).

For example, when the member initially accepts an order for a certain project, the progress rate is 0%, the actual side job hours are 0 hours, and the planned side job hours and the expected side job hours match. As the member proceeds with the task of the project, the expected side job hours change in conjunction with input of the actual side job hours and the progress rate.

The side job database 125 illustrated in FIG. 7 illustrates data for the side jobs of Member P2 from October 2021 to December 2021. By referring to the side job database 125 illustrated in FIG. 7, it can be seen that Member P2 was engaged in Project 001 and Project 002 between October 2021 and December 2021.

As data for the period of October for Project 001, the planned side job hours=5, the actual side job hours=10, and the expected side job hours=10 are registered in the side job database 125. It can be seen from this that in October, Member P2 was engaged in Project 001 beyond the planned side job hours.

As data for the period of November for Project 002, the planned side job hours=10, the actual side job hours=4, and the expected side job hours=8 are registered in the side job database 125. It can be seen from this that in November, Member P2 was engaged in Project 002 without exceeding the set expected side job hours. Since the progress rate is 50, it can be seen that in November, Member P2 completed half of the entire task for Project 002.

As data for the period of December for Project 001, the planned side job hours=5 and the expected side job hours=5 are registered in the side job database 125, and no actual side job hours are registered. Similarly to the data for the period of December for Project 002, no actual side job hours are registered. This means that input of the actual side job hours by Member P2 is awaited.

The sharing server 100 calculates the member's spare capacity to take on additional side jobs, using the expected side job hours and the actual side job hours in the side job database 125. When the member is engaged in a plurality of side jobs, the sharing server 100 calculates “total expected side job hours”, being a sum of the expected side job hours corresponding to the plurality of side jobs, and “total actual side job hours”, being a sum of the actual side job hours corresponding to the plurality of side jobs. The sharing server 100 calculates the spare capacity for side jobs by calculating “the upper limit of side job hours−(the total expected side job hours+the total actual side job hours)”. Here, if “the total expected side job hours+the total actual side job hours” is defined as “the total side job hours”, the spare capacity for side jobs, that is, the “available hours for side job” will be calculated using “the upper limit of side job hours−total side job hours”. For example, in the side job database 125 illustrated in FIG. 7, the total expected side job hours, being the sum of the expected side job hours of Member P2 for December, are 15 hours (5 hours+10 hours). In addition, the total actual side job hours of Member P2 for December are zero. At this time, if the “upper limit of side job hours” defined at the company to which Member P2 belongs is 30 hours, the Member P2's spare capacity for side job (the available hours for side job) is calculated as 15 hours (30 hours−15 hours).

Here, an example of a more specific procedure for calculating the expected side job hours will be described. For example, the “expected side job hours” may be calculated based on a calculation formula of “(man-hour progress rate)/progress rate)×planned side job hours−actual side job hours”. Here, the “man-hour progress rate” is calculated by the “actual side job hours/planned side job hours”. As already described, the “progress rate” is a rate that is input into the side job database 125 at the discretion of the person engaged in the side job.

For example, when the planned side job hours=10 hours and the actual side job hours=2 hours, the man-hour progress rate is calculated to be 20%. Here, the progress rate is assumed to be 40%. At this time, the expected side job hours are calculated to be “(208/40%)×10 hours−2 hours”=3 hours. That is, according to this calculation result, the expected side job hours for the target side job are 3 hours.

### [Evaluation Input Database 126]

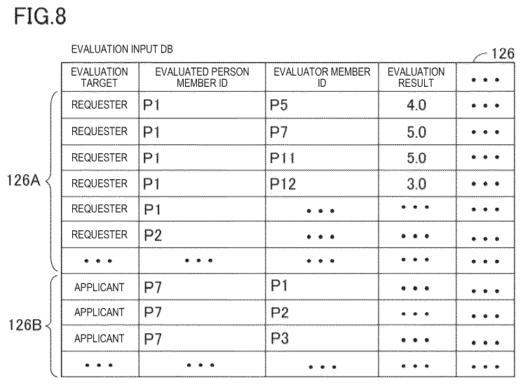

FIG. 8 is a diagram illustrating an example of the evaluation input database 126. Information on evaluations on evaluated persons is registered in the evaluation input database 126. The information on evaluations includes an evaluation target, a member ID of an evaluated person, a member ID of an evaluator, and an evaluation result.

The evaluation input database 126 includes a requester evaluation unit 126A and an applicant evaluation unit 126B. Information on evaluations for requesters (orderers) is registered in the requester evaluation unit 126A. Information on evaluations for applicants (contractors) is registered in the applicant evaluation unit 126B.

In the requester evaluation unit 126A, the requester (orderer) corresponds to an evaluation target (evaluated person), and an applicant who applied for a solicited task of the party to be evaluated and accepted an order for the task corresponds to an evaluator. An evaluation for the evaluated person is registered for each evaluated person in the requester evaluation unit 126A. FIG. 8 illustrates an example in which Members P1 and P2, who correspond to evaluated persons, are evaluated by evaluator members. In particular, FIG. 8 illustrates an example in which Member P1 is evaluated by each of Evaluator Members P5, P7, P11, and P12. Evaluation results (evaluation values) are expressed by a numerical value with 10 being the maximum value and 0 being the minimum value.

In the applicant evaluation unit 126B, the applicant (contractor) for the posted project corresponds to the evaluation target (evaluated person), and the requester (orderer) of that project corresponds to the evaluator. An evaluation for the evaluated person is registered for each evaluated person in the applicant evaluation unit 126B. FIG. 8 illustrates an example in which Member P7, who corresponds to the evaluated person, is evaluated by each of Members P1, P2, and P3, who correspond to the evaluators. Note that in FIG. 8, an example of evaluation results in the applicant evaluation unit 126B is omitted, but various evaluation results are registered therein, similarly to the requester evaluation unit 126A.

The applicant (contractor), when the task that he/she accepted from the requester (orderer) is completed, evaluates the evaluated person who is the requester, as the evaluator, using the applicant device 300. The result of evaluator's evaluation is registered in the evaluation input database 126. When an applicant accepts an order for another task again from a requester from whom the applicant has previously accepted a task, the applicant evaluates the requester again. In this case, an average value of the previous evaluation result and the subsequent evaluation result is registered in the evaluation input database 126.

When the applicant (contractor) completes the task requested by the requester (orderer), the requester (orderer) evaluates the evaluated person who is the applicant (contractor), as the evaluator, using the requester device 200. The result of evaluator's evaluation is registered in the evaluation input database 126. When a requester places an order for another task again to an applicant whom the requester has previously requested to undertake a task, the requester evaluates the applicant again. In this case, an average value of the previous evaluation result and the subsequent evaluation result is registered in the evaluation input database 126.

Therefore, the average values of evaluations for the evaluated persons by respective evaluators are reflected in the evaluation results registered in the evaluation input database 126. Note that instead of the average values, a weighted average value calculated according to the number of evaluations and a deviation value, or the like, may be adopted. The evaluation input database 126 may further register evaluation results for each project ID.

### [Evaluation Summary Database 127]

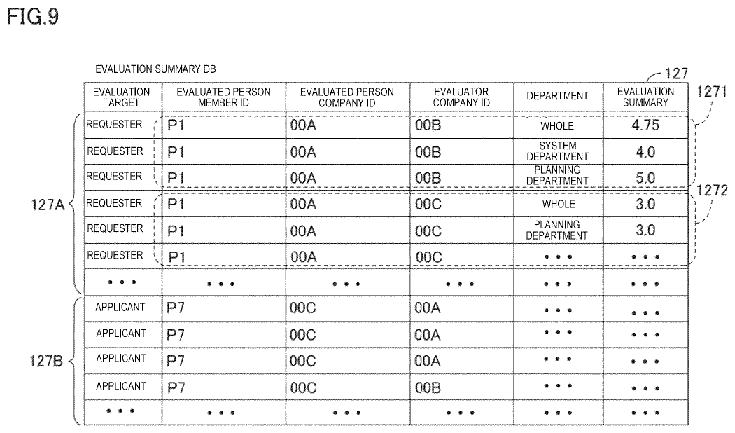

FIG. 9 is a diagram illustrating an example of the evaluation summary database 127. Information on evaluations of evaluated persons by department is registered in the evaluation summary database 127. The information on evaluations by department includes an evaluation target, a member ID of an evaluated person, an ID of a company to which an evaluated person belongs, an ID of a company to which an evaluator belongs, a department to which an evaluator belongs, and an evaluation summary.

The evaluation summary database 127 includes a requester evaluation summary unit 127A and an applicant evaluation summary unit 127B. In the requester evaluation summary unit 127A, the requester (orderer) corresponds to the evaluation target (evaluated person). In the applicant evaluation summary unit 127B, the applicant (contractor) corresponds to the evaluation target (evaluated person). Evaluation summaries for the evaluation targets are registered by department in the evaluation summary database 127.

An evaluation summary is calculated based on aggregate results of the evaluation input database 126. Department categories include each department such as “System Department” or “Planning Department” that belong to a company, and “Whole” meaning a company as a whole. The evaluation summary is calculated for each of such “departments”.

FIG. 9 illustrates an example in which Member P1 corresponds to an evaluated person as the requester evaluation summary unit 127A. The company ID of the evaluated person is “00A”. Therefore, Member P1 belongs to Company A. In FIG. 9, a data group 1271 represents Company B's evaluation for Member P1 who behaves as the requester, and a data group 1272 represents Company C's evaluation for Member P1 who behaves as the requester.

With reference to the data group 1271, it can be seen that the Company B's evaluation is classified into an evaluation as the company as a whole, an evaluation of System Department within Company B, and an evaluation of Planning Department within Company B. An average value corresponding to each of the classified categories is registered in the evaluation summary.

For example, as the evaluation summary corresponding to Company B as a whole, an average value of evaluation results of Company B's members who evaluated Member P1 who behaves as the requester is registered. In FIG. 9, that value is “4.75”. As the evaluation summary corresponding to System Department, an average value of the evaluation results of the members of System Department, among the members of Company B who evaluated Member P1 who behaves as the requester, is registered. In FIG. 9, that value is “4.0”. As the evaluation summary corresponding to Planning Department, an average value of the evaluation results of the members of Planning Department, among the members of Company B who evaluated Member P1 who behaves as the requester, is registered. In FIG. 9, that value is “5.0”.

Also, for the data group 1272, similarly to the data group 1271, Company C's evaluation is classified into an evaluation as the company as a whole and evaluation of each department within Company C. The data groups 1271 and 1272 are data having the requester as the evaluation target. Therefore, the evaluation summaries registered in the data groups 1271 and 1272 are the requester evaluation summaries.

The requester evaluation summary unit 127A has been described above in detail. Next, the applicant evaluation summary unit 127B will be described. FIG. 9 illustrates an example in which Member P7 corresponds to an evaluated person as the applicant evaluation summary unit 127B. The company ID of the evaluated person is “00C”. Therefore, Member P7 belongs to Company C. In the applicant evaluation summary unit 127B, evaluation by each department for Member P7 who behaves as the applicant is registered.

The applicant evaluation summary unit 127B has a similar configuration to the requester evaluation summary unit 127A, except that the evaluation target is the “applicant” and not the “requester”. Therefore, here, the description of the requester evaluation summary unit 127A already given will replace the description of the applicant evaluation summary unit 127B.

The sharing server 100 identifies the evaluation result of each member, using the evaluation input database 126, and identifies affiliation of each member, using the member database 122. The sharing server 100 updates the data in the evaluation summary database 127, based on these identification results.

Note that in FIG. 9, only Members P1 and P7 are illustrated as the evaluated persons, but other Members P2 to P6, Member P8, and Member P9 . . . are similarly registered as the evaluated persons in the evaluation summary database 127. The evaluation summary database 127 may include data in which a same member is the evaluation target as a requester and an applicant. For example, in the evaluation summary database 127 illustrated in FIG. 9, the applicant evaluation summary regarding Member P1 may be registered, in addition to the requester evaluation summary regarding Member P1.

### [Functions of Sharing Server, Requester Device, and Applicant Device]

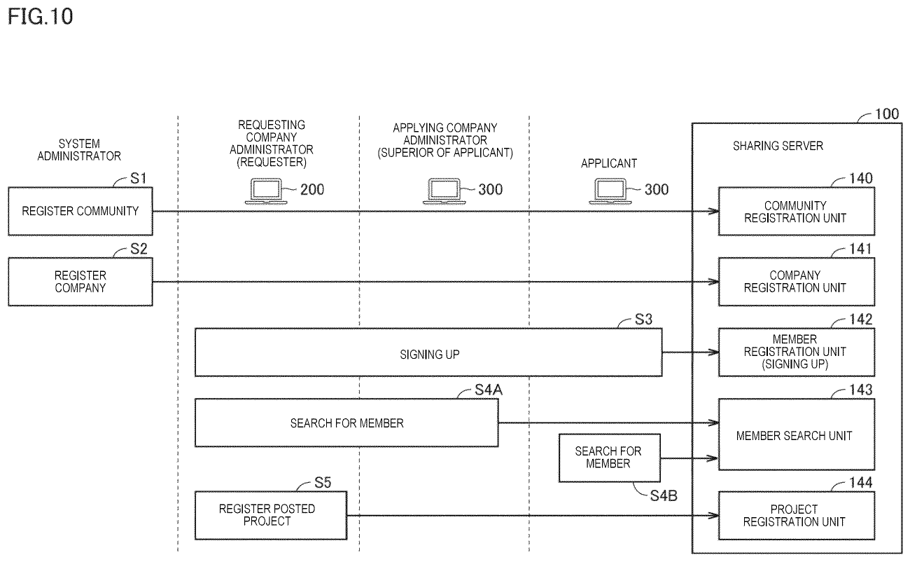

FIG. 10 to FIG. 12 are diagrams for describing functions of the sharing server, the applicant device, and the requester device.

As illustrated in FIG. 10, the sharing server 100 functionally includes a community registration unit 140, a company registration unit 141, a member registration unit 142, a member search unit 143, and a project registration unit 144. These various types of functions are realized by the processor 101, the memory 102, the storage 103, and the communication interface 104 that the sharing server 100 includes. As used herein, the term “unit” refers to circuitry that may be configured via the execution of computer readable instructions, and the circuitry may include one or more local processors (e.g., CPU's), and/or one or more remote processors, such as a cloud computing resource, or any combination thereof.

The community registration unit 140 includes a function to register a community in the community database 123. A system administrator who manages the matching system 1 uses an operating unit, such as a keyboard (not illustrated), or the like, to input information regarding the community into the sharing server 100.

The information regarding the community includes a community name, and information on the companies belonging to the community. The community registration unit 140 registers communities in the community database 123, according to input by the system administrator (step S1). The community registration unit 140 further includes a function to update the information on the communities registered in the community database 123.

The company registration unit 141 includes a function to register a new company affiliated with the matching system 1. The system administrator inputs the information regarding the company into the sharing server 100, using the operating unit such as the keyboard, or the like.

The information regarding the company includes a company name, an address, the upper limit of side job hours, or the like. The company registration unit 141 sets the company in the company database 121, according to input by the system administrator (step S2). The company registration unit 141 further includes a function to update the company information that has been already registered.

The member registration unit 142 includes a function to register (sign up) a new member who joins the matching system 1. The member registration unit 142 issues a member ID and a password in response to a request from those who belong to the company affiliated with the matching system 1. Those who wish to become a member perform sign up processing, using a personal computer, or the like (step S3). Thus, the registration is reliable and verified.

Specifically, a person who wishes to become a member inputs information such as his/her name, a company to which he/she belongs, a department to which he/she belongs, and the like, in a personal computer, or the like, and transmits the input information to the sharing server 100. The member registration unit 142 registers, i.e., verifies and stores, the input information in the member database 122. A new member can sign in to the sharing server 100 using the personal computer used for member registration. In this case, the personal computer functions as the requester device 200 or the applicant device 300.

FIG. 10 illustrates two applicant devices 300. One is a device that is assumed to be operated by an administrator of the applying company. The other is a device that is assumed to be operated by someone in the applying company other than the administrator. The administrator of the applying company is engaged in management positions such as a department head, or the like, and corresponds to the superior of the applicant who is his/her subordinate. In the present embodiment, the administrator of the applying company assumes a role as an approver who approves application by the subordinate for a posted project.

The member search unit 143 includes a function to search for members of the matching system 1. In response to requests from the requester device 200 and the applicant device 300, the member search unit 143 provides the requester device 200 and the applicant device 300 with the member information registered in the member database 122.

When receiving an operation to search for a requester, the requester device 200 performs member search processing (step S4A). This enables the requester to view, for example, information on applicants. The requester can select an applicant to accept a task from among a plurality of applicants, considering information on the applicants. Similarly, when receiving an operation to search for a supervisor who corresponds to a superior of a certain applicant, the applicant device 300 performs the member search processing (step S4A).

Furthermore, when receiving an operation to search for an applicant, the applicant device 300 performs the member search processing (step S4B). This enables the applicant to view, for example, information on the requester. The applicant can select a task for which he/she accepted an order, from a plurality of posted tasks, considering information on requesters.

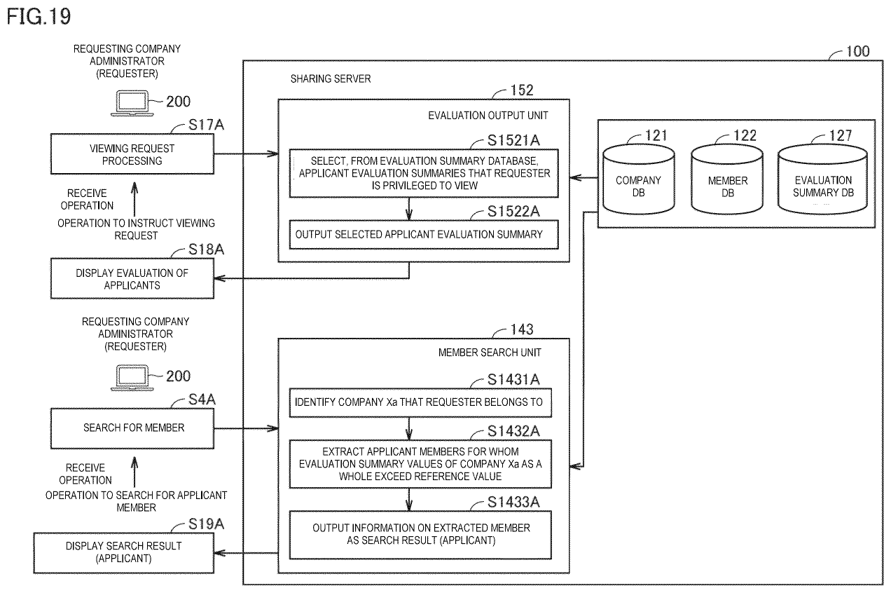

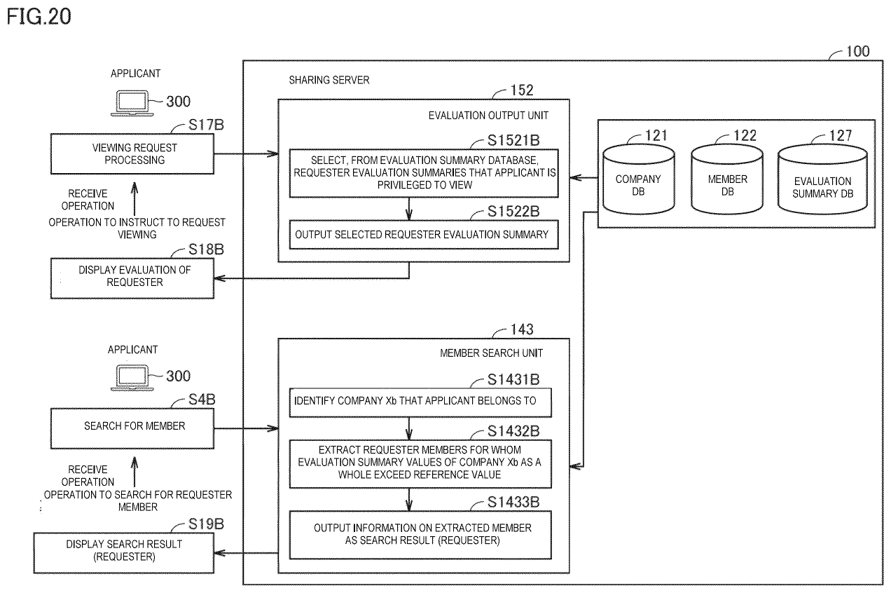

The member search processing (step S4A) performed by the requester device 200 and the processing by the member search unit 143 will be described later in detail with reference to FIG. 19. The member search processing (step S4B) performed by the applicant device 300 and the processing by the member search unit 143 will be described later in detail with reference to FIG. 20.

The project registration unit 144 includes a function to register posted projects in the posted project database 124. When receiving an operation to input a posted project, the requester device 200 performs processing of registering the posted project (step S5). In the processing of registering a posted project, the requester device 200 transmits information on the posted project to the sharing server 100. The project registration unit 144 registers the received information on the posted project in the posted project database 124.

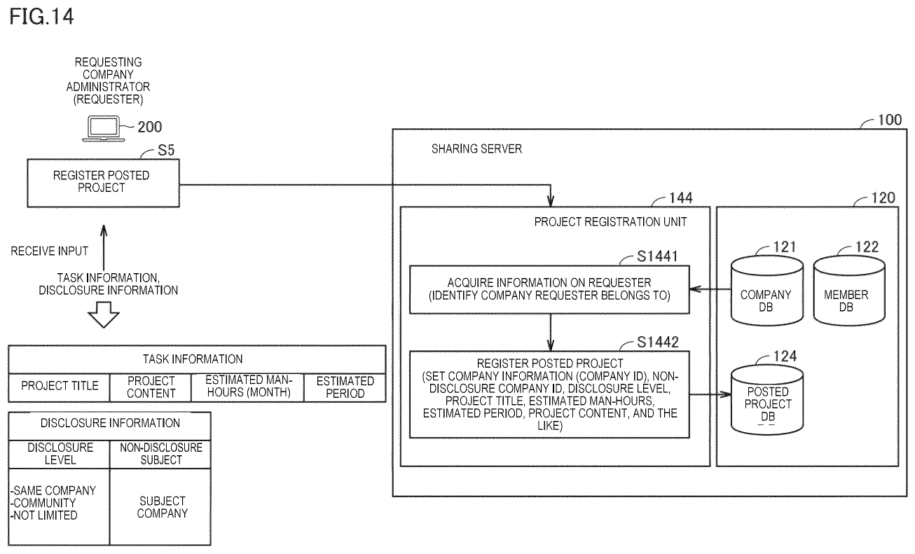

The posted project registration processing (step S5) performed by the requester device 200 and the processing by the project registration unit 144 will be described later in detail with reference to FIG. 14.

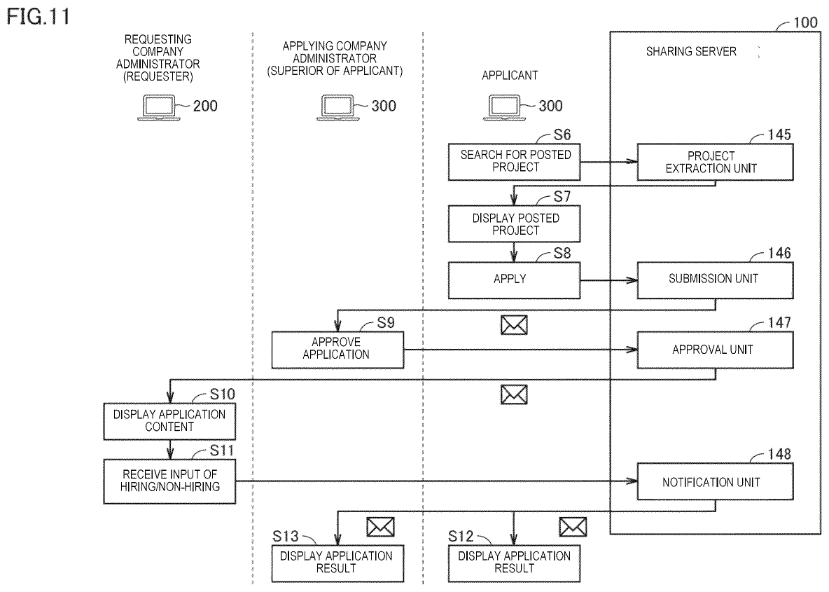

As illustrated in FIG. 11, the sharing server 100 functionally includes a project extraction unit 145, a submission unit 146, an approval unit 147, and a notification unit 148. These various types of functions are realized by the processor 101, the memory 102, the storage 103, and the communication interface 104 that the sharing server 100 includes.

The project extraction unit 145 includes a function to extract a posted project that can be viewed by the applicants. The submission unit 146 includes a function to submit an application by an applicant to a supervisor (the applicant's superior). The approval unit 147 includes a function to transmit contents of the application for the posted project to the requester, on the condition that an approval for the application has been received from the supervisor (approver). The notification unit 148 has a function to receive, from the requester, a result of whether or not to hire the applicant, and to notify the applicant and the supervisor of the result.

The submission unit 146, the approval unit 147, and the notification unit 148 realize notification to the supervisor asking for approval, notification of an applicant to a requester, and notification of an application result to an applicant through a workflow system.

When receiving an applicant's operation requesting a search for posted projects, the applicant device 300 performs processing of searching for posted projects (step S6). In the processing of searching for posted projects, the applicant device 300 transmits a search request to the project extraction unit 145 of the sharing server 100.

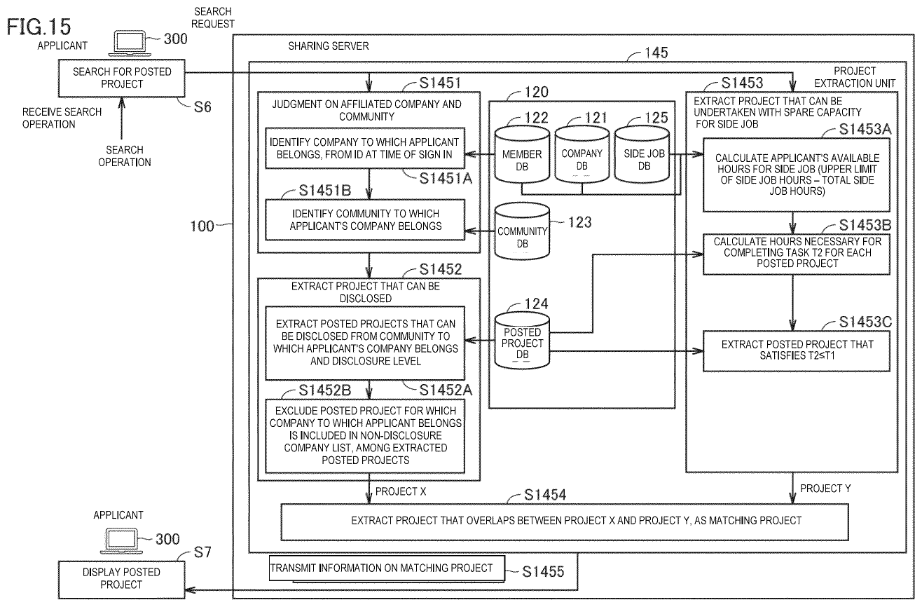

When receiving the search request, the project extraction unit 145 extracts a project allowed to be viewed by the applicant, from among the posted projects registered in the posted project database 124, and transmits the extracted project to the applicant device 300. The project extraction unit 145 judges that the project is allowed to be viewed by the applicant, based on a first criterion and a second criterion. The first criterion is a disclosure range set for posted projects. The second criterion is an applicant's spare capacity for a side job. The disclosure range is defined by disclosure information illustrated in FIG. 14. The spare capacity for a side job is calculated as the available hours for side job illustrated in FIG. 15.

The project extraction unit 145 determines a project that satisfies both the first and second criteria, as the project allowed to be viewed by the applicant. Therefore, the project extraction unit 145 extracts a project that is permitted to be disclosed to the applicant who received the search request, from among the posted projects registered in the posted project database 124. Furthermore, the project extraction unit 145 extracts a project that can be handled within the available hours for side job of the applicant who received the search request, from among the posted projects registered in the posted project database 124. The project extraction unit 145 transmits the project allowed to be viewed by the applicant to the applicant device 300.

The project extraction unit 145 may receive an operation to set a criterion for extracting projects. For example, a function may be added to the sharing server 100 that allows the system administrator to select any of first setting to enable only the first criterion, second setting to enable only the second criterion, and third setting to enable both the first and second criteria.

The applicant device 300 receives posted projects from the project extraction unit 145. The applicant device 300 displays the received posted projects on the display 305 (step S7).

Note that the posted project search processing (step S6), the processing of displaying a posted project (step S7), and the processing of the project extraction unit 145 will be described later in detail with reference to FIG. 15.

At the applicant device 300, the applicant performs an operation to select an application target from the posted projects displayed on the display 305. The applicant device 300 performs application processing in response to operations by the applicant (step S8). In the application processing, the applicant device 300 transmits application information listing projects to be applied for to the submission unit 146 of the sharing server 100. As a result, a request to accept an order for the task is transmitted from the applicant device 300 to the submission unit 146.

The submission unit 146 transmits the application information received from the applicant device 300 to the applicant device 300 of the supervisor (applicant's superior). The submission unit 146 identifies a member ID of the superior, who is the supervisor of the applicant, for example, based on a relationship between the applicant's member ID and the superior's member ID that are registered in the member database 122. The submission unit 146 transmits the subordinate's application information to the applicant device 300 corresponding to the identified superior's member ID. The supervisor checks the task for which his/her subordinate is applying, on his own applicant device 300. The supervisor performs an operation to approve the application on the applicant device 300. The applicant device 300 receives an approval operation, and performs processing of approving the application (step S9). In the processing of approving the application, the applicant device 300 transmits approval information to the approval unit 147 of the sharing server 100. As a result, the approval information, which is an example of an approval notice, is transmitted from the applicant device 300 of the supervisor (approver) to the approval unit 147.

The approval unit 147 receives the applicant's application on the condition that the approval information has been received from the applicant device 300. As such, in the present embodiment, the applicant's application is received on the condition that approval has been given by the supervisor to whom the applicant belongs. Therefore, the supervisor can check in advance contents of the posted task for which his/her subordinate plans to apply. Consequently, it is possible to prevent confidential information from being leaked outside the company through employees' side job actions.

Note that FIG. 11 illustrates a flow when the supervisor approves the application. If an operation to reject the application is received in step S9, rejection information is transmitted from the applicant device 300 of the supervisor to the approval unit 147. When receiving the rejection information, the approval unit 147 may notify the applicant device 300 of the applicant that the application has been rejected.

The approval unit 147 that has received the applicant's application transmits the application information to the requester device 200. The application information includes information on the applicant and contents of the task to be applied for. The requester device 200 displays contents of the application on the display 205 (step S10). The requester checks the applicant and the task for which the applicant has applied based on the display on the display 205, and determines whether or not to hire the applicant.

The requester inputs the result of the determination on hiring or non-hiring into the requester device 200. The requester device 200 receives the input result (step S11). The requester device 200 transmits the received result of hiring or non-hiring to the notification unit 148 of the sharing server 100.

When receiving the result of hiring or non-hiring from the requester device 200, the notification unit 148 transmits the application result (result of hiring or non-hiring) to the applicant device 300 of the applicant and the applicant device 300 of the supervisor.

The applicant device 300 of the applicant and the applicant device 300 of the supervisor display the application result on the display 305 (step S12 and step S13). The applicant and the supervisor confirm the application result by looking at the display on the display 305.

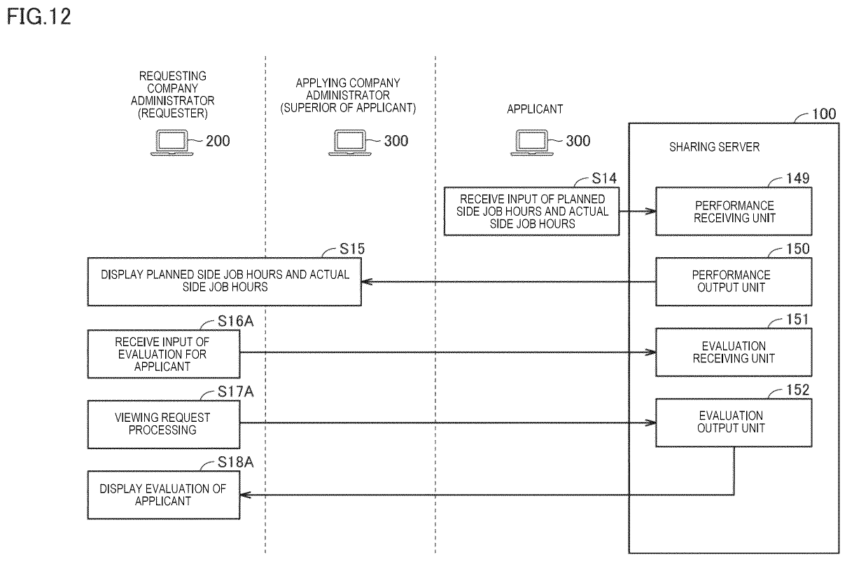

As illustrated in FIG. 12, the sharing server 100 functionally includes a performance receiving unit 149, a performance output unit 150, an evaluation receiving unit 151, and an evaluation output unit 152. These various types of functions are realized by the processor 101, the memory 102, the storage 103, and the communication interface 104 that the sharing server 100 includes.

The performance receiving unit 149 includes a function to receive planned side job hours and actual side job hours input by the applicant on the applicant device 300. The performance output unit 150 includes a function to output information including the applicant's planned side job hours and actual side job hours to the requester device 200 or the supervisor's applicant device 300.

The evaluation receiving unit 151 includes a function to receive the evaluation for the applicant (contractor) that is input by the requester on the requester device 200. The evaluation output unit 152 includes a function to output information indicating the evaluation for the applicant to the requester device 200.

When being engaged in a side job, the applicant inputs the planned side job hours and the actual side job hours in the applicant device 300. When accepting an order for a new side job, the applicant usually inputs the planned side job hours into the applicant device 300, and inputs the actual side job hours into the applicant device 300 at any timing while being engaged in the side job. For example, when accepting an order for a task that is estimated to span a plurality of months, as a side job, the applicant inputs the actual side job hours for each month into the applicant device 300.

The applicant device 300 receives input of the planned side job hours and the actual side job hours (step S14). The applicant device 300 transmits the received planned side job hours and actual side job hours to the performance receiving unit 149 of the sharing server 100.

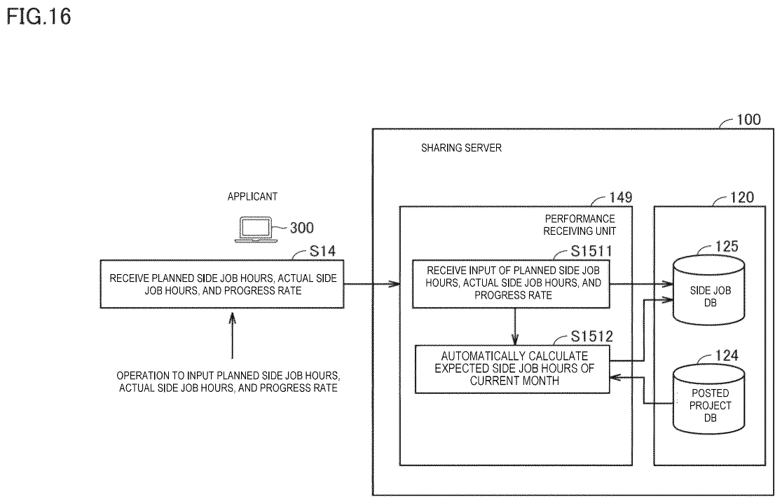

The performance receiving unit 149 registers the received planned side job hours and actual side job hours in the side job database 125. The processing of step S14 performed by the applicant device 300 and the processing of the performance receiving unit 149 will be described later in detail with reference to FIG. 16.

The performance output unit 150 transmits the planned side job hours and the actual side job hours registered in the side job database 125 to the requester device 200 and the supervisor's applicant device 300. The requester device 200 displays the received planned side job hours and actual side job hours on the display 205, and the supervisor's applicant device 300 displays information including the received planned side job hours and actual side job hours on the display 305 (step S15). However, when the information transmitted to the requester device 200 and the information transmitted to the supervisor's applicant device 300 are compared, the projects to be transmitted are different.

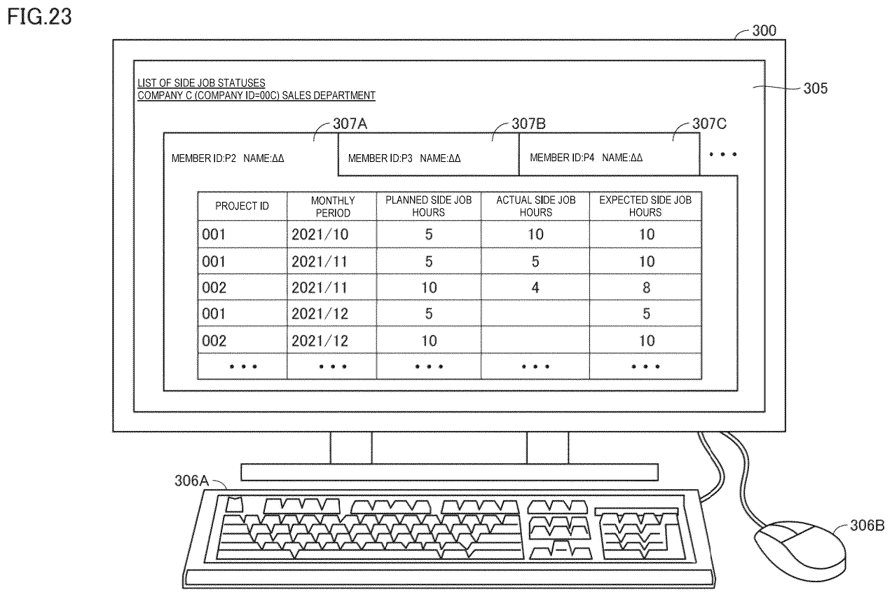

Data corresponding to the project of which the subordinate is in charge, among the many projects registered in the side job database 125, is transmitted from the performance receiving unit 149 to the supervisor's applicant device 300. The supervisor can check the subordinate's side job status by looking at the display 305. Note that the screen to be displayed on the supervisor's applicant device 300 when the supervisor checks the subordinate's side job status will be described later with reference to FIG. 23.

Data corresponding to the project solicited by the requester among the many projects registered in the side job database 125 is transmitted from the performance receiving unit 149 to the requester device 200. For example, in the side job database 125 illustrated in FIG. 7, consider a case in which, among a plurality of requesters, a first requester solicits Project 001 and a second requester solicits Project 002.

In this case, various types of data corresponding to Project 001 in the side job database 125 is transmitted from the performance receiving unit 149 to the requester device 200 operated by the first requester. Various types of data corresponding to Project 002 in the side job database 125 is transmitted from the performance receiving unit 149 to the requester device 200 operated by the second requester.

The first requester and the second requester can check how his/her own project progresses, by viewing the planned side job hours, the actual side job hours, and the like, displayed on the display 205 of the requester device 200.

When the side job is completed, the requester inputs an evaluation for the applicant in the requester device 200. The requester device 200 receives input of the evaluation for the applicant (step S16A). Therefore, when receiving the input evaluation, the requester device 200 functions as the evaluator device operated by the evaluator (requester).

The requester device 200 transmits the received evaluation to the evaluation receiving unit 151 of the sharing server 100. The evaluation receiving unit 151 updates the evaluation input database 126 and the evaluation summary database 127 based on the received evaluation. As a result, the information in the applicant evaluation unit 126B is updated in the evaluation input database 126, and the information in the applicant evaluation summary unit 127B is updated in the evaluation summary database 127.

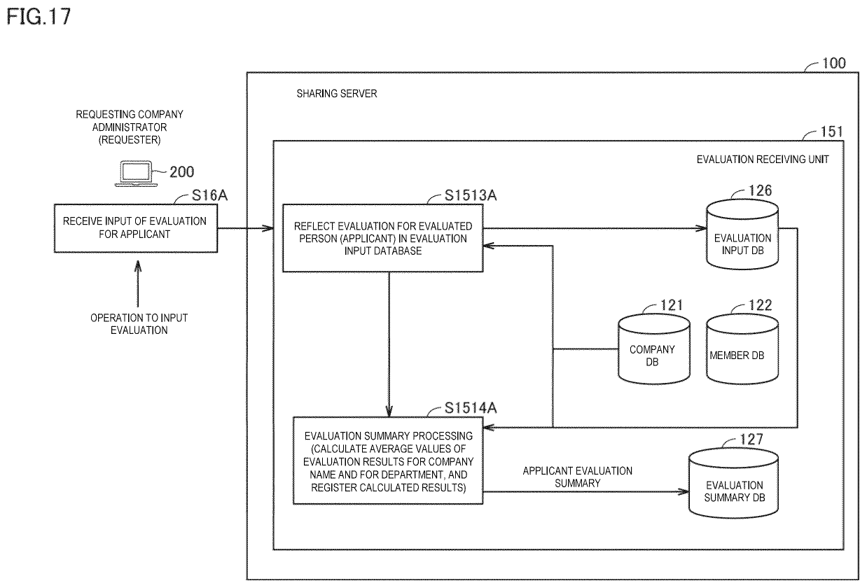

The processing of step S16A performed by the requester device 200 and the processing of the evaluation receiving unit 151 will be described later in detail with reference to FIG. 17.

When receiving an operation for the requester to view the applicant's evaluation, the requester device 200 performs viewing request processing (step S17A). In the viewing request processing, the requester device 200 transmits a viewing request to the evaluation output unit 152 of the sharing server 100. In response to the viewing request, the evaluation output unit 152 transmits the evaluation for applicant (applicant evaluation summary) registered in the evaluation summary database 127 to the requester device 200. The requester device 200 displays the evaluation for applicant on the display 205 (step S18A).

The processing of step S17A and step S18A performed by the requester device 200 and the processing of the evaluation output unit 152 will be described later in detail with reference to FIG. 19.

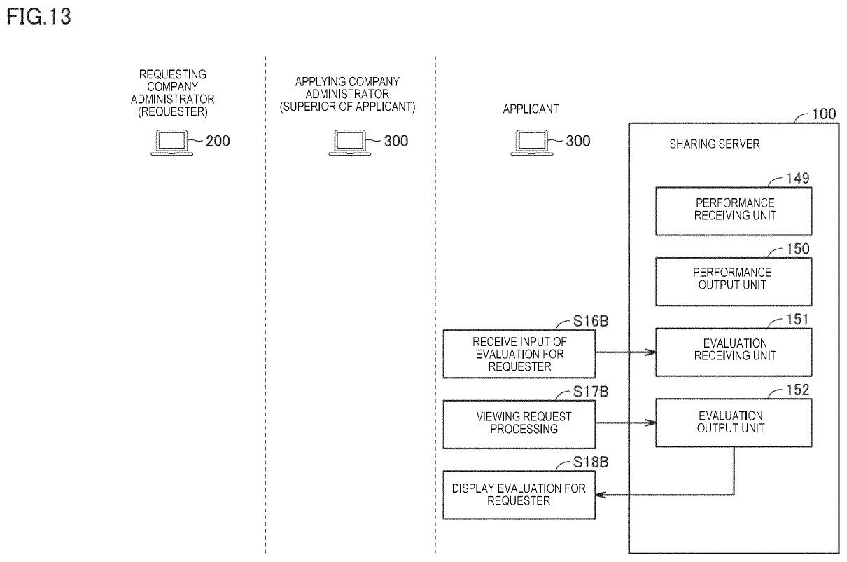

FIG. 13 is a diagram for further explaining the function of the applicant device 300. Here, input and output of the evaluation for the requester will be described with reference to FIG. 13. The evaluation receiving unit 151 further includes a function to receive the evaluation for the requester that is input by the applicant on the applicant device 300. The evaluation output unit 152 further includes a function to output information indicating the evaluation for the requester to the applicant device 300. When completing the task for which the applicant received an order, the applicant inputs the evaluation for the requester into the applicant device 300. There are various points in which the applicant evaluates the requester.

For example, when the applicant could communicate smoothly with the requester and complete the task within an appropriate period of time, the applicant would highly evaluate the requester. Conversely, if there are a number of requests for additions, changes, and modifications to the task contents, when too many man-hours are spent outside the scope of the task, when instructions are communicated too late, and instructions on modification of the task contents are given unilaterally without prior consultation, the applicant would poorly evaluate the requester.

The applicant device 300 receives input of the evaluation for the requester (step S16B). Therefore, when receiving the input evaluation, the applicant device 300 functions as an evaluator device operated by the evaluator (applicant).

The applicant device 300 transmits the received evaluation to the evaluation receiving unit 151 of the sharing server 100. The evaluation receiving unit 151 updates the evaluation input database 126 and the evaluation summary database 127 based on the received evaluation. As a result, the information in the requester evaluation unit 126A is updated in the evaluation input database 126, and the information in the requester evaluation summary unit 127A is updated in the evaluation summary database 127.

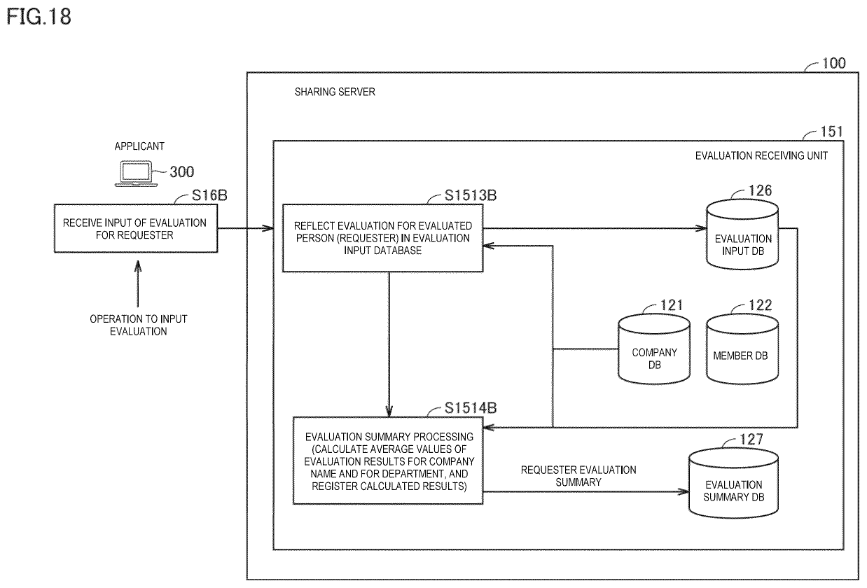

The processing of step S16B performed by the applicant device 300 and the processing of the evaluation receiving unit 151 will be described later in detail with reference to FIG. 18.

When receiving an operation for the applicant to view the evaluation for the requester, the applicant device 300 performs the viewing request processing (step S17B). In the viewing request processing, the requester device 200 transmits a viewing request to the evaluation output unit 152 of the sharing server 100. In response to the viewing request, the evaluation output unit 152 transmits the evaluation for the requester (requester evaluation summary) registered in the evaluation summary database 127 to the applicant device 300. The applicant device 300 displays the received evaluation for the requester on the display 305 (step S18B).

The step S17B performed by the applicant device 300, the processing of step S18B, and the processing of the evaluation output unit 152 will be described later in detail with reference to FIG. 20.

### [Details of Processing of Project Registration Unit 144 and Requester Device 200]

FIG. 14 is a diagram for explaining a procedure for registering a posted project in the posted project database 124. The step S5 of FIG. 10 and the function of the project registration unit 144 will be described in more detail with reference to FIG. 14.

The requester who registers a posted project first signs in to the sharing server 100, using the requester device 200. This establishes a logical communication path identified by the requester's member ID between the requester device 200 and the sharing server 100. Then, the requester inputs task information and disclosure information of the posted project into the requester device 200, using the operating unit 206 such as a mouse and a keyboard, or the like.

The information input by the operating unit 206 is notified to the processor 201 via the input/output interface 204 of the requester device 200. The operating unit 206 and the input/output interface 204 constitute an interface that receives an operation to input task contents, and an operation to input the disclosure information that specifies a target to which the task is disclosed.

The task information for the posted project includes a project title, project contents, estimated man-hours (person/month), and an estimated period. The disclosure information may include a disclosure level. The disclosure information may include an ID of a company which is a non-disclosure target, depending on a requester's selection.

The requester device 200 receives input of the task information and the disclosure information of the posted project, and performs processing of registering the posted project (step S5). In the processing of registering the posted project, the requester device 200 transmits the task information and the disclosure information of the posted project to the sharing server 100.

The project registration unit 144 of the sharing server 100 acquires information on the requester (step S1441). Specifically, the project registration unit 144 specifies the company to which the requester belongs.

When a member signs in the sharing server 100 using the requester device 200 or the applicant device 300, the sharing server 100 stores the member ID used in the sign-in. When the sharing server 100 receives any information from the requester device 200 or the applicant device 300 in communication established by this member ID, the sharing server 100 identifies the member who is the source of the information using the member ID used in the sign-in.

Therefore, when receiving the task information and the disclosure information of the posted task from the requester device 200, the project registration unit 144 uses the member ID used in the sign-in to identify the requester who operates the requester device 200. The project registration unit 144 uses the identified member ID, the member database 122, and the company database 121 to identify the member, who is the requester, and the company to which the requester belongs.

Next, the project registration unit 144 performs processing to register the posted project in the posted project database 124 (step S1442). Specifically, after generating a project ID, the project registration unit 144 registers company information (company ID), an ID of a company not to be disclosed, a disclosure level, a project title, estimated man-hours, an estimated period, project contents, and the like, in the posted project database 124, in association with the generated project ID.

According to the present embodiment, the requester can freely control the disclosure range of the posted project at the level of “Within Own Company”, “Within Community”, and “Not Limited”. Consequently, it is possible to prevent a posted project from being disclosed to a specific company without the requester's intention.

According to the present embodiment, a company not to be disclosed can be set separately from the disclosure level. For this reason, the requester can set the disclosure range by excluding some companies among a plurality of companies having a community relationship with the company to which the requester belongs. Consequently, it is possible to prevent a task related to a specific company within the community from being disclosed to that specific company.

Instead of or in addition to the list of non-disclosure company IDs, the posted project database 124 may be provided with a list of non-disclosure member IDs for registering IDs of members to whom disclosure of posted project is prohibited. The requester device 200 may receive an operation to specify a member to whom disclosure of posted projects is prohibited, and transmit that member's ID to the sharing server 100. The sharing server 100 may choose not to provide the member corresponding to the member ID listed in the list of non-disclosure member IDs with the posted project corresponding to that list. In this manner, the requester device 200 may receive any of the company and the member as a target party to which disclosure of tasks is prohibited.

FIG. 15 is a diagram for explaining a procedure for searching for a posted project from the database 120. The processing of step S6 and step S7 of FIG. 11 and the function of the project extraction unit 145 will be described in more detail with reference to FIG. 15.

When receiving the applicant's operation requesting a search for a posted project, the applicant device 300 performs processing of searching for the posted project (step S6). In the processing of searching for the posted project, the applicant device 300 transmits a search request to the project extraction unit 145 of the sharing server 100.

When receiving the search request, the project extraction unit 145 extracts the project allowed to be viewed by the applicant from the posted projects registered in the posted project database 124. To this end, the project extraction unit 145 performs the processing from steps S1451 to S1454.

Step S1451 and step S1452 are processing of extracting the project allowed to be viewed by the applicant, based on the disclosure range set for the posted project. In step S1451, the company to which the applicant belongs and the community of the company to which the applicant belongs are judged. In step S1452, a project that can be disclosed is extracted.

Step S1453 is processing of extracting the project allowed to be viewed by the applicant based on the applicant's spare capacity for a side job. Step S1454 is processing of finally extracting a project that matches the applicant.

### [Processing of Extracting Projects Based on Disclosure Range]

Step S1451 includes step S1451A and step S1451B.

In step S1451A, the company to which the applicant belongs is identified based on the member ID used at the time of sign in, the company database 121, and the member database 122.

In step S1451B, the community of the company to which the applicant belongs is identified based on the ID of the company to which the applicant belongs and the community database 123.

Step S1452 includes step S1452A and step S1452B.

In step S1452A, posted projects that can be disclosed are extracted from the posted project database 124 based on the community to which the applicant's company belongs and the disclosure level.

In step S1452B, among the posted projects extracted in step S1452A, posted projects for which the company to which the applicant belongs is included in the non-disclosure company list are excluded. Here, the project extracted by the processing of step S1452B is referred to as Project X.

### [Processing of Extracting Projects Based on Spare Capacity for Side Job]

Step S1453 includes step S1453A, step S1453B, and step S1453C.

In step S1453A, the applicant's available hours for side job T1 are calculated. The available hours for side job are derived by calculating “the upper limit of side job hours−total side job hours”. The upper limit of side job hours is time defined by the company to which the applicant belongs, and is registered in the company database 121. The calculated available hours for side job are registered in the member database 122. The project extraction unit 145 may calculate the available hours for side job of all the members at regular intervals, and register the calculated available hours for side job in the member database 122.

The total side job hours are calculated by the calculation formula of “total expected side job hours+total actual side job hours” based on the expected side job hours and the actual side job hours registered in the side job database 125. That is, the total side job hours include expected hours that have not yet been spent on the side job, in addition to hours that have already been spent on the side job.

In step S1453B, hours necessary for completing the task T2 are calculated for each of the posted projects. The hours T2 are calculated based on the estimated man-hours (person/month) and the estimated period registered in the posted project database 124. For example, hours of the estimated man-hours (month) may be adopted as the hours T2. For example, as the hours T2, 5 hours may be set as hours for each month for the posted project corresponding to Project ID 001.

In step S1453C, the posted project that falls under “Hours T2≤available hours for side job T1” is extracted from the posted project database 124. Here, the project extracted by the processing of step S1453C is referred to as Project Y.

### [Processing of Extracting Projects Based on Disclosure Range and Spare Capacity for Side Job]

After extracting Project X based on the disclosure range and Project Y based on the spare capacity for side job, the project extraction unit 145 extracts the project that overlaps between Project X and Project Y, as the applicant's matching condition (step S1454).

### [Processing of Providing Extracted Projects]

Next, the project extraction unit 145 transmits information on the matching project to the applicant device 300 (step S1455). The applicant device 300 receives the matching project. The applicant device 300 lists the received matching project as the posted project on the display 305 (step S7).

As a result, the posted project that is appropriate from two perspectives is provided. That is, first, the applicant is provided with the posted project that can be handled without exceeding the applicant's upper limit of side job hours. This can prevent the applicant from becoming overworked. Secondly, the requester's posted project is provided only to the applicants who fall within the disclosure range intended by the requester. This can prevent confidential information of the company to which the requester belongs from being leaked to competitors.

### [Processing of Registering Planned Side Job Hours and Actual Side Job Hours]

FIG. 16 is a diagram for explaining a procedure for registering the side job plan and performance in the database 120. Step S14 of FIG. 12 and the function of the performance receiving unit 149 will be described in more detail with reference to FIG. 16.

The applicant inputs the planned side job hours into the applicant device 300, for example, when accepting an order for a new side job, and inputs the actual side job hours into the applicant device 300 at any timing while being engaged in the side job. The applicant device 300 receives input of the planned side job hours (step S14). The applicant device 300 transmits the received planned side job hours and actual side job hours to the performance receiving unit 149 of the sharing server 100.

The performance receiving unit 149 receives the applicant's planned side job hours and actual side job hours, and registers the received side job hours and actual side job hours of the applicant in the side job database 125 (step S1511). As a result, the applicant's planned side job hours and actual side job hours for each month are registered in the side job database 125 by the project ID.

Usually, after the applicant inputs the planned side job hours, the applicant inputs the actual side job hours at the end of the month. For this reason, the side job database 125 may include projects for which the planned side job hours are registered, but the actual side job hours have not yet been registered. For example, when the applicant who has received an order for a side job inputs the planned side job hours, as data corresponding to the side job, no actual side job hours are registered although the planned side job hours are registered.

Next, the performance receiving unit 149 automatically calculates the expected side job hours of the current month (step S1512). The performance receiving unit 149 calculates the expected side job hours based on the planned side job hours and the actual side job hours. Specifically, as already described, the “expected side job hours” are calculated based on the calculation formula of “(man-hour progress rate/progress rate)×planned side job hours−actual side job hours”. Note that the performance receiving unit 149 may calculate with the calculation formula of the “planned side job hours−actual side job hours”. The performance receiving unit 149 registers the calculated expected side job hours in the side job database 125. As illustrated in the side job database 125 of FIG. 7, the expected side job hours are registered for each project ID.

### [Processing of Registering Evaluation Result (Evaluation for Applicant)]

FIG. 17 is a diagram for explaining a procedure for registering an evaluation for the applicant in the database 120. Step S16A of FIG. 12 and the function of the evaluation receiving unit 151 will be described in more detail with reference to FIG. 17.

When completing the side job, the applicant reports delivery and completion to the requester, and undergoes the requester's inspection. Thereafter, the requester operates the requester device 200 to input an evaluation for the applicant into the requester device 200. The requester device 200 receives the input evaluation (step S16A). The requester device 200 transmits the received evaluation to the evaluation receiving unit 151 of the sharing server 100. Information transmitted from the requester device 200 to the sharing server 100 includes the member ID of the applicant who is an evaluated person and an evaluation value (0 to 10).

When receiving the information on the evaluation for the evaluated person (applicant) from the requester device 200, the evaluation receiving unit 151 reflects the evaluation for the evaluated person in the evaluation input database 126 (step S1513A).

If the evaluation result for the evaluated person (applicant) has already been registered in the evaluation input database 126, the evaluation receiving unit 151 calculates an average value of the evaluation result for the evaluated person, including the evaluation value received this time. The evaluation receiving unit 151 updates the evaluation results registered in the evaluation input database 126 with the calculated average value. As a result, the average values (evaluation results) of the evaluations for the evaluated person (applicant) are registered in the evaluation input database 126 by the evaluator (requester). This updates the information in the applicant evaluation unit 126B in the evaluation input database 126.

Next, the evaluation receiving unit 151 performs evaluation summary processing (step S1514A). In the evaluation summary processing, the evaluation receiving unit 151 calculates the average value of the evaluation results for the evaluated person (applicant) for each company and for each department, and registers the calculation results in the evaluation summary database 127. This updates the information of the applicant evaluation summary unit 127B in the evaluation summary database 127.

For example, the evaluation receiving unit 151 identifies the evaluator (requester), using the member ID used by the requester device 200 for sign in to perform step S16A. The evaluation receiving unit 151 identifies the company ID to which the evaluator belongs, the department to which the evaluator belongs, the member ID of the evaluated person, and the ID of the company to which the evaluated person belongs, based on the evaluation information received in step S1513A, the company database 121, and the member database 122. The “member ID” is an example of “identification information that enables the sharing server 100 including the evaluation receiving unit 151 to identify (the company and the department) to which a person who accessed the sharing server 100 belongs and the viewing privilege”.

The evaluation receiving unit 151 accesses the evaluation summary database 127, and detects a data row in which the identified IDs (the member ID of the evaluated person, the ID of the company to which the evaluated person belongs, and the ID of the company to which the evaluator belongs) are arranged. The evaluation receiving unit 151 updates the value of the applicant evaluation summary corresponding to the detected data row.

### [Processing of Registering Evaluation Result (Evaluation for Requester)]

FIG. 18 is a diagram for explaining a procedure for registering an evaluation for the requester in the database. Step S16B of FIG. 13 and the function of the evaluation receiving unit 151 will be described in more detail with reference to FIG. 18.

As described above, when completing the side job, the applicant reports the delivery and completion to the requester, and undergoes the requester's inspection. Thereafter, the applicant operates the applicant device 300 to input an evaluation for the requester into the applicant device 300. The applicant device 300 receives the input evaluation (step S16B). The applicant device 300 transmits the received evaluation to the evaluation receiving unit 151 of the sharing server 100. Information transmitted from the applicant device 300 to the sharing server 100 includes the member ID of the requester who is an evaluated person and an evaluation value (0 to 10).

When receiving information on the evaluation for the evaluated person (requester) from the applicant device 300, the evaluation receiving unit 151 reflects the evaluation for the evaluated person (requester) in the evaluation input database 126 (step S1513B).

If the evaluation result for the evaluated person (requester) has already been registered in the evaluation input database 126, the evaluation receiving unit 151 calculates an average value of the evaluation result for the evaluated person, including the evaluation value received this time. The evaluation receiving unit 151 updates the evaluation results registered in the evaluation input database 126 with the calculated average value. As a result, the average values (evaluation results) of the evaluations for the evaluated person (requester) are registered in the evaluation input database 126 by the evaluator (applicant). This updates the information in the requester evaluation unit 126A in the evaluation input database 126.

Next, the evaluation receiving unit 151 performs the evaluation summary processing (step S1514B). In the evaluation summary processing, the evaluation receiving unit 151 calculates the average value of the evaluation results for the evaluated person (requester) for each company and for each department, and registers the calculation result in the evaluation summary database 127. This updates the information of the requester evaluation summary unit 127A in the evaluation summary database 127.

For example, the evaluation receiving unit 151 identifies the evaluator (applicant), using the member ID used by the applicant device 300 for sign in to perform step S16B. The evaluation receiving unit 151 identifies the ID of the company to which the evaluator belongs, the department to which the evaluator belongs, the member ID of the evaluated person, and the ID of the company to which the evaluated person belongs, based on the evaluation information received in step S1513B, the company database 121, and the member database 122. The “member ID” is an example of “identification information that enables the sharing server 100 including the evaluation receiving unit 151 to identify (the company and the department) to which a person who accessed the sharing server 100 belongs and the viewing privilege”.

The evaluation receiving unit 151 accesses the evaluation summary database 127, and detects a data row in which the identified IDs (the member ID of the evaluated person, the ID of the company to which the evaluated person belongs, and the ID of the company to which the evaluator belongs) are arranged. The evaluation receiving unit 151 updates the value of the requester evaluation summary corresponding to the detected data row.

For example, in the data group 1271 of FIG. 9, the member ID of the evaluated person=P1, the ID of the company to which the evaluated person belongs=00A, and the ID of the company to which the evaluator belongs=00B are arranged. When the member belonging to System Department of Company B evaluates Member P1, the evaluation is received in step S1513B.

In this case, in step S1514B, the evaluations received in step S1513B are reflected in the requester evaluation summary corresponding to “All” of the data group 1271 and in the requester evaluation summary corresponding to “System Department”.

More specifically, the evaluation receiving unit 151 sets the average value of the evaluations for Company B as a whole including the evaluation received in step S1513B, as the requester evaluation summary corresponding to “Whole” of the data group 1271. Similarly, the evaluation receiving unit 151 sets the average value of the evaluations of System Department including the evaluation received in step S1513B, as the requester evaluation summary corresponding to “System Department” of the data group 1271.

FIG. 19 is a diagram for explaining a procedure for displaying the evaluation for the applicant and member search results on the display 205. Step S4A (processing of the requester device 200) of FIG. 10 and the function of the member search unit 143, as well as step S17A and step S18A of FIG. 12 and the function of the evaluation output unit 152 will be described in more detail, with reference to FIG. 19.

### [Processing of Outputting Evaluation Summary for Applicant]

First, each processing of step S17A, step S18A, step S1521A, and step S1522A illustrated in FIG. 19 will be described.

When receiving an operation for the requester to view the evaluation for the applicant, the requester device 200 performs the viewing request processing (step S17A). In the viewing request processing, the requester device 200 transmits a viewing request to the evaluation output unit 152 of the sharing server 100. In response to the viewing request, the evaluation output unit 152 selects, from the evaluation summary database 127, the applicant evaluation summary that the requester (person who requests viewing) is privileged to view (step S1521A).

The requester who made the viewing request is privileged to view the applicant evaluation summary for the requester's company as a whole and the applicant evaluation summaries for the department to which the requester belongs. The requester who made the viewing request is not privileged to view any evaluation summaries other than these. The evaluation output unit 152 judges the viewing privilege based on the member ID of the requester who transmits the viewing request, the company database 121, and the member database 122. The “member ID” is an example of “identification information that enables the sharing server 100 including the evaluation receiving unit 151 to identify (the company and the department) to which a person who accessed the sharing server 100 belongs and the viewing privilege”.

The evaluation output unit 152 selects the applicant evaluation summary corresponding to the viewing privilege from the evaluation summary database 127. The evaluation output unit 152 transmits data including the selected applicant evaluation summary to the requester device 200 (step S1522A). The data to be transmitted includes the member ID of the applicant (evaluated person), information on the company to which the applicant belongs, information on the department to which the applicant belongs, or the like, in addition to the applicant evaluation summary. The data to be transmitted may include the applicant evaluation summary corresponding to each of a plurality of the applicants (evaluated person), in response to the viewing request.

The requester device 200 that has received the applicant evaluation summary displays the applicant evaluation summary on the display 205, together with the information on the company to which the applicant belongs and the information on the department to which the applicant belongs (step S18A). When receiving the applicant evaluation summary corresponding to each of the plurality of applicants (evaluated persons), the requester device 200 displays the applicant evaluation summary listing the plurality of applicants (evaluated persons).

In this manner, when receiving the viewing request in communication established by the member ID capable of identifying the company and the department to which the requester belongs, the sharing server 100 transmits the applicant evaluation summaries, which are examples of the evaluation information, to the requester device 200 of the requester who is a transmission source that transmitted that viewing request.

### [Processing of Searching for Member (Applicant)]

Processing of each of step S4A, step S19A, and step S1431A to step S1433A will be described continuously referring to FIG. 19.

When receiving a search operation from the requester, the requester device 200 performs the member search processing for searching for information regarding the applicant (step S4A). In the member search processing, the requester device 200 transmits a search request to the member search unit 143 of the sharing server 100. The search request includes a reference value for searching, by excluding members with poor evaluations as an applicant. This reference value is defined, for example, based on the values of the applicant evaluation summaries.

The member search unit 143 that has received the search request identifies the company to which the requester who transmitted the search request belongs (step S1431A). Here, the company identified by step S1431A is referred to as “Company Xa”.

The member search unit 143 identifies the requester that operates the requester device 200, using the member ID used by the requester device 200 to sign in to the sharing server 100. The member search unit 143 uses the company database 121 and the member database 122 to identify the company Xa to which the requester belongs.

Next, the member search unit 143 extracts, from the evaluation summary database 127, members for whom the values of the applicant evaluation summaries covering the identified Company Xa as a whole exceed a reference value (step S1432A). That is, the member search unit 143 extracts search results by excluding members having poor evaluations of Company Xa as a whole.

Here, it is to be noted that the member search unit 143 judges whether or not the evaluation is poor, based on the applicant evaluation summaries. That is, Member α, who has both requester and applicant privileges, may behave as a requester and behave as an applicant. Thus, as the evaluation summary for such Member α, the requester evaluation summary and the applicant evaluation summary are registered in the evaluation summary database 127. Member α may be highly evaluated as the requester, while Member α may be poorly evaluated as the applicant. In this case, Member a may be excluded from extraction targets in step S1432A.

The sharing server 100 may be provided with a function to receive reference value setting information from the requester device 200 of each company. This enables each company to exclude the poorly evaluated members from search results based on its unique reference value.

Next, the member search unit 143 outputs information of the extracted members as search results to the requester device 200 that made the search request (step S1433A). The requester device 200 lists the received search results on the display 205 (step S19A).

As a result, the requester can view, on the display 205, the search results from which the members for whom the overall evaluation of the requester's company is poor are excluded. Therefore, when selecting a contractor from among applicants, the requester can save the effort of visually excluding the members for whom the company's overall evaluation is poor.

Note that in the present embodiment, even when members are poorly evaluated by a certain department of the company to which the requester belongs, the members are not excluded from search results if the members are not poorly evaluated by the company as a whole. However, the member search unit 143 may further exclude such members from the search results.

FIG. 20 is a diagram for explaining a procedure for displaying the evaluation for the requester and the member search results on the display 305. Step S4B (processing of the applicant device 300) of FIG. 10 and the function of the member search unit 143, as well as step S17B and step S18B of FIG. 13 and the function of the evaluation output unit 152 will be described in more detail with reference to FIG. 20.

### [Processing of Outputting Evaluation Summary for Requester]

First, processing of each of step S17B, step S18B, step S1521b, and step S1522B illustrated in FIG. 20 will be described.

When receiving an operation for the applicant to view an evaluation for the requester, the applicant device 300 performs the viewing request processing (step S17B). In the viewing request processing, the applicant device 300 transmits a viewing request to the evaluation output unit 152 of the sharing server 100. In response to the viewing request, the evaluation output unit 152 selects, from the evaluation summary database 127, requester evaluation summaries that the applicant (person who requests viewing) is privileged to view (step S1521B).

The applicant who made the viewing request is privileged to view the requester evaluation summary for the applicant's company as a whole and the requester evaluation summaries for the department to which the applicant belongs. The applicant who made the viewing request is not privileged to view any evaluation summaries other than these. The evaluation output unit 152 judges on the viewing privilege, based on the member ID of the applicant who transmits the viewing request, the company database 121, and the member database 122. The “member ID” is an example of “identification information that allows the sharing server 100 including the evaluation receiving unit 151 to identify affiliation (company and department) of a person who accessed the sharing server 100”.

The evaluation output unit 152 selects the requester evaluation summary corresponding to the viewing privilege from the evaluation summary database 127. The evaluation output unit 152 transmits data including the selected requester evaluation summary to the applicant device 300 (step S1522B). The data to be transmitted includes the member ID of the requester (evaluated person), information on the company to which the requester belongs, information on the department to which the requester belongs, or the like, in addition to the requester evaluation summary. The data to be transmitted may include the requester evaluation summary corresponding to each of the plurality of requesters (evaluated persons), in response to the viewing request.

The applicant device 300 that has received the requester evaluation summaries displays the requester evaluation summaries together with the information on the company to which the requester belong and the information on the department to which the requester belongs on the display 305 (step S18B). When receiving the requester evaluation summaries corresponding to each of a plurality of the requesters (evaluated persons), the applicant device 300 displays the requester evaluation summary listing the plurality of requesters (evaluated persons).

In this manner, when receiving the viewing request in communication established by the member ID capable of identifying the company and department to which the applicant belongs, the sharing server 100 transmits the requester evaluation summaries, which are examples of the evaluation information, to the applicant device 300 of the applicant who is the transmission source that transmitted that viewing request.

### [Processing of Searching for Member (Requester)]

Processing of each of step S4B, step S19B, and step S1431B to step S1433B will be described continuously referring to FIG. 20.

When receiving a search operation from the applicant, the applicant device 300 performs the member search processing for searching for information regarding the requester (step S4B). In the member search processing, the applicant device 300 transmits a search request to the member search unit 143 of the sharing server 100. The search request includes a reference value for searching, by excluding members with poor evaluations as the requester. This reference value is defined, for example, based on the values of the requester evaluation summaries.

The member search unit 143 that has received the search request identifies the company to which the applicant who transmitted the search request belongs (step S1431B). Here, the company identified by step S1431B is referred to as “Company Xb”.

The member search unit 143 identifies the applicant that operates the applicant device 300, using the member ID used by the applicant device 300 to sign in to the sharing server 100. The member search unit 143 uses the company database 121 and the member database 122 to identify the company Xb to which the applicant belongs.

Next, the member search unit 143 extracts, from the evaluation summary database 127, members for whom the values of the requester evaluation summaries covering the identified Company Xb as a whole exceed a reference value (step S1432B). That is, the member search unit 143 extracts search results by excluding members having poor evaluations of Company Xb as a whole.

The sharing server 100 may be provided with a function to receive the reference value setting information from the requester device 200 of each company. This enables each company to exclude the poorly evaluated members from search results based on its unique reference value.

Next, the member search unit 143 outputs information of the extracted members as search results to the applicant device 300 who made the search request (step S1433B). The applicant device 300 lists the received search results on the display 305 (step S19B).

As a result, the applicant can view, on the display 305, the search results from which the members for whom the overall evaluation of the applicant's company is poor are excluded. Therefore, when selecting a contractor from among requesters, the applicant can save the effort of visually excluding the members for whom the company's overall evaluation is poor.

Note that in the present embodiment, even when members are poorly evaluated by a certain department of the company to which the applicant belongs, the members are not excluded from search results if the members are not poorly evaluated by the company as a whole. However, the member search unit 143 may further exclude such members from the search results.

### [Viewable Range of Evaluation Summary Database 127]

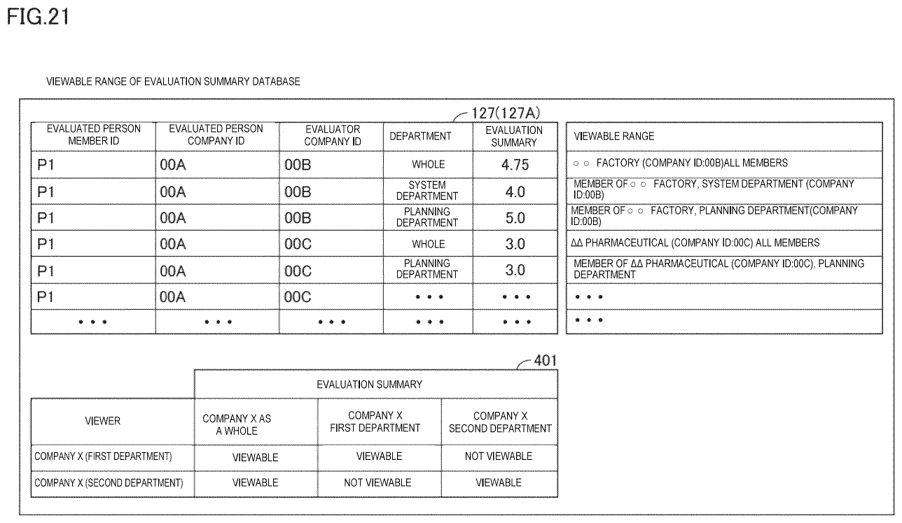

FIG. 21 is a diagram for explaining a viewable range of the evaluation summary database 127. Here, the viewable range will be described by taking, as an example, the requester evaluation summary unit 127A, which is also illustrated in FIG. 9, of the evaluation summary database 127.

The requester evaluation summary unit 127A illustrated in FIG. 21 includes evaluation summaries from each of Company B and Company C for Member P1 who behaves as the “requester”. Member P1 belongs to Company A. The evaluation summary of Company B is classified into “Whole”, “System Department”, and “Planning Department”. The evaluation summary of Company C is classified into “Whole”, “Planning Department”, and the like. Members belonging to Companies B and C view the evaluation summaries for Member P1 as the “applicant”.

The viewing privilege for the evaluation summaries that are calculated from the evaluation of Company B as a whole is granted to all members belonging to Company B, as illustrated in the “Viewable Range” column in FIG. 21.

The viewing privilege for the evaluation summaries that are calculated from the evaluation of System Department of Company B is granted to members of System Department of Company B, but is not granted to members other than those of System Department of Company B. The viewing privilege for the evaluation summaries that are calculated from the evaluation of Planning Department of Company B is granted to members of Planning Department of Company B, but is not granted to members other than those of Planning Department of Company B.

The viewing privilege for the evaluation summaries that are calculated from the evaluation of Company C as a whole is granted to all members belonging to Company C. The viewing privilege for the evaluation summaries that are calculated from the evaluation of Planning Department of Company C is granted to members of Planning Department of Company C, but is not granted to members other than those of Planning Department of Company C.

As above, the viewable range is described taking the requester evaluation summary unit 127A as an example. In the matching system 1, the viewable range for the applicant evaluation summary unit 127B (See FIG. 9) is also defined based on the design concept similar to that of the requester evaluation summary unit 127A.

If viewers are members from First Department of Company X and members from Second Department of Company X, viewers' privileges for the evaluation summary of Company X as a whole, the evaluation summary of First Department of Company X, and the evaluation summary of Second Department of Company X are as illustrated in Table 401 in FIG. 21. Here, when the applicant falls under the “viewers”, a viewing target is the evaluation summaries of the “requesters”. Conversely, when the requester falls under the “viewers”, the viewing target is the evaluation summaries of the “applicant”.

Members who belong to First Department of Company X can view the evaluation summaries of Company X as a whole and the evaluation summaries of First Department of Company X, but cannot view the evaluation summaries of Second Department of Company X. Members who belong to Second Department of Company X can view the evaluation summaries of Company X as a whole and the evaluation summaries of Second Department of Company X, but cannot view the evaluation summaries of First Department of Company X. Members belonging to Company Y other than Company X cannot view the evaluation summaries of Company X as a whole, the evaluation summaries of First Department of Company X, and the evaluation summaries of Second Department of Company X.

The evaluation summaries of Company X as a whole, the evaluation summaries of First Department of Company X, and the evaluation summaries of Second Department of Company X will not be disclosed to members of companies other than Company X. Therefore, in a scene where a member, who belongs to Company Y and behaves as an applicant, evaluates a requester who belongs to Company X, the member can objectively evaluate the requester belonging to Company X without considering a relationship between the companies, or the like. Similarly, in a scene where a member, who belongs to Company Y and behaves as a requester, evaluates an applicant who belongs to Company X, the member can objectively evaluate the applicant belonging to Company X without considering a relationship between the companies, or the like.

In addition, evaluations made by the members belonging to Company X (evaluations for the requester, and evaluations for the applicant) are shared within Company X as the requester evaluation summary and the applicant evaluation summary. This enables evaluators to be aware that accumulation of each evaluation produces useful information. This motivates the evaluators to make accurate evaluations.

As a result, the accuracy of the requester evaluation summary and the applicant evaluation summary is improved. This makes it possible to usefully utilize the requester evaluation summary as reference data when selecting posted tasks. Similarly, the applicant evaluation summary can be usefully utilized as reference data when selecting a contractor.

Furthermore, according to the present embodiment, when the member search processing (step S4A) is performed in the requester device 200, the requester is provided with search results from which the poorly evaluated members are excluded (step S1432A). Similarly, when the member search processing (step S4B) is performed in the applicant device 300, the requester is provided with search results from which the poorly evaluated members are excluded (step S1432B). That is, the matching system 1 includes a filtering function that provides search results from which the poorly evaluated members are excluded.

Therefore, the requester can prevent, on a company-by-company basis, a mistake of hiring a poorly evaluated member when determining a contractor for a posted task. Similarly, the applicant can prevent, on a company-by-company basis, a mistake of selecting a posted task solicited by a poorly evaluated member when determining the application target from a large number of posted tasks. Note that the sharing server 100 may perform filtering using department-by-department based evaluation summaries.

The requester device 200 may transmit, to the sharing server 100, a command signal instructing which of filtering using evaluation summaries of a company as a whole or filtering using the department-by-department based evaluation summaries is to be used. In this case, the sharing server 100 is provided with a function to change the evaluation summary to be used for filtering, in response to the command signal.

[Example in which Disclosure Range is Set According to Disclosure Level]

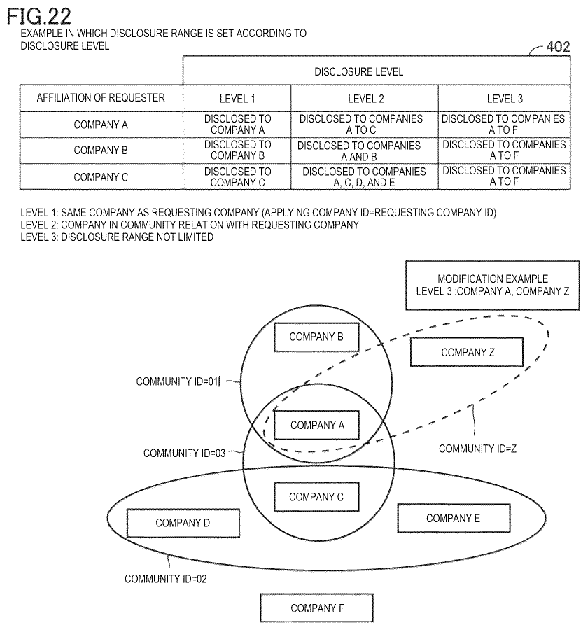

FIG. 22 is a diagram illustrating an example in which the disclosure range is set according to the disclosure level. Here, as illustrated in FIG. 22, a case is considered in which Company A to Company E form a community relationship, and Company F has no community relationship with any company. In this case, the disclosure range of posted projects is as illustrated in Table 402, according to the company to which the requester belongs and the disclosure level set by the requester.

The disclosure levels of “Level 1” to “Level 3” illustrated in FIG. 22 correspond to the three levels of “Own Company”, “Within Community”, and “All” which have already been described. Therefore, at Level 1, the requester's posted project is disclosed to only applicants of the same company as the company to which the requester belongs. At Level 2, the requester's posted project is disclosed to applicants belonging to companies that have a community relationship with the company to which the requester belongs, in addition to the range of Level 1. At Level 3, the requester's posted project is disclosed to all companies including the company to which the requester belongs. However, if the requester specifies IDs of non-disclosure companies, the companies corresponding to those IDs are excluded from the companies to be disclosed, irrespective of the set disclosure level. Among the disclosure levels of the present embodiment, “Level 1” is a level corresponding to “allowing disclosure of task information to a first applicant, and prohibiting disclosure of the task information to applicants who do not belong to the first group”. “Level 2” is a level corresponding to “allowing disclosure of task information to an applicant who belongs to the first group or a community group that has formed a community relationship with the first group, and prohibiting the disclosure of the task information to applicants who do not belong to any of the first group or a community group”. “Level 3” is a level corresponding to “allowing disclosure of task information to applicants irrespective of a group to which the applicant belongs”.

Here, the Level 1 to Level 3 are described above as an example of a plurality of types of disclosure levels. However, the plurality of types of disclosure levels is not limited thereto. For example, a community may be divided to a plurality of small communities, and whether or not to disclose posted tasks may be set for each small community. More specifically, Community 02 illustrated in FIG. 5 is divided into a first small community and a second small community. Company C belongs to the first small community, and Company D and Company E belong to the second small community. In this case, the requester from Company D may be able to select whether to set the disclosure range of his/her own posted task to the first small community or to the second small community.

The sharing server 100 may receive an operation to set a different disclosure range for each posted project. For example, among a large number of posted projects, a specific example of setting a different disclosure range for each posted project will be described by taking Project 001 to Project 003 as examples.

For example, the disclosure range of the posted project 001 may be limited only to Companies A and C that belong to the community identified with the community ID=03. Alternatively, the disclosure range of the posted project 002 may be limited to only Companies C, D, and E, which belong to the community identified with the community ID=02. Alternatively, the disclosure range of Project 003 may be limited to Companies C, D, and E that belong to the community identified with the community ID=02, and Companies A and C that belong to the community identified with the community ID=03.

Company A may form another community that is separate from the communities identified by the community IDs=01 or 02. For example, as illustrated by the dashed line in FIG. 22, Company A may form a community identified by community ID=Z, with Company Z. For example, if the requester belongs to Company A, the requester's posted project may be disclosed to applicants belonging to Company A and applicants belonging to Company Z. Such a disclosure level may be adopted as a modification example of “Level 3”, as illustrated in FIG. 22.

In this case, “Level 3” corresponds to “allowing task information to applicants who belong to a first group (Company A), and a specific community group (community identified with community ID=Z) that is different from the second level community groups (Company A to Company C) that have formed a community relationship with the first group, and prohibiting the disclosure of the task information to applicants who do not belong to any of the first group or the specific community group”.

[Example of Screen Displayed when Checking Side Job Status]

FIG. 23 is a diagram illustrating a screen to be displayed on the supervisor's applicant device 300 when the supervisor (the applicant's superior) checks the side job statuses of his/her subordinates. FIG. 23 illustrates an example in which the side job statuses of the supervisor's subordinates are displayed to the applicant device 300. The applicant device 300 is provided with a keyboard 306A and a mouse 306B as operating units.

Here, the supervisor is, for example, a department head of Sales Department of Company C. The side job statuses of employees who belong to Sales Department are displayed on the display 305. The supervisor can check the side job statuses of the employees belonging to Sales Department, by specifying any of tab 307A, tab 307B, tab 307C . . . using the keyboard 306A or the mouse 306B. Therefore, the supervisor can manage the working hours of his/her subordinates so that the subordinates do not fall into an overwork status. Note that the progress rate may also be displayed on the screen.

### [Details of Project Contents]

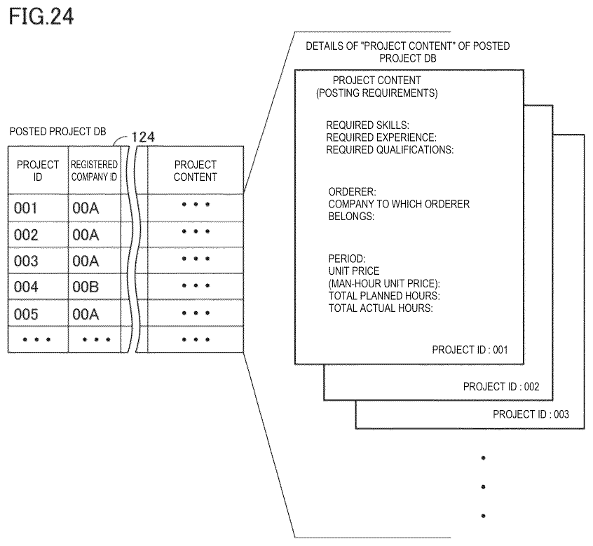

FIG. 24 is a diagram illustrating details of the project contents included in the posted project database 124. The project contents include posting requirements. As illustrated in FIG. 24, the project contents are registered in the posted project database 124 by the project ID.

The project contents include items of required skills, required experience, and required qualifications. These requirements describe conditions required of applicants. The required skills refer to skills necessary for the project. The required experience refers to a number of years during which applicants are engaged in a task using the required skill. The required qualification means national qualifications, private qualifications, and the like.

The project contents further include items of the orderer and the company to which the orderer belongs. The orderer refers to a party who drew up a plan for the project, that is, the requester. The company to which the orderer belongs refers to the name of the company to which the requester belongs.

The project contents further include items of a period, a unit price (man-hour unit price), total planned hours, and total actual hours. The period refers to a period in which the task is started. The unit price (man-hour unit price) refers to wage per unit time. The total planned hours refer to planned hours from the start to the end of the task. The total planned hours vary depending on a progress status of a project involved in the task. The total actual hours refer to hours to be calculated by reviewing hours till the project is completed, depending on the progress status of the project involved in the task.

The applicant reviews the project contents and determines a project he/she wishes to apply for from among a large number of projects. Before finally applying for the project, the applicant may interview the requester of the project, as necessary. In addition, after selecting a specific person as a provisional contractor from applicants and before entering into a task contract, the requester may interview the provisional contractor. After entering into the task contract with the applicant, the requester may interview the applicant (contractor) regarding the project contents, depending on the progress of the task.

### [Overview of Advertisement Delivery Function]

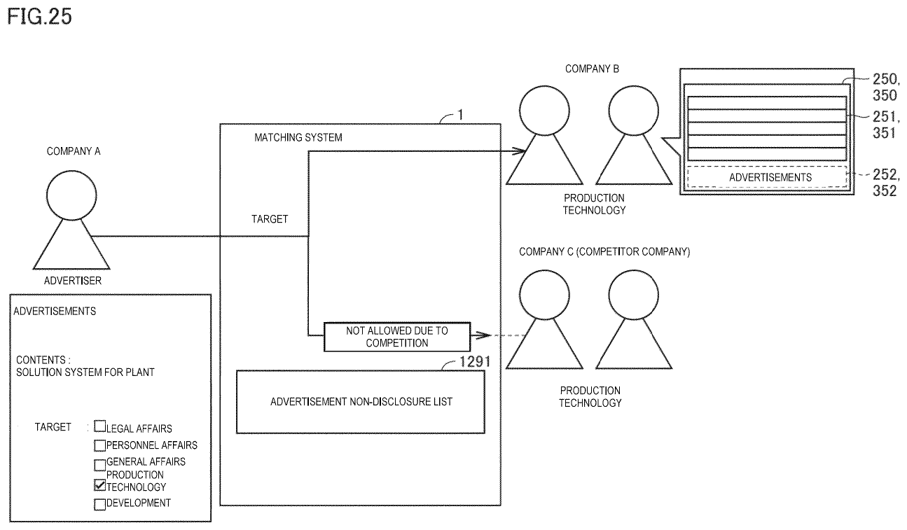

FIG. 25 is a diagram illustrating an overview of an advertisement delivery function included in the matching system 1. Among users (members) of the matching system 1, here, users who belong to Company A are advertisers. Users who belong to Company B and Company C each work in Production Technology Department. Company A and Company C are in a competitive relationship. Company A and Company B are not in a competitive relationship.

An advertiser uploads an advertisement for a solution system for factories to the matching system 1. For example, the advertisement is an advertisement for an exhibition, a sales promotion event, or the like. The advertiser wishes to deliver the advertisement to users interested in the solution system for factories. The advertiser believes that users related to production technologies are targets of the advertisement. However, the advertiser does not wish the advertisement to be delivered to users of companies in a competitive relationship.

The matching system 1 includes a function to analyze attributes and action histories of all users and select users estimated to have high interest in the content of the advertisement. Therefore, the matching system 1 can deliver the advertisement to appropriate users without obtaining, from the advertiser, information regarding characteristics of users to whom the advertiser wishes to deliver the advertisement. In this example, the information regarding the characteristics of the users is information regarding a department (production technology) to which the targeted user belongs. Therefore, in the example illustrated in FIG. 25, except for the problem of a competitive relationship, the matching system 1 may select the users belonging to Production Technology Department of each of Company B and Company C as the target of the advertisement.

An advertisement non-disclosure list 1291 is registered in the matching system 1. The advertisement non-disclosure list 1291 is an example of data capable of identifying a competitive relationship between companies. The advertisement non-disclosure list 1291 indicates a relationship between the advertiser's company ID and the company ID (non-disclosure company ID) of the company to which the advertiser does not wish to disclose the advertisement of his/her company. Using the advertisement non-disclosure list 1291, the matching system 1 determines that Company A and Company C are in a competitive relationship. The matching system 1 excludes users belonging to Company C from the target of the advertisement. The matching system 1 does not deliver the advertisement to users of Company C that is in a competitive relationship with Company A, while delivering the advertisement to users of Company B that is not in a competitive relationship with Company A.

Companies participating in the matching system 1 can effectively deliver advertisements of their own companies to companies considered to be interested in their products or services. The matching system 1 prevents delivery of the advertisement of the advertiser to the companies that are in a competitive relationship with the advertiser. Therefore, the advertiser does not have to worry about a possibility that their advertisement will be delivered to competitor companies.

In particular, the matching system 1 realizes such advertisement delivery by utilizing a platform for providing crowdsourcing among companies. This has the following advantages relative to commonly available target advertising systems.

In general target advertising systems, similarly to the matching system 1, users' attributes and action histories are also analyzed to determine targets to which advertisements are delivered. However, there is a significant difference in the reliability of data to be analyzed between the general target advertising system and the matching system 1. As described later, in the matching system 1, users' attributes are extracted based on the highly reliable member data registered in the database 21. Therefore, the accuracy of attribute information extracted for targeting advertisement is extremely high.

Furthermore, the matching system 1 analyzes users' action histories by utilizing the user device 500 utilized by users as a requester or an applicant. Users operating the user device 500 will input information regarding tasks in which they have high interest into the user device 500. The users operating the user device 500 will search for the information regarding the tasks in which they have high interest, using the user device 500. It is considered that the users operating the user device 500 have many opportunities to use the user device 500 for business purposes, and have fewer opportunities to use the user device 500 for personal purposes such as hobbies, or the like. Therefore, the action history information obtained from the user device 500 has less noise and contains a large number of pieces of information that are useful for analyzing targets of the advertisement.

The matching system 1 has the advantages as described above, relative to the commonly available target advertising system. Therefore, according to the matching system 1, it is possible to effectively provide advertisements from a group such as companies to another group, and to restrict provision of the advertisements to competing groups. As a result, companies that are advertisers can refrain from unnecessary exposure of advertisements. Consequently, the companies that are the advertisers can expect a sufficient return on the advertisement expenses.

Note that the matching system 1 may obtain, from the advertiser, information regarding the characteristics of users whom the advertiser wishes to target, as part of the advertisement information. For example, in the example illustrated in FIG. 25, the matching system 1 may acquire affiliation information (production technology) of the target users from the advertiser. The matching system 1 may check the acquired affiliation information against the affiliation information of the members registered in the database 21 and set a targeting range.

As described below, in order to realize advertisement delivery, the matching system 1 utilizes a prediction model that determines an advertisement target using a predetermined algorithm. The matching system 1 inputs attribute information and action history information of each user into the prediction model and determines the target. The matching system 1 may further input the affiliation information received from the advertiser into the prediction model and determine the target.

Alternatively, the matching system 1 may select, from the database 21, users corresponding to the affiliation information received from the advertiser without using the prediction model, and deliver the advertisement to the selected users. For example, when the affiliation information is “Production Technology”, the matching system 1 refers to “Department” column in the member database 122 and identifies users belonging to “Production Technology”. The matching system 1 refers to the advertisement non-disclosure list 1291 and excludes users of companies that are in a competitive relationship with the advertiser, from the identified users. The matching system 1 delivers the advertisement to the selected users in this manner. The integration of the profile database 129, action history database 131, and advertisement database 132 within the specific context of the crowdsourcing platform represents a significant technical departure from conventional advertising systems. The group information, such as the company and department a user belongs to, is not self-reported for advertising purposes but is verified information essential to the platform's primary crowdsourcing function. This creates a trusted and structured data source that is not available in generic systems. The present disclosure leverages this unique data architecture to enable a new level of precision and control in advertisement targeting, solving the technical problem of unreliable recipient verification that plagues conventional systems.

The sharing server 100 may set “advertiser members” that are not granted privilege as a requester or an applicant, and granted privilege as an advertiser. In this case, “Advertiser” is set as the privilege type in the member database 122. Alternatively, the sharing server 100 may solicit advertisers without limiting the privilege to become an advertiser to members.

### [Other Databases]

In the following, a description will be given of other databases adopted in the present embodiment, in addition to various types of databases 121 to 127 illustrated in FIG. 2.

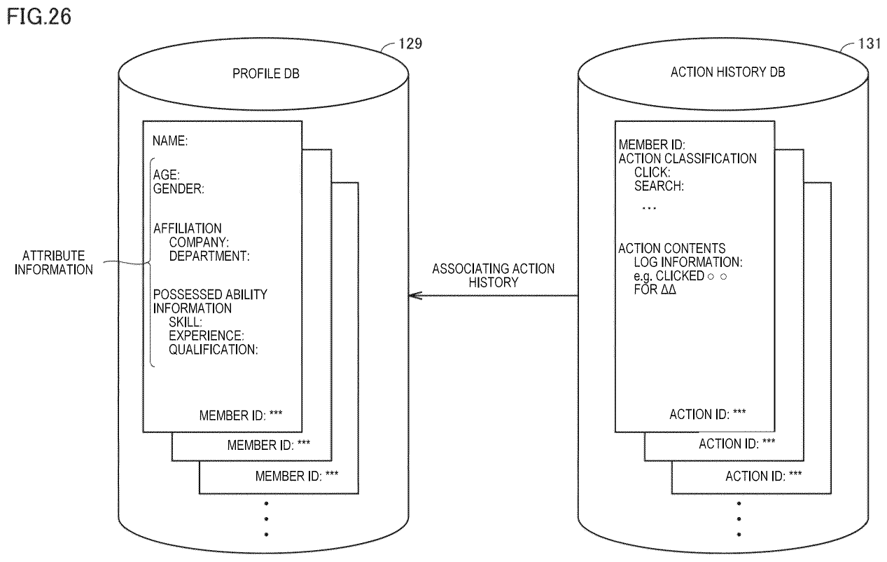

FIG. 26 is a diagram illustrating an example of a profile database 129 and an action history database 131. As illustrated in FIG. 26, profile information of members (users) is registered in the profile database 129 by the member ID. A part of the profile information may overlap with the information registered in the member database 122. The profile information includes a member name, age, and gender. Furthermore, the profile information includes affiliation information capable of identifying members' affiliations (company and department). The affiliation information is an example of group information for identifying any one of a company and a department within a company.

Furthermore, the profile information includes members' possessed ability information. The possessed ability information is categorized by skill, experience, and qualification. These categories correspond to project posting requirements (See FIG. 24). For example, the attribute information for each member includes age, gender, affiliation, and possessed ability information. Integration of such attribute information of members generates attribute information of each company.

As illustrated in FIG. 26, members' action history information is registered in the action history database 131 by the action ID. The action history information includes information indicating members' actions on information displayed on a screen of the user device 500. The action ID is information for identifying each of such actions of members.

Specifically, the action history information includes member IDs, action categories, and action contents. The action categories include, for example, an operation of clicking an information area presented on the screen, searching for information presented on the screen, or the like. The action contents include log information consisting of information areas to be clicked, click operation time, and the like. Each time the sharing server 100 detects a member's action, new action history information is accumulated in the action history database 131.

The sharing server 100 associates the member's profile information in the profile database 129 with the member's action history information in the action history database 131.

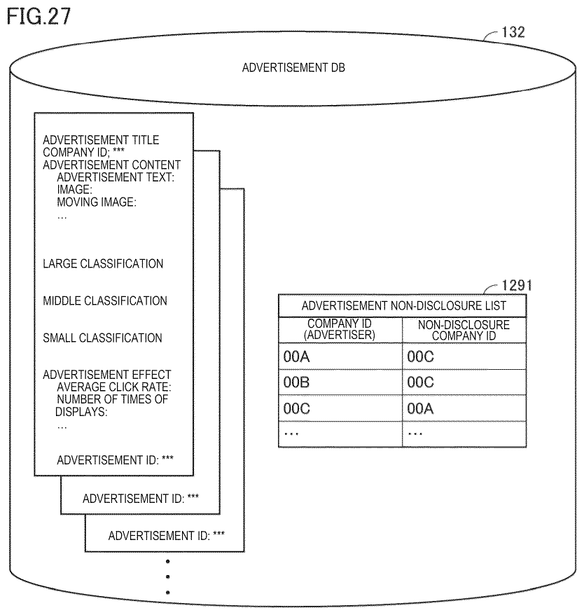

FIG. 27 is a diagram illustrating an example of an advertisement database 132. As illustrated in FIG. 27, advertisement information classified by the advertisement ID and the advertisement non-disclosure list 1291 are registered in the advertisement database 132.

The advertisement information includes an advertisement title, a company ID, advertisement contents, a large classification, a middle classification, a small classification, and an advertisement effect. The originating company of an advertisement is identified by a company ID included in the advertisement information, thereby linking the advertisement to a specific advertiser entity on the platform. The advertisement contents include detailed information such as advertisement wording, advertisement images, advertisement videos, or the like. Advertisements are classified according to the advertisement contents. The large classification, the middle classification, and the small classification include names according to the classification. The advertisement effect includes a numerical value according to movement of the user who viewed the advertisement. For example, the advertisement effect includes an average number of clicks on an advertisement, a number of times of advertisement displays, or the like.

The advertisement non-disclosure list 1291 indicates a relationship between an advertiser's company ID and a company ID of a company to which the advertiser does not wish to disclose an advertisement of his/her company (non-disclosure company ID). According to the advertisement non-disclosure list 1291, disclosure of the advertisement of Company A to Company C is prohibited, disclosure of the advertisement of Company B to Company C is prohibited, and the advertisement of Company C to Company A is prohibited. Note that when Company A wishes to avoid disclosure of the advertisement to Company C and Company D, 00C and 00D are registered in the non-disclosure company ID columns corresponding to the company ID=00A. The sharing server 100 may adopt a function that enables a user to set companies to which disclosure of an advertisement is prohibited, by the advertisement information (by the advertisement ID). The advertisement non-disclosure list 1291 is an example of information indicating respective competitive relationships among a plurality of groups.

The matching system identifies an advertiser of an advertisement based on the company ID included in the advertisement information. The matching system 1 uses the advertisement non-disclosure list 1291 to identify a company that is in a competitive relationship with the advertiser. The matching system 1 excludes users belonging to the identified competitor company from the advertisement target. Note that the matching system 1 uses the member database 122 to identify users belonging to the competitor company.

The non-disclosure list 1291 is an example of prohibition information capable of identifying advertisement information prohibited from being associated with the users belonging to the first group, among a plurality of pieces of advertisement information. The company IDs included in the advertisement information are examples of information for identifying advertisers. Note that the member IDs may be used as the information for identifying advertisers, instead of the company IDs. The matching system 1 can identify a relationship between the member ID and the company ID by utilizing the member database 122.

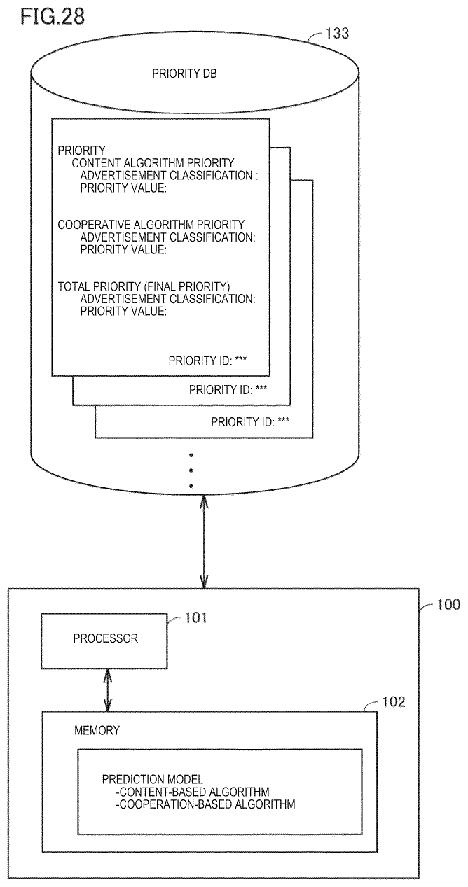

FIG. 28 is a diagram illustrating an example of a priority database 133. As illustrated in FIG. 28, priority information is registered in the priority database 133 for each priority ID. The priority information includes information regarding priority of advertisements to be delivered to users. The priority information includes a content algorithm priority, a cooperative algorithm priority, and an integrated priority (final priority). The content algorithm priority, the cooperative algorithm priority, and the integrated priority (final priority) each include an advertisement classification and a priority value.

The sharing server 100 integrates the advertisement classification and the priority value based on the content algorithm priority with the advertisement classification and the priority value based on the cooperative algorithm priority to determine the advertisement classification and the priority value based on the integrated priority (final priority). The sharing server 100 uses the priority value based on the integrated priority (final priority) to determine an advertisement (target advertisement) to be delivered to users.

The sharing server 100 uses the trained prediction model to calculate the content algorithm priority and the cooperative algorithm priority. As illustrated in FIG. 28, the prediction model is stored in the memory 102 of the sharing server 100. The prediction model is generated by machine learning and updated by re-learning using an output of the prediction model.

Methods termed content-based filtering and cooperative filtering are known as a method for extracting information having high user preferences from a plurality of pieces of information. In general, the content-based filtering is a method of recommending, to a user, a product having a tag of a product that is highly relevant to tag information of a product the user is viewing. The cooperative filtering is a method of determining information to be recommended to a user, based on viewing histories, or the like, of those who have similar preferences to the user. These content-based filtering and cooperative filtering methods are adopted in generation of the prediction model according to the present embodiment. User attribute information is used as the tag information of the content-based filtering. This is to assume that a recommendation is made based on the closeness of the user attribute information (considering that the “user” in the previous example is a “product”). On the other hand, the cooperative filtering uses the action history information of the user. This is to make a recommendation based on interests of the user, similarly to a typical cooperative filtering, irrespective of the user attribute information.

The prediction model includes the content-based algorithm generated based on the content-based filtering and the cooperation-based algorithm generated based on the cooperative filtering. Note that any learning method such as supervised learning and reinforcement learning may be adopted for the generation of the prediction model.

The sharing server 100 calculates the content algorithm priority by inputting user-specific characteristics (affiliation, skill, age, and the like) into the content-based algorithm. The sharing server 100 calculates the cooperative algorithm priority by inputting user-specific action histories (project viewing history, the search history, and the like) into the cooperation-based algorithm.

### [Description of Processing Procedure Related to Advertisement Delivery Function]

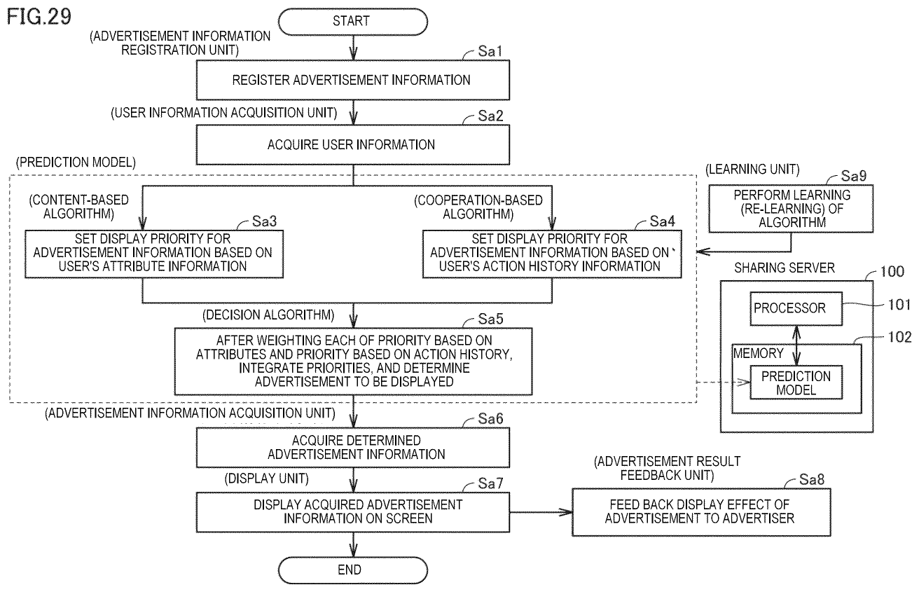

Next, various processing procedures related to the advertisement delivery function will be described with reference to FIG. 29 to FIG. 38. FIG. 29 is a flowchart illustrating a processing procedure related to the advertisement delivery function of the matching system 1.

In the flowchart illustrated in FIG. 29, first, the sharing server 100 registers the advertisement information in the advertisement database 132 (step Sa1). In step Sa1, the sharing server 100 functions as an advertisement information registration unit.

Next, the sharing server 100 acquires user information from the profile database 129 (step Sa2). In step Sa2, the sharing server 100 functions as a user information acquisition unit.

Next, the sharing server 100 sets a display priority (content algorithm priority) for the advertisement information based on the user's attribute information (step Sa3). The user's attribute information includes user's work history. In step Sa3, the sharing server 100 calculates the display priority using the content-based algorithm included in the prediction model.

Next, the sharing server 100 sets the display priority (cooperative algorithm priority) for the advertisement information based on the user's action history information (step Sa4). In step Sa4, the sharing server 100 calculates the display priority using the cooperative algorithm included in the prediction model.

Next, after weighting each of the priority based on the attribute (content algorithm priority) and the priority based on the action history (cooperative algorithm priority), the sharing server 100 integrates both integrities to determine the advertisement information to be displayed based on the integrated priority (step Sa5). In step Sa5, the sharing server 100 uses a decision algorithm. In this manner, the sharing server 100 uses the attribute information and the action history information to associate the user with one or more pieces of the advertisement information among the plurality of pieces of advertisement information. The action history information includes information regarding actions of the user for the advertisement information.

The prediction model includes the algorithms contained in step Sa3 to step Sa5. The prediction model is stored in the memory 102 of the sharing server 100. Step Sa3 to step Sa5 exemplarily illustrate processing of inputting the attribute information and the action history information into the trained prediction model and associating the one or more pieces of advertisement information among the plurality of pieces of advertisement information with users belonging to a certain company (group). The prediction model is trained by machine learning based on the attribute information and the action history information.

Next, the sharing server 100 acquires the determined advertisement information (step Sa6). In step Sa6, the sharing server 100 functions as an advertisement information acquisition unit.

Next, the sharing server 100 displays the acquired advertisement information on the screen of the user's user device 500 (step Sa7). In step Sa7, the sharing server 100 functions as a display unit.

Next, the sharing server 100 feeds back display effect of the advertisement to the advertiser (step Sa8). In step Sa8, the sharing server 100 functions as an advertisement effect feedback unit.

Next, the sharing server 100 learns (re-learns) an algorithm (step Sa9). In step Sa9, the sharing server 100 functions as a learning unit. The processor 101 of the sharing server 100 updates the prediction model stored in the memory 102. The prediction model is re-learned (re-trained) by machine learning based on the user's attribute information and the user's action history information.

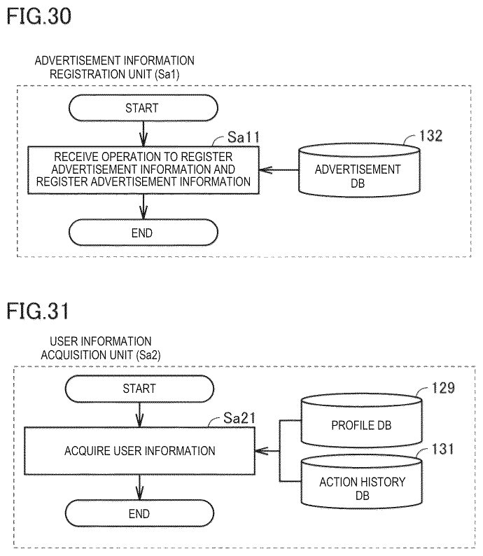

FIG. 30 is a flowchart illustrating a processing procedure of the advertisement information registration unit (Sa1). The advertisement information registration unit receives an operation to register advertisement information by the advertiser, and registers the advertisement information in the advertisement database 132 (step Sa11).

For example, the advertiser operates the user device 500 to input the advertisement information into the user device 500. The user device 500 transmits the input advertisement information to the sharing server 100. The sharing server 100 registers the received advertisement information in the advertisement database 132 in step Sa11.

Alternatively, the sharing server 100 receives an operation by a server administrator, and registers the advertisement information requested by the advertiser in the advertisement database 132 in step Sa11. In this manner, the sharing server 100 registers the advertisement information received from the user device 500 in the advertisement database 132.

This terminates the processing of the advertisement information registration unit. Note that here, the advertisement information registration unit registers advertisement information including category information of advertisements. If the advertiser cannot determine the category, the server administrator, or the like, supports the advertiser.

FIG. 31 is a flowchart illustrating a processing procedure of the user information acquisition unit (Sa2). The user information acquisition unit acquires the user information from the profile database 129 and the action history database 131 (step Sa21). The user information acquisition unit acquires the user's attribute information from the profile database 129 and the user's action history information from the action history database 131. The user information acquisition unit performs the above processing for all users. This terminates the processing of the user information acquisition unit.

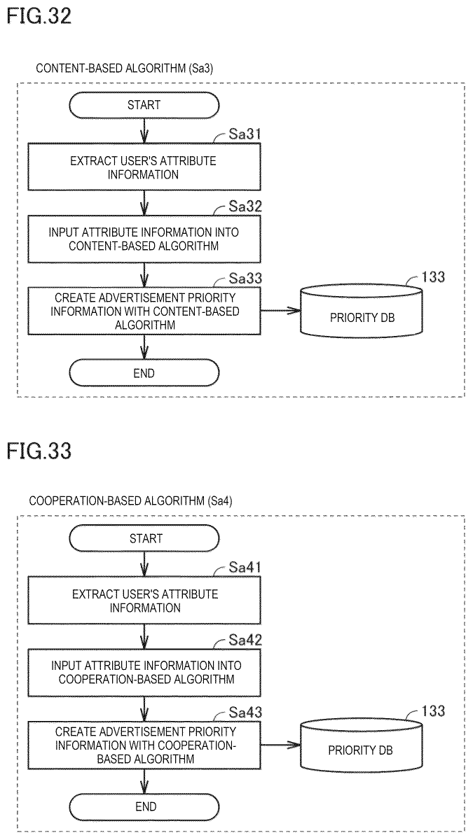

FIG. 32 is a flowchart illustrating a processing procedure regarding the content-based algorithm (Sa3). The sharing server 100 performs the processing using the content-based algorithm, according to the procedure described below. First, the sharing server 100 extracts the user's attribute information (step Sa31). Next, the sharing server 100 inputs the attribute information into the content-based algorithm (step Sa32).

Next, the sharing server 100 creates advertisement priority information with the content-based algorithm (step Sa33). The sharing server 100 registers the created advertisement priority information as the “content algorithm priority” in the priority database 133. The content algorithm priority includes the advertisement classification and the priority value (See FIG. 28). The sharing server 100 performs the above processing for all users. With the above, the processing of the content-based algorithm is terminated.

Note that the sharing server 100 may store the created advertisement priority information in a cache, instead of the priority database 133.

FIG. 33 is a flowchart illustrating a processing procedure of the cooperation-based algorithm (Sa4). The sharing server 100 performs the processing using the cooperation-based algorithm, according to the procedure described below. First, the sharing server 100 extracts the user's attribute information (step Sa41). Next, the sharing server 100 inputs the attribute information into the cooperation-based algorithm (step Sa42).

Next, the sharing server 100 creates the advertisement priority information with the cooperation-based algorithm (step Sa43). The sharing server 100 registers the created advertisement priority information as the “cooperative algorithm priority” in the priority database 133. The cooperative algorithm priority includes the advertisement classification and the priority value (See FIG. 28). The sharing server 100 performs the above processing for all users. With the above, the processing of the cooperation-based algorithm is terminated.

Note that the sharing server 100 may store the created advertisement priority information in a cache, instead of the priority database 133.

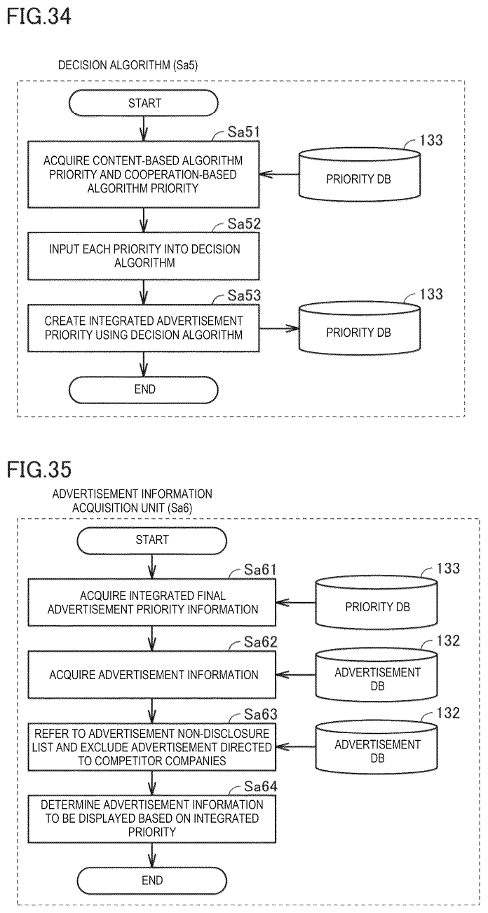

FIG. 34 is a flowchart illustrating a processing procedure of the decision algorithm (Sa5). The sharing server 100 performs the processing using the decision algorithm, according to the procedure described below. First, the sharing server 100 acquires the content algorithm priority and the cooperative algorithm priority from the priority database 133 (step Sa51).

Next, the sharing server 100 inputs the content algorithm priority and the cooperative algorithm priority into the decision algorithm (step Sa52). Next, the sharing server 100 creates the integrated advertisement priority using the decision algorithm (step Sa53). The decision algorithm determines content-based and cooperation-based bias, or the like.

Next, the sharing server 100 registers the created advertisement priority as the “integrated priority (final priority)” in the priority database 133. With the above, the processing of the decision algorithm is terminated.

Note that the sharing server 100 may store the integrated advertisement priority information in a cache, instead of the priority database 133. In addition, in order to determine the final advertisement priority, the sharing server 100 may use one of the content-based algorithm and the cooperation-based algorithm, instead of using both of them.

FIG. 35 is a flowchart illustrating the processing procedure of the advertisement information acquisition unit (Sa6). First, the advertisement information acquisition unit acquires the integrated final advertisement priority information from the priority database 133 (step Sa61). Specifically, the advertisement information acquisition unit acquires the “integrated priority” from the priority database 133.

Next, the advertisement information acquisition unit acquires the advertisement information from the advertisement database 132 (step Sa62). Next, the advertisement information acquisition unit refers to the advertisement non-disclosure list 1291 registered in the advertisement database 132, and excludes advertisements directed to competitor companies (step Sa63).

More specifically, the advertisement information acquisition unit identifies the company to which the advertiser of the advertisement information belongs, based on the company IDs included in the advertisement information. The advertisement information acquisition unit refers to the non-disclosure list 1291 to identify companies that compete with the company to which the advertiser belongs. The advertisement information acquisition unit identifies the company to which the user targeted for advertisement delivery belongs from the user's profile information. The advertisement information acquisition unit excludes the advertisement to be delivered to the competitors, from among a large number of pieces of advertisement information that are candidates to be displayed to users.

Next, the advertisement information acquisition unit determines the advertisement information to be displayed to the users, based on the integrated priority (step Sa64). With the above, the processing of the advertisement information acquisition unit is terminated.

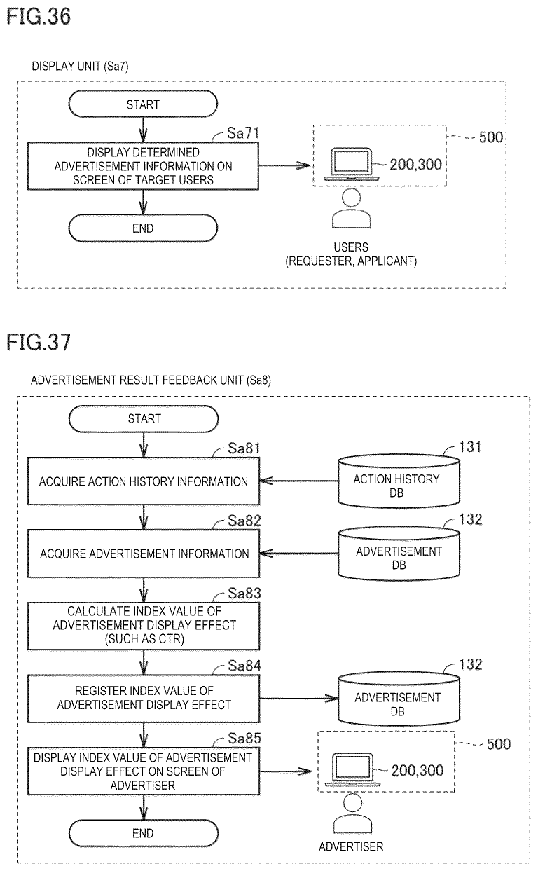

FIG. 36 is a flowchart illustrating a processing procedure of the display unit (Sa7). The display unit displays the advertisement information determined by the advertisement information acquisition unit on the screen of the user device 500 of the target user (step Sa71). With the above, the processing of the display unit is terminated.

FIG. 37 is a flowchart illustrating a processing procedure of the advertisement result feedback unit (Sa8). First, the advertisement result feedback unit acquires the action history information from the action history database 131 (step Sa81).

Next, the advertisement result feedback unit acquires the advertisement information from the advertisement database 132 (step Sa82). Next, the advertisement result feedback unit calculates an index value of the advertisement display effect (step Sa83). For example, a click rate (Click Through Rate) may be adopted as an index value of the advertisement display effect. The click rate is calculated by dividing the number of clicks on the advertisement by the number of times of displays.

Next, the advertisement result feedback unit registers the index value of the advertisement display effect in the advertisement database 132 (step Sa84). Information regarding the advertisement display effect is utilized to improve the accuracy of the matching algorithm and to convey the advertisement display effect to the advertiser. The viewing time of images (including videos) regarding the advertisement may be included in the information regarding the advertisement display effect. Next, the advertisement result feedback unit displays the index value of the advertisement display effect on the screen of the advertiser's user device 500, or the like (step Sa85). With the above, the processing of the advertisement result feedback unit is terminated.

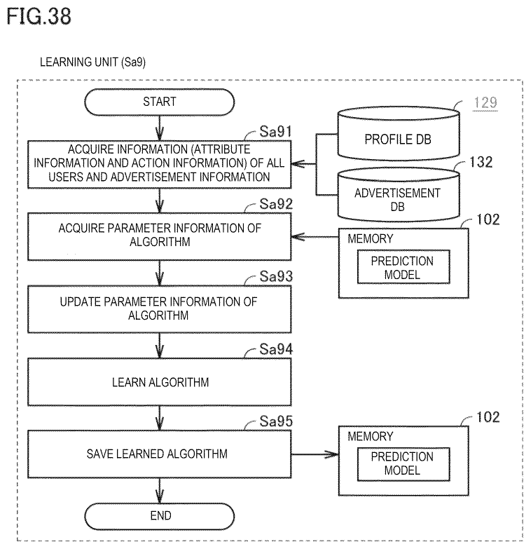

FIG. 38 is a flowchart illustrating a processing procedure of the learning unit (Sa9). First, the learning unit accesses the profile database 129 and the advertisement database 132 to acquire the information of all users (attribute information and action information) and the advertisement information (step Sa91). Next, the learning unit acquires parameter information of the algorithms (content-based algorithm and the cooperation-based algorithm) from the prediction model (step Sa92).

Next, the learning unit updates parameter information of the algorithm (step Sa93). Prior to learning by the learning unit, hyperparameters (Hyperparameter) are used as a parameter of the algorithm. A value of the hyperparameter of the algorithm may be determined with another learning algorithm such as deep learning (Deep Learning). In addition, if the parameter is a parameter other than the hyperparameter, a parameter value may be manually updated by a person, without relying on the learning algorithm such as deep learning.

Next, the learning unit learns an algorithm based on the index value of the advertisement display effect, or the like (step Sa94). Next, the learning unit saves the learned algorithm as the updated prediction model in the memory 102 of the sharing server 100 (step Sa95). With the above, the processing of the learning unit is terminated.

Note that here, the example has been described in which the prediction model trained by machine learning is utilized to determine the advertisement to be delivered to the users. However, the sharing server 100 may determine the advertisement to be delivered to users based on rules defined by a program manually created by a person, without utilizing such a prediction model.

As described above, the matching system 1 has the function to deliver targeting advertisement by effectively utilizing the platform that matches requesters and applicants. In particular, according to the matching system 1, it is possible to analyze the user information based on the users' attribute information and the users' action history information, and to provide the users with the advertisements that match the users. According to the matching system 1, it is possible to limit the disclosure range of the advertisement.

This enables the target of advertisements to be narrowed down to specific companies, specific industries, and specific groups. Furthermore, according to the matching system 1, the reliability of the information of the company to which the user belongs is guaranteed, so that more accurate targeting advertisement is possible. In addition, according to the matching system 1, it is possible to feed back the results of advertisement displays to the algorithm, thereby improving the accuracy of the matching algorithm. As a result, according to the matching system 1, more accurate matching can be performed and highly cost-effective advertisements can be delivered to users.

As described above, the sharing server 100 communicates with a plurality of the user devices 500, including the user device 500 operated by the users belonging to the first group (any of Company A, B, C, . . . , or the like), via the communication interface 104. The sharing server 100 accesses the database 120 (the profile database 129, the advertisement database 132) in which the group information (users' affiliation information) capable of identifying each of the plurality of groups, the plurality of pieces of advertisement information, and the prohibition information (advertisement non-disclosure list 1291) capable of identifying the advertisement information that is prohibited from being associated with the users belonging to the first group among the plurality of pieces of advertisement information are registered. The sharing server 100 associates the one or more pieces of advertisement information among the plurality of pieces of advertisement information with the users belonging to the first group (step Sa64), and delivers the one or more pieces of advertisement information to the first user devices based on the association (step Sa71). The sharing server 100 associates the advertisement information with the users belonging to the first group (step Sa63), by excluding the advertisement information with which the association is prohibited by the prohibition information. The step of excluding advertisements directed to competitor companies (step Sa63) constitutes a specific improvement to computer functionality. This is not merely the application of a business rule, but a specific, deterministic computational filtering process that leverages the unique data structure of the advertisement non-disclosure list 1291. By performing this deterministic check, the computing device avoids the substantial processing overhead associated with probabilistic models that attempt to infer competitive relationships. Furthermore, this pre-delivery filtering directly enhances the efficiency of the matching system by preventing the allocation of network resources and the transmission of data packets to user devices associated with prohibited groups. This conservation of bandwidth and processing power is a direct technical benefit that improves the performance and security of the overall system.

In order to find more suitable human resources through crowdsourcing, the range of crowdsourcing may be further extended rather than limiting the range within a specific company or within a small number of companies. In this case, there arises a need to consider interests between requesters who solicit a contractor of a task and applicants who apply for the solicited task. In the present embodiment, the requester device 200 transmits, to the sharing server 100, the posting information for soliciting a contractor and the disclosure information indicating the disclosure range of the task information. The sharing server 100 registers the task information together with the disclosure information in the database 120. The sharing server 100 judges on the task information that is permitted to be disclosed to the applicants among the task information registered in the database 120 based on the disclosure information, and provides the applicant device 300 with the task information that is permitted to be disclosed to the applicants. Therefore, according to the present embodiment, it is possible to select appropriate applicants in consideration of the interests between the requesters and the applicants.

In the present embodiment described above, “groups by company” and “groups by department within a same company” are examples of a “group”. Applicants who do not belong to a company, such as freelancers, may form one “group”. A “company group” may be formed of a plurality of companies.

In the present embodiment, “companies forming a community relationship” is an example of a “community group”.

In the present embodiment, information included in the “non-disclosure target” included in the disclosure information is an example of the “information capable of identifying a target party to which disclosure of the task information is prohibited”.

A communication for transmitting approval information from the applicant device 300 of the supervisor who serves as the approver to the approval unit 147 (S9 in FIG. 11) is performed on a logical communication path identified by the member ID of that approver. “The approval unit 147 receiving the approval information on such a communication path” is an example of “receiving an approval notice in a communication involving the identification information of the approver of the first applicant”.

In the present embodiment, the “applicant evaluation summary” registered in the evaluation summary database 127 is an example of the “evaluation information based on the evaluation received from the requester device 200 that functions as the evaluator device”. In the present embodiment, the “requester evaluation summary” registered in the evaluation summary database 127 is an example of the “evaluation information based on the evaluation received from the applicant device 300 that functions as the evaluator device”.

FIG. 9 merely illustrates an example of the data registered in the evaluation summary database 127. In the present embodiment, it is also assumed that the member belonging to Company A, in the position of the applicant, evaluates members who belong to Companies A, B, C . . . and behave as the requester. In the present embodiment, it is also assumed that the member belonging to Company B, in the position of the applicant, evaluates members who belong to Companies A, B, C . . . and behave as the requester. In the present embodiment, it is also assumed that the member belonging to Company A, in the position of the requester, evaluates members who belong to Companies A, B, C, . . . and behave as the applicant. In the present embodiment, it is also assumed that the member belonging to Company B, in the position of the requester, evaluates members who belong to Companies A, B, C, . . . and behave as the applicant.

In the present embodiment, the “requester device 200A” operated by the requester belonging to Company A functions as the evaluator device, and is an example of a “first evaluator device (first evaluation device on the posting side) operated by one or more evaluators belonging to the first group”. In the present embodiment, the “applicant device 300A” operated by the applicant belonging to Company A functions as the evaluator device, and is an example of the “first evaluator device (first evaluation device on the applying side) operated by one or more evaluators belonging to the first group”.

In the present embodiment, the “requester device 200B” operated by the requester belonging to Company B functions as the evaluator device, and is an example of a “second evaluator device (second evaluation device on the posting side) operated by one or more evaluators who belong to the second group that is different from the first group”. In the present embodiment, the “applicant device 300B” operated by the applicant belonging to Company B functions as the evaluator device, and is an example of the “second evaluator device (second evaluation device on the applying side) operated by one or more evaluators who belong to the second group that is different from the first group”.

FIG. 21 exemplarily illustrates System Department and Planning Department as departments of Company B. In the present embodiment, “one of System Department and Planning Department” is an example of a “first divided group” included in the first group, and the other is an example of a “second divided group” included in the first group.

The sharing server 100 extracts, from the list of the posted project database 124, the task information for which the applicant's working hours do not exceed the upper limit of hours, based on the estimated man-hour registered in the posted project database 124, the upper limit of side job hours registered in the company database 121, the actual side job hours registered in the side job database 125, and the expected side job hours registered in the side job database 125. Specifically, for example, when the applicant is engaged in a plurality of side jobs, the sharing server 100 calculates a total value of the actual side job hours corresponding to each of the side jobs to determine the total actual side job hours, and calculates a total value of the estimated side job hours corresponding to each of the side jobs to determine the total expected side job hours.

The sharing server 100 adds the determined total actual side job hours and the total expected side job hours to determine the total side job hours. The sharing server 100 determines the applicant's available hours for side job by subtracting the total actual side job hours from the applicant's upper limit of side job hours. The sharing server 100 searches the list of the posted project database 124 for a project that can be handled with the determined available hours for side job.

At this time, the sharing server 100 calculates hours necessary for handling each posted project based on the estimated man-hour in the posted project database 124, and searches for a posted project that falls within the range of the available hours for side job. Here, the “upper limit of side job hours” is an example of the “upper limit of hours that are the upper limit of the applicant's working hours”, the “actual side job hours” are an example of the “actual hours that are hours the applicant has already spent on actual working”, and the “expected side job hours” are an example of the “expected hours that the applicant is expected to spend on working”. The upper limit of hours may be hours for which the upper limit is set not only on side jobs, but also on the total hours of main job hours and side job hours.

A first upper limit of hours is not the upper limit of side job hours, but may be the upper limit of hours for all tasks including main jobs and side jobs. The first actual hours and the first expected hours may be the total hours of all tasks including not only side job hours but also the combined hours of the main job and the side job.

The requester device 200 and the applicant device 300 may be not only devices provided with all of the processor, the memory, the communication interface, and the input/output interface illustrated in FIG. 2, but also a thin client system that utilizes VDI (Virtual Desktop Infrastructure), or the like. A thin client system utilizing the VDI is a system utilizing a desktop environment that is transferred from a server to a terminal on a remote location. The requester device 200, the applicant device 300, and the sharing server 100 do not necessarily need to be independent devices. When a thin client system such as the above is utilized, it is possible to provide the functions of the requester device 200, the applicant device 300, and the sharing server 100 on a same aggregation server.

The database 120 is not limited to a relational database, and a database of an object type, NoSQL type, or the like, may be utilized.

The sharing server 100 is an example of a computing device. A computing device may include a server (an on-premise server, a cloud server, or the like) or a serverless system, or the like. Here, an on-premise server is a server installed and managed in facilities managed within own company. A cloud server is a server (a rented server) provided by another operator via a network. A serverless system is a system in which computing/memory functions can be used only when necessary, without being aware of the existence of a server. Computing devices include servers and serverless systems. Servers include on-premise servers and cloud servers.

### Modification Example 1

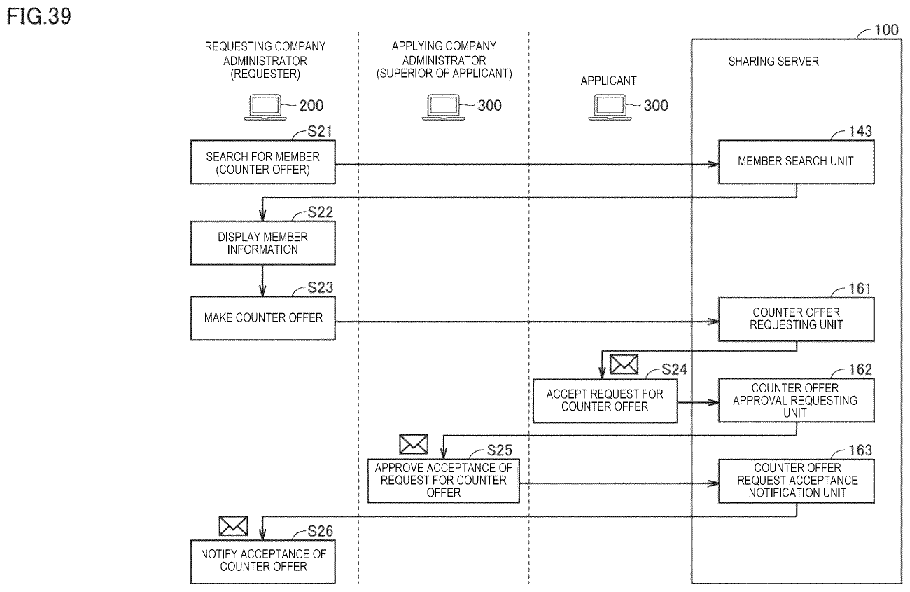

Next, with reference to FIG. 39 to FIG. 41, Modification Example 1 will be described. In Modification Example 1, a counteroffer function is described that allows a requester to encourage those selected from a large number of members to solicit a posted task.

### [Background for Proposing CounterOffer Function]

In crowdsourcing, a requester generally discloses information of a posted project, and waits for applications from those who are interested in contents of the posted project. In such a posting method, however, it may take time to receive a response from applicants. In addition, it is unknown whether or not those who have skills expected by the requester apply.

Then, it is conceivable that the requester searches for members and nominates suitable members (counteroffer). However, in a situation in which the requester is informed of only member IDs and member names, it is difficult for the requester to nominate an applicant the requester truly desires. In addition, to prevent confidential information from leaking to companies, or the like, in a competitive relationship, member information of the companies in a competitive relationship must be excluded from search results.

In Modification Example 1, considering such a background, the requester who performed the member search is provided with search results including detailed member profile information. Furthermore, in Modification Example 1, the member information of the companies, or the like, in a competitive relationship with the company to which the requester belongs, or the like, is excluded from the search results. In the following, Modification Example 1 will be described in detail with reference to the drawings.

FIG. 39 is a diagram for explaining the functions of a sharing server 100, a requester device 200, and an applicant device 300 according to Modification Example 1.

As illustrated in FIG. 39, in addition to a member search unit 143, the sharing server 100 functionally includes a counteroffer request unit 161, a counteroffer approval request unit 162, and a counteroffer request acceptance notification unit 163. These various types of functions are realized by the processor 101, the memory 102, the storage 103, and the communication interface 104 that the sharing server 100 includes.

As already described, the member search unit 143 includes a function to search for members of a matching system 1. In Modification Example 1, in particular, the member search unit 143 includes a function to provide a searcher with detailed member profile information. When receiving a search operation from a requester, a requester device 200 performs member search processing (step S21). In step S21, in particular, the requester device 200 receives the search operation for the requester to make a counteroffer. The member search unit 143 provides the requester device 200 with information of members registered in a member database 122. The provided member information includes the detailed member profile information. However, the member search unit 143 excludes information of members of companies, or the like, that are in a competitive relationship to the company to which the requester belongs.

The requester device 200 receives the member information (search result) from the member search unit 143, and displays the member information as the search result on a display 205 (step S22). Then, the requester device 200 receives an operation for the requester to select an applicant from the search result. That is, the requester selects members to whom a counteroffer is made based on the search result, and makes a counteroffer by operating the requester device 200 (step S23). The requester device 200 transmits, to the sharing server 100, a member ID of a member who is a target of the counteroffer.

The counteroffer request unit 161 receives, from the requester device 200, the member ID of the member who is a target of the counteroffer. The counteroffer request unit 161 identifies the member corresponding to the received member ID. The counteroffer request unit 161 notifies an applicant device 300 of the member who is the target of the counteroffer that a counteroffer request has been received. Information on a posted project, which is a target of the counteroffer, may be included in this notice. The member, who is the target of the counteroffer, receives a request for counteroffer from the applicant device 300. The “request” received here is an example of “information encouraging applicants to apply”. The member, who is the target of the counteroffer, determines whether or not to accept the request for counteroffer. The member, who is the target of the counteroffer, can perform an operation to accept the request for counteroffer or an operation to reject the request for counteroffer, using the applicant device 300. The applicant device 300 accepts the request for counteroffer, for example (step S24). The applicant device 300 that has accepted the request for counteroffer transmits application information to the counteroffer approval request unit 162.

The counteroffer approval request unit 162 transmits, to a superior of the applicant, his/her subordinate's application information. The counteroffer approval request unit 162 identifies a member ID of the superior, who is a supervisor of the applicant, based on a relationship between the applicant's member ID and the superior's member ID that are registered in the member database 122. The applicant's superior checks the application information at his/her own applicant device 300, and approves the application (step S25).

The counteroffer request acceptance notification unit 163 receives approval information from the applicant's superior. The counteroffer request acceptance notification unit 163 receives the applicant's application on the condition that the approval information has been received. The counteroffer request acceptance notification unit 163 notifies the requester device 200 that the application from the applicant to whom the counteroffer was made has been received. The requester device 200 notifies the requester that the counteroffer has been accepted, based on that notice (step S26). More specifically, the requester device 200 displays, on the display 205, information notifying the requester that the counteroffer has been accepted.

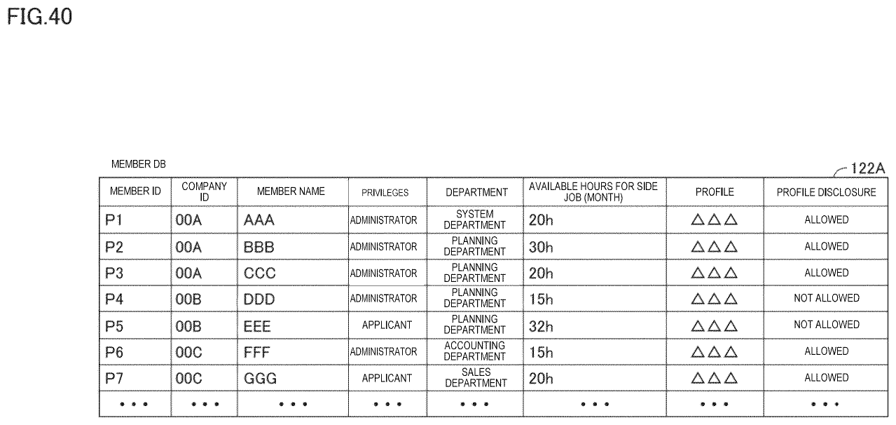

FIG. 40 is a diagram illustrating an example of a member database 122A according to Modification Example 1. When compared to the member database 122 illustrated in FIG. 4, profile information and profile disclosure information indicating whether or not to disclose profiles are added to the member database 122A illustrated in FIG. 40.

The matching system 1 provides members with a privilege that enables the members to register and modify their own profile information in the member database 122A, using the applicant device 300. The members use the applicant device 300 to register their various profile information in the member database 122A. The profile information includes, for example, information of SPI (Synthetic Personality Inventory) of members, members' work histories, members' performance, qualifications possessed by members, and the like.

The member sets the profile disclosure information, using the applicant device 300. The profile information of a member for whom the profile disclosure information is set to “allowed” is provided to a searcher. The profile information of a member for whom the profile disclosure information is set to “not allowed” is not provided to a searcher. The sharing server 100 registers the profile disclosure information in the member database 122A based on the setting selected by each of the members. In this manner, the sharing server 100 receives, from each of a plurality of the members, input of the information indicating whether or not the members permit their profile information to be included in search results.

Here, an example has been described in which it is determined whether or not disclosure of the members' profile information is permitted based on the setting of the profile disclosure information. However, the sharing server 100 may receive an operation to set whether to permit disclosure according to the type of the profile information. This enables, for example, the members to set the SPI information as a non-disclosure target, while setting performance and possessed qualifications as disclosure targets. Alternatively, if age is included in the profile information, the members can set the age as a non-disclosure target, and set the profile information other than the age as disclosure targets. In this case, the sharing server 100 registers a plurality of pieces of profile information of each of a plurality of registered persons (member) in the member database 122A. The sharing server 100 receives, from each of the plurality of registered persons, input for setting a range of the plurality of pieces of profile information to be disclosed as search results.

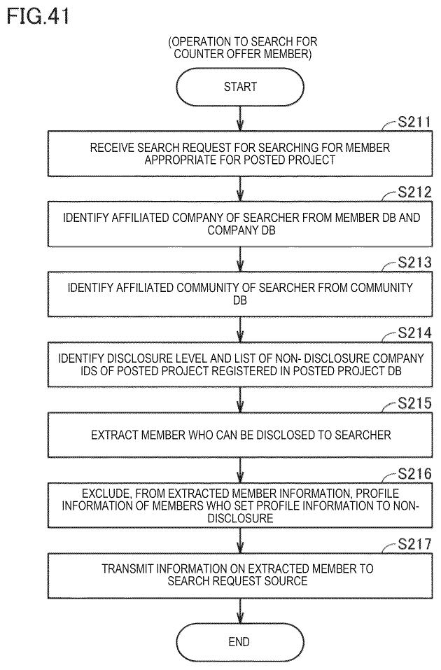

FIG. 41 is a flowchart illustrating a processing procedure of counteroffer member search processing according to Modification Example 1. The processing based on this flowchart is performed by the sharing server 100.

First, the sharing server 100 receives a search request for a searcher to search for members appropriate for a posted project (step S211). Here, the searcher is a requester having a posted project. The requester searches for members using his/her own requester device 200, to make a counteroffer to members who have skills appropriate for the posted project. In step S211, the requester's search request is received by the sharing server 100. The search request may include the searcher's member ID and a project ID of the posted project.

Next, the sharing server 100 identifies a company to which the searcher belongs, from the member database 122A and a company database 121 (step S212). Next, the sharing server 100 identifies a community to which the searcher belongs, from a community database 123 (step S213).

Next, the sharing server 100 identifies a disclosure level and a list of non-disclosure company IDs registered in a posted project database 124 (step S214). Next, the sharing server 100 extracts members who can be disclosed to the searcher (step S215).

More specifically, the sharing server 100 identifies companies to which the posted project held by the searcher (requester) should not be disclosed, based on a non-disclosure company list and the disclosure level in the posted project database 124. The sharing server 100 judges members belonging to such companies as members that cannot be disclosed to the searcher. The sharing server 100 extracts members other than the members belonging to such companies, as members that can be disclosed to the searcher.

Next, the sharing server 100 refers to the member database 122A to exclude, from the extracted member information, profile information of the members who set the profile information to non-disclosure (step S216).

Next, the sharing server 100 transmits the extracted member information to a search request source (step S217), and terminates the processing based on this flowchart. The requester device 200, which is the search request source, receives the member information transmitted from the sharing server 100, and displays that information on the display 205. The information displayed on the display 205 includes an ID, a name, and profile information of each extracted member. However, for the members who set their profile information to non-disclosure, only a company ID and a name are displayed, and the profile information is not displayed.

As described above, according to Modification Example 1, the requester searches for a member who is considered most appropriate for application for the posted task referring to the member's detailed profile information, and can make a counteroffer to the member. Furthermore, members of the company to which the requester belongs and members of companies that are in a competitive relationship with a community are excluded from the members displayed as search results. This makes it possible to prevent any inconvenience that the requester places an order for the task to the members of such rival companies. Furthermore, members themselves can decide whether or not to disclose their profile information, so that a system can be provided in which a free will of each member is respected.

Note that members may be allowed to set whether or not to disclose their names, in addition to the profile information. In addition, the profile information may be provided with several categories, and the members may be allowed to set whether or not to disclose the profile information for each category.

By adding the offer function described above to the matching system 1, the requester can check the profile information of the members who are permitted to view the posted project. Furthermore, the requester can encourage a member with whom the requester himself/herself wishes to place an order to apply. In addition, the member encouraged by the requester to apply can view the project information, and accept or reject the application. In addition, each of the members can decide whether or not to disclose the profile information, when registering and editing the member information, or the like. This enables the requester to actively select who to offer to, and have the most appropriate applicant engaged in the task early.

### Modification Example 2

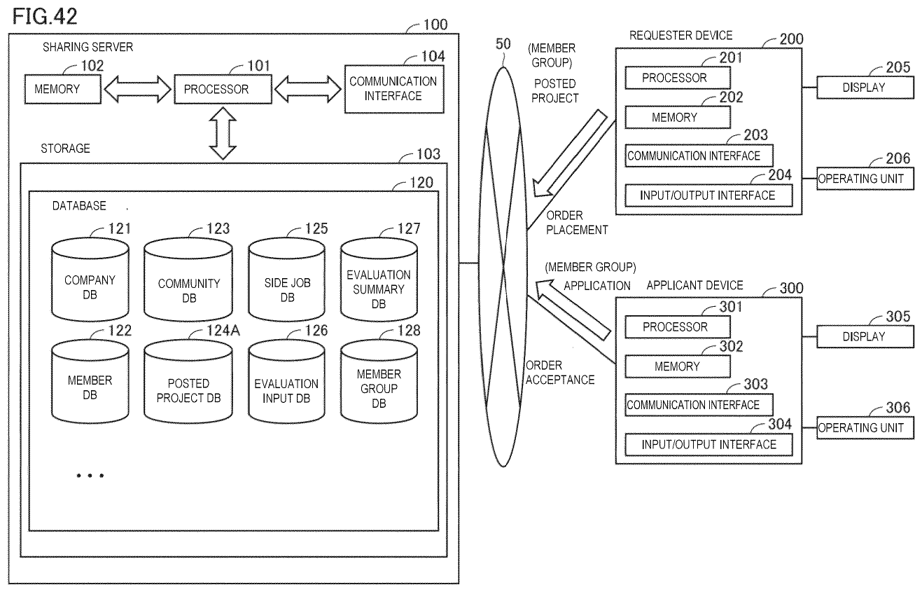

Next, Modification Example 2 will be described with reference to FIG. 42 to FIG. 46. In Modification Example 2, a member group application function is described that allows a plurality of members to apply for a posted task as a group.

### [Background of Proposing Member Group Application Function]

In crowdsourcing, the requester generally discloses information of a posted project, and waits for applications from those who are interested in contents of the posted project. However, there are not a few projects that should be handled by a team of several persons or projects that are desirably handled by a team, such as a comprehensive task from business planning to acquisition of an intellectual property right related to the planning. Therefore, if the number of solicited members is limited to one person, it is difficult for a person who wishes to accept an order to undertake a task volume of which is more than what he/she can handle individually.

In Modification Example 2, considering such a background, the member group application function is provided that allows a plurality of members to apply for a posted task as a group. Modification Example 2 will be described below in detail.

FIG. 42 is a block diagram illustrating configurations of a sharing server 100, a requester device 200, and an applicant device 300 according to Modification Example 2. In the block diagram illustrated in FIG. 42, a member group database 128 is added compared with the block diagram illustrated in FIG. 2. Relative to the posted project database 124 illustrated in FIG. 6, a function to register posted projects that allows application as a member group is added to a posted project database 124A illustrated in FIG. 42.

Member groups including a plurality of members are registered in the member group database 128. Using a requester device 200, a requester can register, in the posted project database 124A, posted projects that allow application by a member group. Using an applicant device 300, applicants can apply, as a member group registered in the member group database 128, for the posted projects that allow application by a member group.

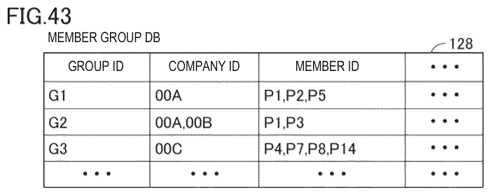

FIG. 43 is a diagram illustrating an example of the member group database 128 according to Modification Example 2. Member group information is registered in the member group database 128. The member group information includes a group ID for identifying a member group, a company ID of a company to which each member of a member group belongs, and a member ID of each member of a member group, or the like.

Hereinafter, using group IDs, member groups corresponding to each of the group IDs may be referred to as Member Group G1, Member Group G2, Member Group G3 . . . .

Member Group G1 includes three members identified by member IDs=P1, P2, and P5. Since the company ID registered corresponding to the Member Group G1 is 00A, it can be seen that all of the three members belong to Company A.

Member Group G2 includes two members identified by member IDs=P1 and P3. Since the company IDs registered corresponding to the Member Group G2 are 00A and 00B, it can be seen that one of the two members belongs to Company A, and the other belongs to Company B. As can be understood by comparing Member Group G1 with Member Group G2, the member ID=P1 is registered in both member groups G1 and G2. Therefore, Member P1 belongs to the two member groups.

Member Group G3 includes four members identified by member IDs=P4, P7, P8, and P14. Since the company ID registered corresponding to the Member Group G3 is 00C, it can be seen that all of the four members belong to Company C.

As illustrated in FIG. 42, the member group database 128 is stored in a storage 103 of a sharing server 100. Members form a member group with agreements with other members with whom they become acquainted in a same company or community, or the like, and register the member group in the member group database 128. A “member group” is an example of an “applicant group”.

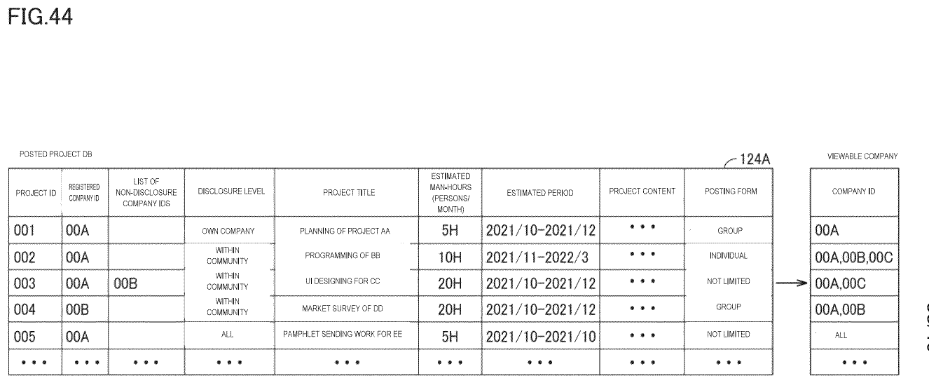

FIG. 44 is a diagram illustrating an example of the posted project database 124A according to Modification Example 2. When compared to the posted project database 124 illustrated in FIG. 6, posting form information is added to the posted project database 124A illustrated in FIG. 44. The requester operates the requester device 200 to set a posting form. The sharing server 100 associates a posting form based on the setting with task information, and registers the posting form in the posted project database 124A.

The requester can select a posting form from groups and individuals. If the requester does not select the posting form, it is considered that the posting form of the posted project is neither limited to groups nor individuals. A project with the posting form set to groups can only be accepted by member groups. A project with the posting form set to individuals can only be accepted by individual members. A project with no posting form restrictions can be accepted by both member groups and individuals. The “posting form information” is an example of “information capable of identifying that a task soliciting a contractor is a task that a plurality of requesters should jointly apply”.

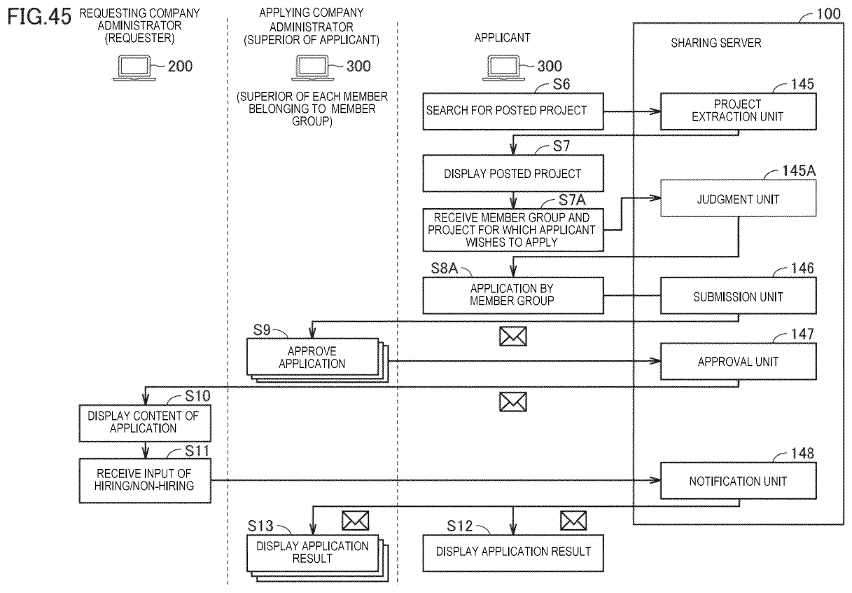

FIG. 45 is a diagram for explaining functions of the sharing server 100, the requester device 200, and the applicant device 300 according to Modification Example 2. In FIG. 45, a judgment unit 145A is added to the sharing server 100, as compared to FIG. 11. In addition, in FIG. 45, when compared to FIG. 11, step S7A is added after step S7 and step S8A of group allocation is adopted instead of step S8 of application.

Here, it is assumed that an applicant belongs to a plurality of member groups. The applicant operates the applicant device 300 to search for a posted project (step S6). The applicant device 300 transmits a search request to a project extraction unit 145 of the sharing server 100.

When receiving the search request, as illustrated with reference to FIG. 11, the project extraction unit 145 extracts the project allowed to be viewed by the applicant from posted projects registered in the posted project database 124. The projects extracted from the project extraction unit 145 include projects the posting form of which is set to any of “Group”, “Individual”, and “Not Limited”. The project extraction unit 145 transmits the extracted posted projects to the applicant device 300. The applicant device 300 receives the posted projects from the project extraction unit 145. The applicant device 300 displays the received posted projects on a display 305 (step S7).

For each of the posted projects, a disclosure level, a project title, estimated man-hour, an estimated period, project contents, the posting form, and the like are displayed on the display 305. If applicants wish to apply as a member group, the applicants specify a member group, using an operating unit 306 such as a mouse and a keyboard, or the like, and then, selects a project for which the posting form is set to “Group” or “Not Limited”. The applicant device 300 receives the member group and the project for which the member group wish to apply, based on applicants' operations (step S7A). The applicant device 300 transmits the group ID of the received member group and the project ID of the received project to the sharing server 100. The judgment unit 145A of the sharing server 100 acquires a group ID and a project ID.

The judgment unit 145A accesses the member group database 128 and identifies the member ID registered in association with the acquired group ID. The judgment unit 145A accesses the member database 122 and identifies the company ID in association with the identified member ID.

The judgment unit 145A accesses a community database 123 and identifies a community ID of a community to which the company with the identified company ID belongs. The judgment unit 145A accesses the posted project database 124A and identifies the company ID (the requester's company ID), the non-disclosure company ID, the disclosure level, and the posting form registered in association with the acquired project ID.

Based on the identified information as described above, the judgment unit 145A judges whether or not the posted project received by the applicant device 300 is a project for which application by the member group specified by the applicants is allowed. In other words, the judgment unit 145A judges whether or not the application by member group is permitted.

For example, the judgment unit 145A does not permit the application by member group when one of the members in the member group belongs to a company listed in a list of non-disclosure company IDs associated with the posted project. Alternatively, the judgment unit 145A does not permit the application by member group when one of the members in the member group belongs to a company outside the community, even though the disclosure level of the posted project is set to “Within Community”.

The judgment unit 145A returns the judgment result to the applicant device 300. FIG. 45 illustrates a flow when the judgment unit 145A has permitted the application by member group. When the judgment unit 145A has permitted the application by member group, the applicant device 300 receives the application by member group (step S8A). For example, the applicant device 300 displays, on the display 305, a screen indicating that the application received in step S7A has been allowed and a screen for checking whether or not to apply. The applicant selects to apply, using the operating unit 306 such as a mouse and a keyboard, or the like.

When receiving the application by member group (step S8A), the applicant device 300 transmits application information to the sharing server 100. A submission unit 146 of the sharing server 100 acquires the application information. Contents of the subsequent processing are similar to the contents described with reference to FIG. 11. However, the submission unit 146 transmits the application information to a superior of each of the members belonging to the member group. Thus, the application approval processing of step S9 is performed for each superior of a corresponding member belonging to the member group. Therefore, an approval unit 147 receives, from a plurality of the superiors, approval information indicating that he/she approves application of his/her subordinate or rejection information indicating that he/she rejects the application of his/her subordinate.

The approval unit 147 receives the applicants' application only in the case in which the approval information is obtained from all of the superiors of the respective members belonging to the member group. The approval unit 147 that has received the applicants' application transmits the application information to the requester device 200. As already described with reference to FIG. 11, the requester device 200 displays contents of the application on a display 205 (step S10). The requester inputs results of determination on hiring or non-hiring in the requester device 200. The requester device 200 receives the input results (step S11), and transmits the received results of hiring or non-hiring to a notification unit 148 of the sharing server 100.

The notification unit 148 transmits the application result (result of hiring or non-hiring) to the applicant's applicant device 300 and the applicant device 300 of the applicant's superior (administrator). However, the notification unit 148 transmits the application result to the superiors of the respective members belonging to the member group.

The applicant's applicant device 300 and the applicant device 300 of the superior of each member belonging to the member group display the application result on the display 305 (step S12 and step S13). The applicant and the superior of each member belonging to the member group confirm the application result by looking at the display on the display 305.

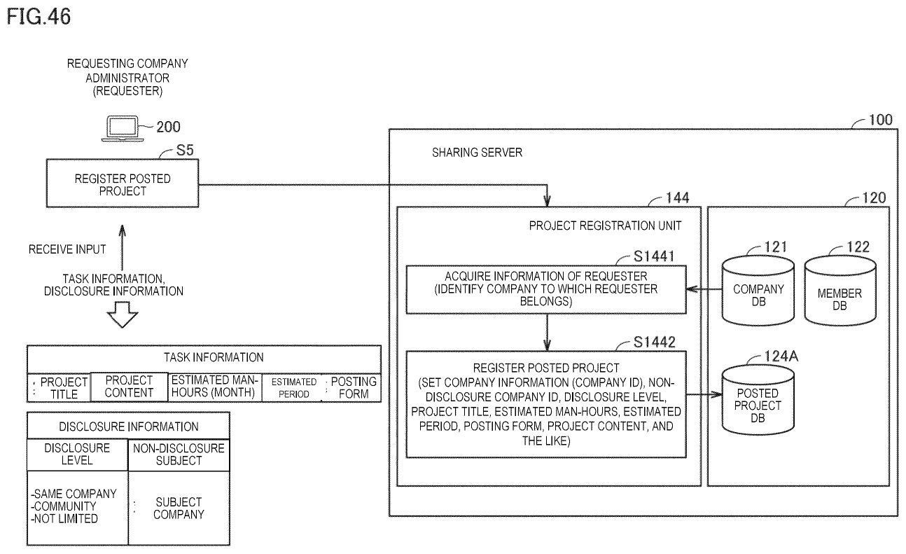

FIG. 46 is a diagram for explaining a procedure for registering a posted project in the posted project database 124A according to Modification Example 2. In FIG. 46, the posting form is added to the project information input into the requester device 200, as compared to FIG. 14.

In Modification Example 2, the requester that registers a posted project can include a posting form of the posted project in the task information, when inputting the task information and the disclosure information of the posted project in the requester device 200. The posting form is any of group or individual. A project registration unit 144 of the sharing server 100 registers the posted project including the posting form selected by the requester in the posted project database 124A (step S1442). When the requester does not select the posting form, the project registration unit 144 registers, in the posted project database 124A, information indicating that the posting form is not limited. Other contents illustrated in FIG. 46 are similar to FIG. 14 already described, and a description thereof is not repeated here.

As described above, according to Modification Example 2, a plurality of members can apply for a posted project as a group. Furthermore, according to Modification Example 2, it is judged whether or not the application by member group is allowed, based on a relationship between the company and the community to which the requester belongs and the company and the community to which each member of the member group belongs. This makes it possible to prevent a member group including members belonging to an organization that is in a competitive relationship with the applicant from accepting an order for the posted project of that applicant.

By adding the member group application function as described above to the matching system 1, it is possible to provide a system in which an order accepting party can view a posted project and apply for the posted project as a member group. This enables the matching system 1 to handle order placement and order acceptance of a large-scale task that is desirably tackled by a team. Consequently, the matching system provides a more efficient and secure computing apparatus. By building the advertising mechanism upon a foundation of verified user and group data from the crowdsourcing platform, the system transforms the abstract business goal of excluding competitors into a concrete, technical implementation. The specific combination of the member database 122, the advertisement database 132, and the advertisement non-disclosure list 1291 creates a novel system architecture that provides more reliable and efficient computer operation compared to prior art advertising systems. The system is thus not merely an abstract idea, but a specific machine and process configured to solve a technical problem rooted in computer science and network security.

The present embodiment described above includes configurations listed below:

(a) In a matching system, a requester device transmits, to a computing device, task information for soliciting a contractor and disclosure information indicating a disclosure range of the task information, the computing device registers the task information together with the disclosure information in a database, and the computing device judges, based on the disclosure information, task information, among the task information registered in the database, that is allowed to be disclosed to a first applicant, and provides the first applicant device with the task information that is allowed to be disclosed to the first applicant.

(b) In the matching system further including a second applicant device that is operated by a second applicant who is different from the first applicant, the computing device judges, based on the disclosure information, task information, among the task information registered in the database, that is allowed to be disclosed to the second applicant, and provides the second applicant device with the task information allowed to be disclosed to the second applicant.

(c) In the matching system, the matching system further includes a third applicant device operated by a third applicant who is different from the first applicant and the second applicant, a plurality of disclosure levels is set for the disclosure information, and the computing device judges whether or not to allow disclosure according to the disclosure level for each of the first applicant to the third applicant.

(d) In the matching system, the first applicant belongs to a first group, the second applicant belongs to a second group that is different from the first group, the plurality of disclosure levels includes a first level and a second level, the first level corresponds to allowing the task information to be disclosed to the first applicant and prohibiting the task information from being disclosed to an applicant who does not belong to the first group, and the second level corresponds to allowing the task information to be disclosed to an applicant who belongs to any of the first group and a community group that has formed a community relationship with the first group and prohibiting the task information from being disclosed to an applicant who does not belong to any of the first group and the community group.

(e) In the matching system, the first applicant belongs to the first group, the second applicant belongs to the second group that is different from the first group, the plurality of disclosure levels includes the first level, the second level, and a third level, the first level corresponds to allowing the task information to be disclosed to the first applicant and prohibiting the task information from being disclosed to the applicant who does not belong to the first group, the second level allows the task information to be disclosed to the applicant who belongs to any of the first group and the community group that has formed a community relationship with the first group, and the third level corresponds to allowing the task information to be disclosed to an applicant who belongs to a community that is different from the first group and the community group of the second level that has formed a community relationship with the first group and prohibiting the task information from being disclosed to the applicant who does not belong to any of the first group and the community group.

(f) In the matching system, the plurality of disclosure levels includes a disclosure level that corresponds to allowing the task information to be disclosed to an applicant, irrespective of a group to which the applicant belongs.

(g) In the matching system, the database registers attribute data capable of identifying a community group, and the computing device identifies an applicant to whom the task information is allowed to be disclosed, based on the disclosure information and the attribute data.

(h) In the matching system, the requester device receives an operation to input a target group to which the task information is prohibited from being disclosed and transmits information capable of identifying the received target group to the computing device, and the computing device prohibits the task information from being disclosed to an applicant belonging to the target group even if the disclosure level is a level that allows the task information to be disclosed to the target group.

(i) In the matching system, the first applicant belongs to a first company and the second applicant belongs to a second company that is different from the first company.

(j) In the matching system, the computing device receives, from the requester device, a request to search for information on a plurality of registered persons registered in the database and provides the requester device with search results based on the received request, the requester device receives an operation to select, from the search results, an application-recommended person who is recommended to apply as an applicant and transmits identification information of the selected application-recommended person to the computing device, and the computing device transmits information for encouraging application to an applicant device of the selected application-recommended person.

(k) In the matching system, the computing device registers a plurality of pieces of profile information of each of the plurality of registered persons in the database, and the computing device receives, from each of the plurality of registered persons, input for setting a range of disclosure as search results among the plurality of pieces of profile information.

(l) In the matching system, the requester device transmits, to the computing device, posting form information capable of identifying whether a task soliciting a contractor is a group task that can be accepted when a plurality of applicants jointly apply, or a task that can be accepted for application by a single applicant, and the computing device registers the posting form information in the database in association with the task information.

(m) In the matching system, the computing device registers, in the database, an application group including a plurality of applicants, and the computing device can receive application from the application group for task information that is allowed to be disclosed to all applicants belonging to the application group.

### Aspects

In the following, aspects of the present disclosure are listed.

(Aspect 1) A matching system according to Aspect 1 provides an advertisement that matches each of a plurality of groups including companies, the matching system including: a plurality of user devices; and a computing device that communicates with each of the plurality of user devices and is accessible to a database, in which the plurality of user devices includes a first user device that is operated by a user belonging to a first group, the database registers group information capable of identifying each of the plurality of groups, a plurality of pieces of advertisement information, and prohibition information capable of identifying advertisement information, among the plurality of pieces of advertisement information, which is prohibited from being associated with the user belonging to the first group, the computing device associates one or more pieces of advertisement information among the plurality of pieces of advertisement information with the user belonging to the first group, and delivers the one or more pieces of advertisement information, based on this associating, to the first user device, and the computing device excludes the advertisement information identified by the prohibition information and associates the advertisement information with the user belonging to the first group.

(Aspect 2) In Aspect 2, in the matching system according to Aspect 1, the plurality of user devices includes a second user device operated by an advertiser who belongs to a group that is different from the first group, the second user device transmits the advertisement information of the advertiser to the computing device, and the computing device registers the advertisement information received from the second user device in the database.

(Aspect 3) In Aspect 3, in the matching system according to Aspect 1 or 2, the group information includes information for identifying either one of a company and a department within a company.

(Aspect 4) In Aspect 4, in the matching system according to any one of Aspects 1 to 3, the prohibition information includes information indicating a competitive relationship of each of the plurality of groups.

(Aspect 5) In Aspect 5, in the matching system according to any one of Aspects 1 to 4, the database includes attribute information of the user and action history information of the user, and the computing device uses the attribute information and the action history information to associate one or more pieces of advertisement information among the plurality of pieces of advertisement information with the user belonging to the first group.

(Aspect 6) In Aspect 6, in the matching system according to Aspect 5, the computing device inputs the attribute information and the action history information into a trained prediction model and associates one or more pieces of advertisement information among the plurality of pieces of advertisement information with the user belonging to the first group, the action history information includes information regarding actions of the user on the advertisement information, and the prediction model is trained by machine learning based on the attribute information and the action history information.

(Aspect 7) In Aspect 7, in the matching system according to any one of Aspects 1 to 6, the first user device has a display for displaying the advertisement information.

(Aspect 8) In Aspect 8, in the matching system according to any one of Aspects 1 to 7, the matching system includes a function to match a requester who solicits a contractor for a task and an applicant, the plurality of user devices includes a requester device operated by the requester and a first applicant device operated by a first applicant, the requester device transmits, to the computing device, task information for soliciting a contractor and disclosure information indicating a disclosure range of the task information, the computing device registers the task information together with the disclosure information in the database, and the computing device judges, based on the disclosure information, task information, among the task information registered in the database, that is allowed to be disclosed to the first applicant, and provides the first applicant device with the task information that is allowed to be disclosed to the first applicant.

(Aspect 9) A computing device according to Aspect 9 is included in a matching system that provides an advertisement that matches each of a plurality of groups including companies, the computing device including: a communication interface that communicates with a plurality of user devices including a first user device that is operated by a user belonging to a first group; and a processor that accesses a database, in which the database registers group information capable of identifying each of the plurality of groups, a plurality of pieces of advertisement information, and prohibition information capable of identifying advertisement information, among the plurality of pieces of advertisement information, which is prohibited from being associated with the user belonging to the first group, the processor associates one or more pieces of advertisement information among the plurality of pieces of advertisement information with the user belonging to the first group, and delivers the one or more pieces of advertisement information to the first user device, and the processor excludes the advertisement information identified by the prohibition information and associates the advertisement information with the user belonging to the first group.

(Aspect 10) A method according to Aspect 10 is a method of providing an advertisement that matches each of a plurality of groups including companies, the method including: a step of communicating with a plurality of user devices including a first user device that is operated by a user belonging to a first group; a step of accessing a database that registers group information capable of identifying each of the plurality of groups, a plurality of pieces of advertisement information, and prohibition information capable of identifying advertisement information, among the plurality of pieces of advertisement information, which is prohibited from being associated with the user belonging to the first group; a step of associating one or more pieces of advertisement information among the plurality of pieces of advertisement information with the user belonging to the first group, and delivering the one or more pieces of advertisement information to the first user device; and a step of excluding the advertisement information identified by the prohibition information and associating the advertisement information with the user belonging to the first group.

It should be considered that the embodiments disclosed herein are merely illustrative and not limiting in all respects. The scope of the present disclosure is described by the claims, and not by the description of the embodiments described above. It is intended to include all modifications within the scope and meaning equivalent to the claims.

### REFERENCE SIGNS LIST

1 Matching system, 50 Internet, 100 Sharing server, 101 Processor, 102 Memory, 103 Storage, 104 Communication interface, 120 Database (DB), 121 Company database (Company DB), 122, 122A Member database (Member DB), 123 Community database (Community DB), 124, 124A Posted project database (Posted project DB), 125 Side job database (Side job DB), 126 Evaluation input database (Evaluation input DB), 126A Requester evaluation unit, 126B Applicant evaluation unit, 127 Evaluation summary database (Evaluation summary DB), 127A Requester evaluation summary unit, 127B Applicant evaluation summary unit, 128 Member group database (Member group DB), 129 Profile database (Profile DB), 131 Action history database (Action history DB), 132 Advertisement database (Advertisement DB), 133 Priority database (Priority DB), 1271, 1272 Data group, 140 Community registration unit, 141 Company registration unit, 142 Member registration unit, 143 Member search unit, 144 Project registration unit, 145 Project extraction unit, 146 Submission unit, 147 Approval unit, 148 Notification unit, 149 Performance receiving unit, 150 Performance output unit, 151 evaluation receiving unit, 152 Evaluation output unit, 161 Counteroffer request unit, 162 Counteroffer approval request unit, 163 Counteroffer request acceptance notification unit, 200, 200A, 200B, 200C Requester device, 201 Processor, 202 Memory, 203 Communication interface, 204 Input/output interface, 205 display, 206 Operating unit, 206A Keyboard, 206B Mouse, 207, 250, 350 Screen, 300, 300A, 300B, 300C Applicant device, 301 Processor, 302 Memory, 303 Communication interface, 304 Input/output interface, 305 Display, 306 Operating unit, 306A Keyboard, 306B Mouse, 307A to 307C Tabs, 401, 402 Table, 500 User device, 1291 Advertisement non-disclosure list

1. A matching system for providing targeted advertising, the matching system comprising:
a plurality of user devices, wherein a first user device of the plurality of user devices is operated by a user associated with a first group; and
a computing device configured to communicate with each of the plurality of user devices and access a database storing:
group information identifying each of the plurality of groups,
a plurality of pieces of advertisement information, and
prohibition information identifying advertisement information, among the plurality of pieces of advertisement information, which is prohibited from being associated with the user belonging to the first group,
the computing device is configured to:
extract one or more pieces of advertisement information among the plurality of pieces of advertisement information with the user belonging to the first group,
exclude advertisement information identified by the prohibition information from extracted one or more pieces of advertisement information,
associate resulting advertisement information with the user belonging to the first group, and
transmit the one or more pieces of the resulting advertisement information to the first user device.

2. The matching system according to claim 1, wherein
the plurality of user devices includes a second user device operated by an advertiser who belongs to a second group that is different from the first group,
the second user device transmits the advertisement information of the advertiser to the computing device, and
the computing device is configured to store the advertisement information received from the second user device in the database.

3. The matching system according to claim 1, wherein the group information includes information for identifying either one of a company and a department within a company.

4. The matching system according to claim 1, wherein the prohibition information includes information indicating a competitive relationship of each of the plurality of groups.

5. The matching system according to claim 1, wherein
the database includes attribute information of the user and action history information of the user, and
the computing device is further configured to use the attribute information and the action history information to associate one or more pieces of advertisement information among the plurality of pieces of advertisement information with the user belonging to the first group.

6. The matching system according to claim 5, wherein
the computing device is configured to input the attribute information and the action history information into a trained prediction model and extract one or more pieces of advertisement information among the plurality of pieces of advertisement information with the user belonging to the first group,
the action history information includes information regarding actions of the user on the advertisement information, and
the prediction model is trained by machine learning based on the attribute information and the action history information.

7. The matching system according to claim 5, wherein the attribute information includes at least one of a skill, a possessed qualification, or a department to which the user belongs.

8. The matching system according to claim 5, wherein the action history information includes a project viewing history or a search history on the platform.

9. The matching system according to claim 1, wherein the first user device has a display for displaying the advertisement information.

10. The matching system according to claim 1, wherein
the plurality of user devices includes a requester device operated by the requester and a first applicant device operated by a first applicant,
the requester device is configured to transmit, to the computing device, task information for soliciting a contractor and disclosure information indicating a disclosure range of the task information,
the computing device is configured to:
store the task information together with the disclosure information in the database, determine, based on the disclosure information, task information, among the task information registered in the database, allowed to be disclosed to the first applicant, and
transmit, to the first applicant device, the task information allowed to be disclosed to the first applicant.

11. The matching system according to claim 10, wherein the database further stores applicant evaluation information based on historical task performance of applicants on the platform; and
the computing device is further configured to, prior to providing a list of applicants to the requester device, filter the list to exclude applicants whose evaluation information fails to satisfy a predetermined reference value.

12. The matching system according to claim 1, wherein the prohibition information includes a non-disclosure list that maps an advertiser's company identification to a non-disclosure company identification.

13. The matching system according to claim 1, wherein the prohibition information defines competitive relationships between groups and specifies that advertisements from an originating group are not to be delivered to a competitor group.

14. The matching system of claim 1, wherein the group information is verified information associated with member registration.

15. A computing device for a matching system that provides targeted advertisements, the computing device comprising:
a communication interface configured to communicate with a plurality of user devices including a first user device that is operated by a user belonging to a first group; and
a processor configured to access a database storing group information identifying each of the plurality of groups, a plurality of pieces of advertisement information, and prohibition information identifying advertisement information, among the plurality of pieces of advertisement information, which is prohibited from being associated with the user belonging to the first group, wherein the processor is configured to:
extract one or more pieces of advertisement information among the plurality of pieces of advertisement information with the user belonging to the first group,
exclude advertisement information identified by the prohibition information from extracted one or more pieces of advertisement information,
associate resulting advertisement information with the user belonging to the first group and
transmit the resulting one or more pieces of advertisement information to the first user device.

16. The computing device according to claim 15, wherein the processor is further configured to receive advertisement information from a second user device associated with a second group and store the advertisement information in the database.

17. The computing device according to claim 15, wherein the prohibition information includes an advertisement non-disclosure list that includes data mapping an identifier of an originating group of an advertisement to one or more identifiers of prohibited recipient groups based on a competitive relationship.

18. The computing device according to claim 15, wherein the processor is further configured to extract the one or more pieces of advertisement information based on attribute information and action history information associated with the user.

19. The computing device according to claim 15, wherein the group information stored in the database includes verified affiliation data obtained from a user registration process for a crowdsourcing function of the matching system.

20. A method of providing targeting advertising, the method comprising:
communicating with a plurality of user devices including a first user device that is operated by a user belonging to a first group;
accessing a database storing group information identifying each of the plurality of groups, a plurality of pieces of advertisement information, and prohibition information identifying advertisement information, among the plurality of pieces of advertisement information, which is prohibited from being associated with the user belonging to the first group;
extracting one or more pieces of advertisement information among the plurality of pieces of advertisement information with the user belonging to the first group; excluding advertisement information identified by the prohibition information from extracted one or more pieces of advertisement information;
associating resulting advertisement information with the user belonging to the first group; and
transmitting the one or more pieces of advertisement information to the first user device.
